(19) United States
(12) Patent Application Publication
(10) Pub. No.: US 2024/0403538 A1
(43) Pub. Date: Dec. 5, 2024

(54) PRINT BOARD DESIGN ASSISTANCE SYSTEM, DESIGN ASSISTANCE METHOD, AND RECORDING MEDIUM

(71) Applicant: Mitsubishi Electric Corporation, Tokyo (JP)

(72) Inventor: Akihito KOBAYASHI, Tokyo (JP)

(73) Assignee: Mitsubishi Electric Corporation, Tokyo (JP)

(21) Appl. No.: 18/806,963

(22) Filed: Aug. 16, 2024

Related U.S. Application Data
(63) Continuation of application No. PCT/JP2023/001991, filed on Jan. 24, 2023.

(30) Foreign Application Priority Data
Mar. 30, 2022 (WO) PCT/JP2022/015752

(51) Int. Cl. G06F 30/398; G06F 30/347

(52) U.S. Cl. CPC G06F 30/398; G06F 30/347

(57) ABSTRACT

A design assistance system for selecting and determining a bypass capacitor to be mounted on a board, including a process to calculate, for all combinations of a plurality of power supply terminals and one electrode of the plurality of bypass capacitors, a shortest distance in a wiring path from a connection position of a power supply wiring layer to each of connection positions of that layer, and to relatively compare shortest distances of wiring paths on the board corresponding to each of the plurality of bypass capacitors in each of the plurality of power supply terminals, determine that a bypass capacitor connected to a wiring path whose shortest distance indicates a minimum value is valid, determine that remaining bypass capacitors are invalid, determine that the bypass capacitor determined to be valid is valid for the board, and determine that other bypass capacitors are invalid for the board.

### CROSS REFERENCE TO RELATED APPLICATIONS

This application is a Continuation of PCT International Application No. PCT/JP2023/001991, filed on Jan. 24, 2023, which claims priority under 35 U.S.C. 119 (a) to Patent Application No. PCT/JP2022/015752, filed in the Japan on Mar. 30, 2022, all of which are hereby expressly incorporated by reference into the present application.

### TECHNICAL FIELD

The present disclosure relates to a print board design assistance system, a design assistance method, and a recording medium, and particularly relates to a design assistance system for assisting in design of arrangement of a bypass capacitor.

### BACKGROUND ART

In recent years, semiconductor integrated circuit devices (hereinafter, referred to as ICs) have become larger in scale in order to achieve multifunctionality and high functionality, and the number of power supply terminals of an IC has also increased as the scale has increased.

As the number of power supply terminals of the IC increases, bypass capacitors (hereinafter, referred to as “pass capacitor”) connected to the power supply terminals of the IC also increase.

Patent Literature 1 discloses a printed circuit board design assistance device that reduces a burden of arrangement work of bypass capacitors corresponding to a grid array package.

Patent Literature 1 discloses the following contents.

That is, a length of a path from a power supply terminal of a die to a ground terminal of the die via a pass capacitor is set as an evaluation value, and a verification condition is set as a threshold representing an allowable path length.

Whether or not the evaluation value meets the verification condition is determined for each pass capacitor with respect to a highest evaluation value (a shortest loop distance) among all evaluation values derived for each pass capacitor.

If they do not meet, it is determined that they violate the verification condition, and if they meet, it is determined that they meet the verification condition.

### CITATION LIST

### Patent Literature

Patent Literature 1: JP 2015-228078 A

### SUMMARY OF INVENTION

### Technical Problem

Since the printed circuit board design assistance device disclosed in Patent Literature 1 determines whether or not the evaluation value matches using the threshold representing the allowable path length as the verification condition, an optimum value of the allowable path length differs for each IC, and it is difficult to determine an appropriate threshold.

For example, if stability is prioritized and a margin is added to the threshold, pass capacitors are excessively arranged, but on the other hand, if the threshold is strictly set, a problem that desired performance cannot be satisfied occurs although the number of pass capacitors decreases.

The present disclosure has been made in view of the above points, and an object of the present disclosure is to provide a print board design assistance system that enables optimization of the number of bypass capacitors to be arranged without reducing performance by the bypass capacitors.

### Solution to Problem

A print board design assistance system according to the present disclosure is a design assistance system for selecting and determining a bypass capacitor to be mounted from among a plurality of bypass capacitors, the bypass capacitor being mounted on a board on which a semiconductor integrated circuit device including a plurality of power supply terminals and a plurality of ground terminals is mounted, and the plurality of bypass capacitors each having a pair of electrodes is mountable, the board including a power supply wiring layer to which the plurality of power supply terminals is connected, a ground wiring layer to which the plurality of ground terminals is connected, a power supply side wiring layer to which one electrode of the plurality of bypass capacitors is connected, and a ground side wiring layer to which the other electrode of the plurality of bypass capacitors is connected, the design assistance system comprising: a processor; and a memory storing a program, upon executed by the processor, performing a process: to calculate, for all combinations of the plurality of power supply terminals of the semiconductor integrated circuit device and one electrode of the plurality of bypass capacitors, a shortest distance in a wiring path from a connection position of the power supply wiring layer to which each of the plurality of power supply terminals of the semiconductor integrated circuit device is connected to each of connection positions of the power supply side wiring layer to which the one electrode of the plurality of bypass capacitors is connected, and calculate, for all combinations of the plurality of ground terminals of the semiconductor integrated circuit device and other electrode of the plurality of bypass capacitors, a shortest distance in a wiring path from a connection position of the ground wiring layer to which each of the plurality of ground terminals of the semiconductor integrated circuit device is connected to each of connection positions of the ground side wiring layer to which the other electrode of the plurality of bypass capacitors is connected; and to relatively compare shortest distances of wiring paths on the board corresponding to each of the plurality of bypass capacitors calculated in each of the plurality of power supply terminals and the plurality of ground terminals of the semiconductor integrated circuit device, determine that a bypass capacitor connected to a wiring path whose shortest distance indicates a minimum value is valid, determine that remaining bypass capacitors are invalid, determine that the bypass capacitor determined to be valid among the plurality of bypass capacitors is valid for the board, and determine that other bypass capacitors are invalid for the board.

### Advantageous Effects of Invention

According to the present disclosure, it is possible to optimize the number of bypass capacitors to be arranged.

### BRIEF DESCRIPTION OF DRAWINGS

FIG. 1 is a block diagram illustrating a basic configuration of a print board design assistance system according to a first embodiment.

FIG. 2 is a diagram illustrating a configuration of board design information of the design assistance system according to the first embodiment.

FIG. 3 is a configuration diagram of a search target selecting unit of the design assistance system according to the first embodiment.

FIG. 4 is a plan view illustrating pin arrangement of an IC.

FIG. 5 is a view illustrating a pattern of a surface of a first layer of a board immediately below the mounting region of the IC.

FIG. 6 is a view illustrating a pattern of a surface of a second layer of the board immediately below the mounting region of the IC.

FIG. 7 is a view illustrating a pattern of a surface of a third layer of the board immediately below the mounting region of the IC.

FIG. 8 is a view illustrating a pattern of a surface of a fourth layer of the board immediately below the mounting region of the IC.

FIG. 9 is a view illustrating a pattern of a surface of a fifth layer of the board immediately below the mounting region of the IC.

FIG. 10 is a view illustrating a pattern of a back surface of a sixth layer of the board immediately below the mounting region of the IC.

FIG. 11 is a diagram illustrating an example of an output result of a path calculation means of the design assistance system according to the first embodiment.

FIG. 12 illustrates an example of validity evaluation results of bypass capacitors by the design assistance system according to the first embodiment.

FIG. 13 is a diagram illustrating an example of a change result of a bypass capacitor by the design assistance system according to the first embodiment.

FIG. 14 is a flowchart illustrating an operation of the design assistance system according to the first embodiment.

FIG. 15 is a configuration diagram illustrating a hardware configuration of the design assistance system according to the first embodiment.

FIG. 16 is a block diagram illustrating a basic configuration of a print board design assistance system according to a second embodiment.

FIG. 17 illustrates an example of validity evaluation results of the bypass capacitors by the design assistance system according to the second embodiment.

FIG. 18 is a flowchart illustrating an operation of the design assistance system according to the second embodiment.

FIG. 19 is a flowchart illustrating an operation of a design changing unit in the design assistance system according to the second embodiment.

FIG. 20 is a diagram illustrating an example of the validity of the change result of the bypass capacitor with respect to the print board by the design assistance system according to the second embodiment.

FIG. 21 is a block diagram illustrating a basic configuration of a print board design assistance system according to a third embodiment.

FIG. 22 is a flowchart illustrating an operation of the design changing unit in the design assistance system according to the third embodiment.

FIG. 23 is a block diagram illustrating a basic configuration of a print board design assistance system according to a fourth embodiment.

FIG. 24 illustrates an example of the validity evaluation results of the bypass capacitors by the design assistance system according to the fourth embodiment.

FIG. 25 is a block diagram illustrating a basic configuration of a print board design assistance system according to a fifth embodiment.

FIG. 26 is a plan view illustrating pin arrangement of the IC according to the fifth embodiment.

FIG. 27 is a view illustrating a pattern of a surface of a first layer of a board immediately below a mounting region of the IC according to the fifth embodiment.

FIG. 28 is a view illustrating a pattern of a surface of a second layer of the board immediately below the mounting region of the IC according to the fifth embodiment.

FIG. 29 is a view illustrating a pattern of a surface of a third layer of the board immediately below the mounting region of the IC according to the fifth embodiment.

FIG. 30 is a view illustrating a pattern of a surface of a fourth layer of the board immediately below the mounting region of the IC according to the fifth embodiment.

FIG. 31 is a view illustrating a pattern of a surface of a fifth layer of the board immediately below the mounting region of the IC according to the fifth embodiment.

FIG. 32 is a view illustrating a pattern of a back surface of a sixth layer of the board immediately below the mounting region of the IC according to the fifth embodiment.

FIG. 33 is a flowchart illustrating an operation of the design assistance system according to the fifth embodiment.

FIG. 34 is a flowchart illustrating an operation of the design changing unit in the design assistance system according to the fifth embodiment.

FIG. 35 is a diagram illustrating an example of validity evaluation results of the bypass capacitors by the design assistance system according to the fifth embodiment.

### DESCRIPTION OF EMBODIMENTS

### First Embodiment

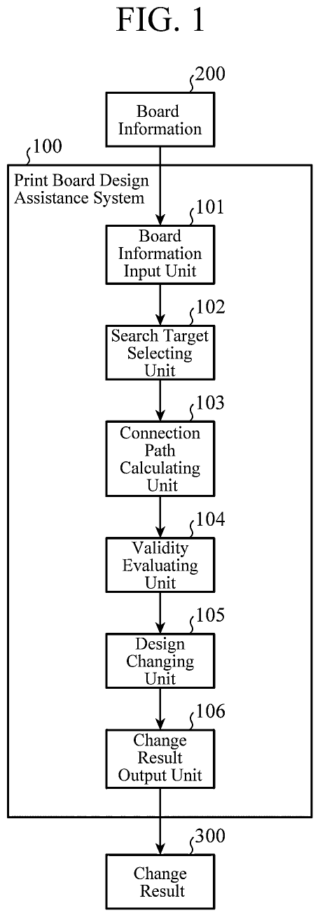

A print board design assistance system according to a first embodiment will be described with reference to FIGS. 1 to 15.

The print board design assistance system according to the first embodiment assists in design for selecting a pass capacitor and determining an arrangement position of the pass capacitor on a print board on which a semiconductor integrated circuit device (hereinafter, referred to as IC) having a plurality of power supply terminals and a plurality of ground terminals and a plurality of bypass capacitors (hereinafter, referred to as “pass capacitor”) connected to an IC are mounted.

An IC mounted on the print board will be described by exemplifying a ball grid array (BGA) package in which ball-like solder (solder balls) are arranged in a lattice pattern on a bottom surface of the package, which is a kind of grid array package.

A six-layer (1+4+1) build-up board will be described as an example, in which the print board has a plurality of IC power supply wiring layers and a plurality of IC ground wiring layers to which a plurality of power supply terminals and a plurality of ground terminals of the IC are connected on a front surface thereof, and has a capacitor power supply wiring layer connected to one electrode of a bypass capacitor and a capacitor ground wiring layer connected to the other electrode of the bypass capacitor on a back surface thereof.

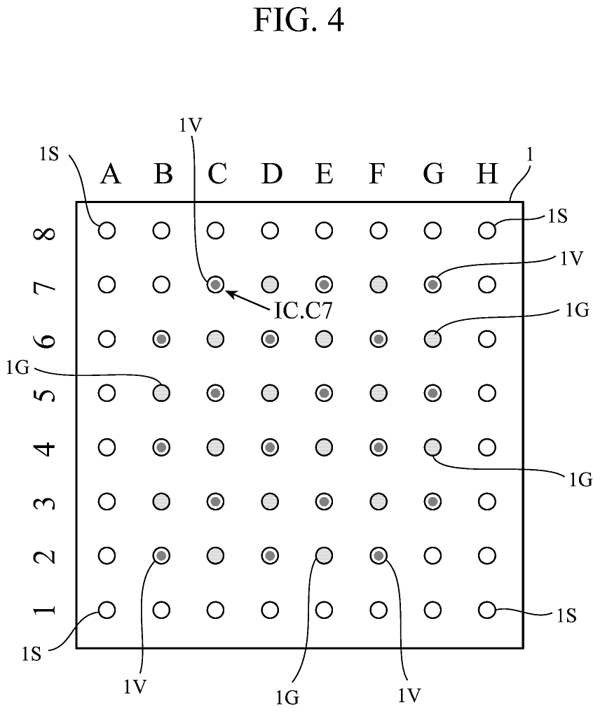

Before describing the design assistance system, a pin arrangement of an IC and a pattern in each layer immediately below a mounting region of the IC on the print board will be described with reference to FIGS. 4 to 10.

In the pin arrangement (in this example, the arrangement of the solder balls is collectively referred to as a pin arrangement) of an IC1, as illustrated in FIG. 4, pins are arranged in an 8×8 grid of eight rows in width and eight rows in height.

A horizontal direction is defined as A column to H column, a vertical direction is defined as 1 row to 8 row, and intersections of the columns and the rows are defined as A1 to A8 to H1 to H8.

A power supply terminal 1V of the IC1 is disposed at B2, B4, B6, C3, C5, C7, D2, D4, D6, E3, E5, E7, F2, F4, F6, G3, G5, and G7.

The ground terminal 1G of the IC1 is arranged in B3, B5, C2, C4, C6, D3, D5, D7, E2, E4, E6, F3, F5, F7, G4, and G6.

Remaining pins are signal terminals 1S.

The power supply terminal 1V and the ground terminal 1G are alternately arranged vertically and horizontally.

The power supply terminal 1V is connected to a 1.0 V power supply system, and 1.0 V is supplied to the power supply terminal 1V. The ground terminal 1G is connected to a ground system and has a ground potential.

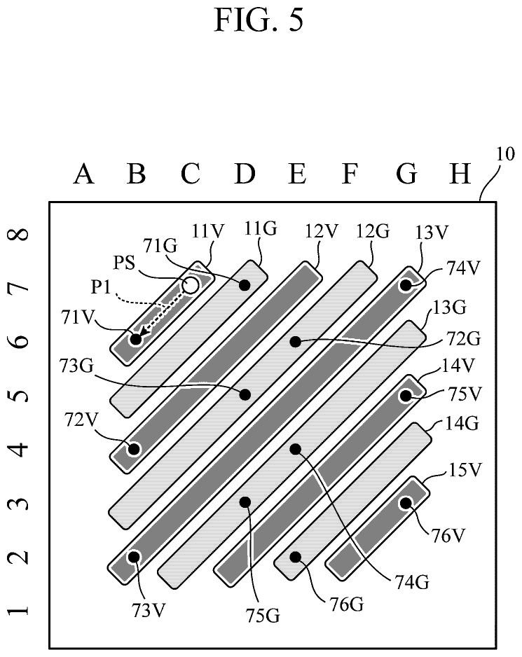

Next, a pattern of a surface in each layer immediately below the mounting region of the IC1 in the print board will be described with reference to FIGS. 5 to 10.

In order to eliminate complexity of description, a pattern of the first layer of the print board is simply abbreviated as one-layer pattern. The sixth layer from the second layer will also be abbreviated for description.

Note that, in one to six layers, a pattern such as a signal wiring layer is formed in a region other than a region immediately below the mounting region of the IC1.

A one-layer pattern 10 is a pattern on the surface of the print board, and is a mounting surface of the IC1.

The one-layer pattern 10 is a pattern of a plurality of IC power supply wiring layers 11V to 15V and a plurality of IC ground wiring layers 11G to 14G.

The IC power supply wiring layers 11V to 15V are connected to the 1.0 V power supply system, and the IC ground wiring layers 11G to 14G are connected to the ground system.

Also in a two-layer pattern 20 to a six-layer pattern 60, the power supply wiring layer is connected to the 1.0 V power supply system, and the ground wiring layer is connected to the ground system.

The IC power supply wiring layer 11V is formed by a line segment connecting B6 and C7, and is connected to the power supply terminals 1V located at B6 and C7.

The IC power supply wiring layer 12V is formed by a line segment connecting B4 and E7, and is connected to the power supply terminals 1V located at B4, C5, D6, and E7.

The IC power supply wiring layer 13V is formed by a line segment connecting B2 and G7, and is connected to the power supply terminals 1V located at B2, C3, D4, E5, F6, and G7.

The IC power supply wiring layer 14V is formed by a line segment connecting D2 and G5, and is connected to the power supply terminals 1V located at D2, E3, F4, and G5.

The IC power supply wiring layer 15V is formed by a line segment connecting F2 and G3, and is connected to the power supply terminals 1V located at F2 and G3.

The IC ground wiring layer 11G is formed by a line segment connecting B5 and D7, and is connected to the ground terminals 1G located at B5, C6, and D7.

The IC ground wiring layer 12G is formed by a line segment connecting B3 and F7, and is connected to the ground terminals 1G located at B3, C4, D5, E6, and F7.

The IC ground wiring layer 13G is formed by a line segment connecting C2 and G6, and is connected to the ground terminals 1G located at C2, D3, E4, F5, and G6.

The IC ground wiring layer 14G is formed by a line segment connecting E2 and G4, and is connected to the ground terminals 1G located at E2, F3, and G4.

The IC power supply wiring layers 11V to 15V and the IC ground wiring layers 11G to 14G are alternately arranged in parallel with one diagonal line.

In the two-layer pattern 20 to the six-layer pattern 60, the wiring layers in respective layers and vias connecting the wiring layers are appropriately arranged in such a manner that the plurality of IC power supply wiring layers 11V to 15V and the plurality of IC ground wiring layers 11G to 14G in the one-layer pattern 10 are connected to the plurality of pass capacitors C1 to C12 that can be mounted on the six-layer pattern 60 after the arrangement of the plurality of pass capacitors C1 to C12 that can be mounted is temporarily determined.

That is, the wiring layers and the vias connecting the wiring layers in respective layers in the two-layer pattern 20 to the six-layer pattern 60 are not uniquely determined to the arrangement of the pins of the IC1.

However, in the following description, in order to describe characteristic points of the print board design assistance system according to the first embodiment in an easily understandable manner, positions of the wiring layers and the vias connecting the wiring layers in respective layers will be described using reference numerals schematically indicating intersections of columns and rows for convenience of description while avoiding complication of the description.

Therefore, the positions of the wiring layers and the vias connecting the wiring layers in respective layers are not limited to the positions described below.

The two-layer pattern 20 is a first switching pattern of a build-up layer.

The two-layer pattern 20 is a pattern of a plurality of power supply switching wiring layers 21V to 26V and a plurality of ground switching wiring layers 21G to 26G.

The power supply switching wiring layer 21V is formed by a line segment connecting B6 and C6.

The power supply switching wiring layer 22V is formed by a line segment connecting B4 and C4.

The power supply switching wiring layer 23V is formed by a line segment connecting B2 and C2.

The power supply switching wiring layer 24V is formed by a line segment connecting F7 and G7.

The power supply switching wiring layer 25V is formed by a line segment connecting F5 and G5.

The power supply switching wiring layer 26V is formed by a line segment connecting F3 and G3.

The ground switching wiring layer 21G is formed by a line segment connecting D7 and E7.

The ground switching wiring layer 22G is formed by a line segment connecting D6 and E6.

The ground switching wiring layer 23G is formed by a line segment connecting D5 and E5.

The ground switching wiring layer 24G is formed by a line segment connecting D4 and E4.

The ground switching wiring layer 25G is formed by a line segment connecting D3 and E3.

The ground switching wiring layer 26G is formed by a line segment connecting D2 and E2.

A build-up via 71V electrically connects a position of B6 in the IC power supply wiring layer 11V and a position of B6 in the power supply switching wiring layer 21V.

A build-up via 72V electrically connects a position of B4 in the IC power supply wiring layer 12V and a position of B4 in the power supply switching wiring layer 22V.

A build-up via 73V electrically connects a position of B2 in the IC power supply wiring layer 13V and a position of B2 in the power supply switching wiring layer 23V.

A build-up via 74V electrically connects a position of G7 in the IC power supply wiring layer 14V and a position of G7 in the power supply switching wiring layer 24V.

A build-up via 75V electrically connects a position of G5 in the IC power supply wiring layer 15V and a position of G5 in the power supply switching wiring layer 25V.

A build-up via 76V electrically connects a position of G3 in the IC power supply wiring layer 16V and a position of G3 in the power supply switching wiring layer 26V.

A build-up via 71G electrically connects a position of D7 in the IC ground wiring layer 11G and a position of D7 in the ground switching wiring layer 21G.

A build-up via 72G electrically connects a position of E6 in the IC ground wiring layer 12G and a position of E6 in the ground switching wiring layer 22G.

A build-up via 73G electrically connects a position of D5 in the IC ground wiring layer 12G and a position of D5 in the ground switching wiring layer 23G.

A build-up via 74G electrically connects a position of E4 in the IC ground wiring layer 13G and a position of E4 in the ground switching wiring layer 24G.

A build-up via 75G electrically connects a position of D3 in the IC ground wiring layer 13G and a position of D3 in the ground switching wiring layer 25G.

A build-up via 76G electrically connects a position of E2 in the IC ground wiring layer 14G and a position of E2 in the ground switching wiring layer 26G.

The three-layer pattern 30 is a ground (GND) pattern layer, and is a solid pattern except for positions of C6, C4, C2, F7, F5, and F3.

In the GND pattern layer 30, a conductive layer is removed in a circular shape at the positions of C6, C4, C2, F7, F5, and F3, and at center positions of C6, C4, C2, F7, F5, and F3, interstitial via holes (IVH, hereinafter referred to as IVH) 81V to 86V are penetrated without being electrically connected to the GND pattern layer 30.

The four-layer pattern 40 is a power supply pattern layer, and is a solid pattern except for positions of D6, D4, D2, E7, E5, and E3.

In the power supply pattern layer 40, a conductive layer is removed in a circular shape at the positions of D6, D4, D2, E7, E5, and E3, and the IVHs 81G to 86G are penetrated through without being electrically connected to the power supply pattern layer 40 at center positions of D6, D4, D2, E7, E5, and E3.

The five-layer pattern 50 is a second switching pattern of the build-up layer.

The five-layer pattern 50 is a pattern of two power supply switching pattern layers 51V and 52V and a ground switching pattern layer 51G.

The power supply switching pattern layer 51V is a solid pattern formed in such a manner as to surround positions of B2 to B7 to C2 to C7.

The power supply switching pattern layer 52V is a solid pattern formed in such a manner as to surround positions of F2 to F7 to G2 to G7.

The ground switching pattern layer 51G is a solid pattern formed in such a manner as to surround positions of A1 to A8 to H1 to H8 separately from the power supply switching pattern layers 51V and 52V except for the power supply switching pattern layers 51V and 52V.

The IVHs 81V to 86V and IVHs 81G to 86G penetrate through from the two-layer to the three-layer and the four-layer, and electrically connect the corresponding two-layer pattern 20 and five-layer pattern.

The IVH 81V electrically connects the power supply switching wiring layer 21V, the power supply pattern layer 40, and the power supply switching pattern layer 51V at the position of C6.

The IVH 82V electrically connects the power supply switching wiring layer 22V, the power supply pattern layer 40, and the power supply switching pattern layer 51V at the position of C4.

The IVH 83V electrically connects the power supply switching wiring layer 23V, the power supply pattern layer 40, and the power supply switching pattern layer 51V at the position of C2.

The IVH 84V electrically connects the power supply switching wiring layer 24V, the power supply pattern layer 40, and the power supply switching pattern layer 52V at the position of F7.

The IVH 85V electrically connects the power supply switching wiring layer 25V, the power supply pattern layer 40, and the power supply switching pattern layer 52V at the position of F5.

The IVH 86V electrically connects the power supply switching wiring layer 26V, the power supply pattern layer 40, and the power supply switching pattern layer 52V at the position of F3.

The IVH 81G electrically connects the ground switching wiring layer 21G, the GND pattern layer 30, and the ground switching pattern layer 51G at the position of E7.

The IVH 82G electrically connects the ground switching wiring layer 22G, the GND pattern layer 30, and the ground switching pattern layer 51G at the position of D6.

The IVH 83G electrically connects the ground switching wiring layer 23G, the GND pattern layer 30, and the ground switching pattern layer 51G at the position of E5.

The IVH 84G electrically connects the ground switching wiring layer 24G, the GND pattern layer 30, and the ground switching pattern layer 51G at the position of D4.

The IVH 85G electrically connects the ground switching wiring layer 25G, the GND pattern layer 30, and the ground switching pattern layer 51G at the position of E3.

The IVH 86G electrically connects the ground switching wiring layer 26G, the GND pattern layer 30, and the ground switching pattern layer 51G at the position of D2.

The six-layer pattern 60 is a pattern on the back surface of the print board, and is a mounting surface on which a plurality of pass capacitors C1 to C12 can be mounted.

The six-layer pattern 60 is a pattern of two capacitor power supply wiring layers 61V and 62V and a capacitor ground wiring layer 61G.

The capacitor power supply wiring layer 61V is a solid pattern formed to face the power supply switching pattern layer 51V.

The capacitor power supply wiring layer 62V is a solid pattern formed to face the power supply switching pattern layer 52V.

The capacitor ground wiring layer 61G is a solid pattern that is located between the capacitor power supply wiring layer 61V and the capacitor power supply wiring layer 62V, is separated from the capacitor power supply wiring layer 61V and the capacitor power supply wiring layer 62V, and is formed in such a manner as to surround the positions of D2 to D7 to E2 to E7.

The power supply switching pattern layer 51V and the capacitor power supply wiring layer 61V are each electrically connected by build-up vias 91V to 93V at the positions of B6, B4, and B2.

The power supply switching pattern layer 52V and the capacitor power supply wiring layer 62V are each electrically connected by build-up vias 94V to 96V at positions of G7, G5, and G3.

The ground switching pattern layer 51G and the capacitor ground wiring layer 61G are electrically connected to each other by build-up vias 91G to 94G at four positions of 3 to 6 between D and E.

Each of the six positions of C7 to C2 in the capacitor power supply wiring layer 61V is a position to which one electrode (hereinafter, for convenience, referred to as a power supply side electrode) of the corresponding pass capacitor C1 to C6 can be connected.

The six positions of D7 to D2 in the capacitor ground wiring layer 61G are positions to which the other electrodes (hereinafter, for convenience, referred to as a GND-side electrode) of the corresponding pass capacitors C1 to C6 can be connected.

Each of the six positions of F7 to F2 in the capacitor power supply wiring layer 62V is a position to which the power supply side electrode of the corresponding pass capacitor C7 to C12 can be connected.

Each of the six positions of E7 to E2 in the capacitor ground wiring layer 61G is a position to which the GND-side electrode of the corresponding pass capacitor C7 to C12 can be connected.

That is, 12 pass capacitors C1 to C12 can be mounted on the mounting surface of the print board.

Next, the print board design assistance system according to the first embodiment will be described with reference to FIGS. 1 to 3.

The design assistance system according to the first embodiment is a design assistance system capable of determining validity of the pass capacitor and optimizing the number of pass capacitors arranged on the mounting surface of the print board.

Taking the print board described above as an example, validity is determined for 12 pass capacitors C1 to C12 that can be mounted on the mounting surface of the print board, and unnecessary pass capacitors are removed to efficiently select an optimum number of pass capacitors for design assistance.

As illustrated in FIG. 1, a design assistance system 100 according to the first embodiment includes a board information input unit 101, a search target selecting unit 102, a connection path calculating unit 103, a validity evaluating unit 104, a design changing unit 105, and a change result output unit 106.

Board design information 200 is input by the board information input unit 101, and the board information input unit 101 converts the input board design information 200 into a format that can be processed in the design assistance system 100 and outputs the information.

The board design information 200 includes component individual information related to components including the IC1 and the pass capacitors C1 to C12, and information related to a wiring layout formed on the print board.

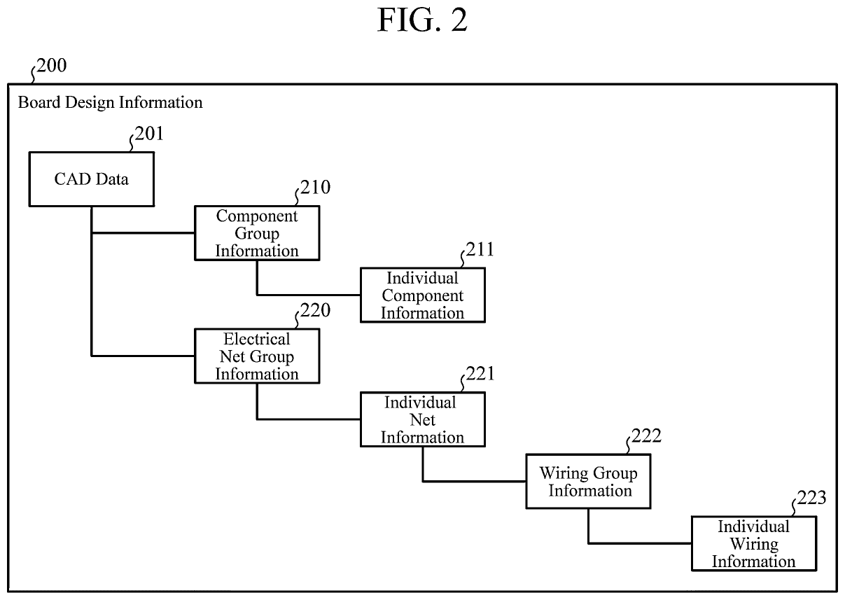

The board design information 200 is, for example, computer aided design (CAD) data 201 of a print board, and includes at least elements of component group information 210, individual component information 211, electrical net group information 220, individual net information 221, wiring group information 222, and individual wiring information 223 as internal information as illustrated in FIG. 2.

Each element has a hierarchical structure.

The individual component information 211 constituting the component group information 210 indicates component individual information for individual components mounted on the print board, such as the IC1, the pass capacitors C1 to C12, and an inductor (not illustrated), and the component individual information is information in which component specific information indicating a component model number and characteristics, a mounting outer shape, and the like are associated with each other.

The individual net information 221 constituting the electrical net group information 220 is an electrically independent individual net on the print board, such as a 1.0 V power supply system and a GND system. For example, in the print board described above, it is information indicating the positions of A1 to A8, . . . , H1 to H8 in one to six layers, that is, whether each node is a 1.0 V system or a GND system.

The wiring group information 222 is information indicating a group of wirings electrically connected to the individual net information 221.

The individual wiring information 223 constituting the wiring group information 222 is information indicating a type and a connection position of a terminal of the IC1, that is, a net, and a structure of an individual conductor constituting a print board, such as a mounting component, for example, a mounting pad to which the pass capacitors C1 to C12 are connected, wiring layers in respective layers, and vias connecting the layers.

For example, the individual wiring information 223 is information indicating that, in the print board described above, the pins located at B2, B4, B6, C3, C5, C7, D2, D4, D6, E3, E5, E7, F2, F4, F6, G3, G5, and G7 of the IC1 are the power supply terminals 1V, and the 1.0 V power supply system is connected to the power supply system. Similarly, it is information of the ground terminal 1G of the IC1.

Similarly, the individual wiring information 223 is individual information in the wiring layer of each layer mixed with net information in the IC power supply wiring layers 11V to 15V and the IC ground wiring layers 11G to 14G, the power supply switching wiring layers 21V to 26V and the ground switching wiring layers 21G to 26G, the GND pattern layer 30, the power supply pattern layer 40, the power supply switching pattern layers 51V and 52V and the ground switching pattern layer 51G, and the capacitor power supply wiring layers 61V and 62V and the capacitor ground wiring layer 61G, and is information regarding a wiring layout.

Similarly, the individual wiring information 223 is individual information in vias mixed with net information in the build-up vias 71V to 76V, 71G to 76G, IVH 81V to 86V, and 81G to 86G, and the build-up vias 91V to 96V, and 91G to 94G, and is information related to a wiring layout.

The search target selecting unit 102 includes an individual component selecting unit and an individual wiring selecting unit.

The individual component selecting unit in the search target selecting unit 102 refers to the individual component information 211 in the board design information 200 output from the board information input unit 101, and selects the IC1 and the pass capacitors C1 to C12 to be mounted on the print board.

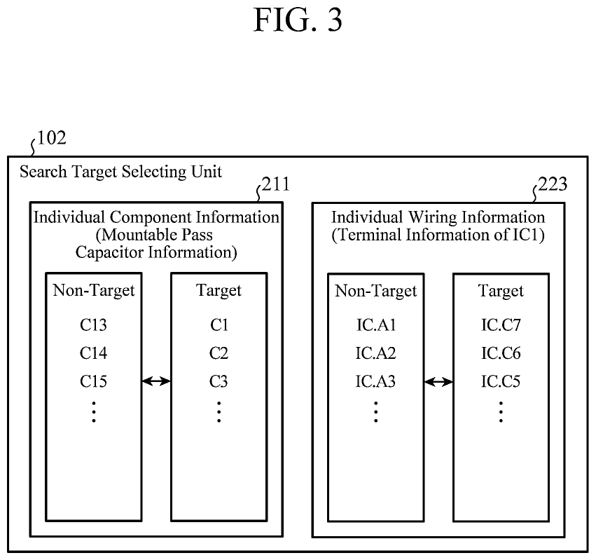

For example, as illustrated in FIG. 3, the individual component selecting unit in the search target selecting unit 102 selects the pass capacitors C1 to C12 as the search target for the print board, and classifies the other pass capacitors output from the board information input unit 101 as non-search targets.

The information set as search targets by the individual component selecting unit in the search target selecting unit 102 is information indicating an arrangement linked to the individual information of the search target pass capacitors C1 to C12, that is, an arrangement position in a six-layer pattern.

The individual wiring selecting unit in the search target selecting unit 102 refers to the individual wiring information 223 in the board design information 200 output from the board information input unit 101, and selects the power supply terminal 1V and the ground terminal 1G of the selected IC1.

When the individual component selecting unit selects the IC1 described above, as illustrated in FIG. 3, the individual wiring selecting unit in the search target selecting unit 102 classifies pins located at B2, B4, B6, C3, C5, C7, D2, D4, D6, E3, E5, E7, F2, F4, F6, G3, G5, and G7 as search targets as the power supply terminal 1V, pins located at B3, B5, C2, C4, C6, D3, D5, D7, E2, E4, E6, F3, F5, F7, G4, and G6 as search targets as the ground terminal 1G, and classifies the other pins as non-search targets.

The information set as search targets by the individual wiring selecting unit in the search target selecting unit 102 is information indicating an arrangement associated with the power supply terminal 1V and the ground terminal 1G of the IC1 as search targets, that is, the connection position in the one-layer pattern.

In FIG. 3, in the individual wiring information 223, an IC is attached to indicate a terminal of the IC1.

Note that the search target selecting unit 102 may automatically select the pass capacitors C1 to C12 connected to the same net and the power supply terminal 1V and the ground terminal 1G of the IC1 on the basis of the individual component information 211 and the individual net information 221 associated with the individual wiring information 223.

The connection path calculating unit 103 calculates a shortest distance of the wiring path from the connection position in the plurality of IC power supply wiring layers 11V to 15V corresponding to each of the plurality of power supply terminals 1V of the IC1 selected by the individual wiring selecting unit in the search target selecting unit 102 to the connection position in the capacitor power supply wiring layers 61V and 62V to which the respective power supply side electrodes of the pass capacitors C1 to C12 are connected.

Further, the connection path calculating unit 103 calculates a shortest distance of the wiring path from the connection position in each of the plurality of IC ground wiring layers 11G to 14G corresponding to each of the plurality of ground terminals 1G of the IC1 selected by the individual wiring selecting unit in the search target selecting unit 102 to the connection position in the capacitor ground wiring layer 61G to which the GND-side electrode of each of the pass capacitors C1 to C12 is connected.

For example, among the plurality of power supply terminals 1V of the IC1, a shortest distance to the position of C7 in the capacitor power supply wiring layer 61V to which the power supply side electrode of the pass capacitor C1 is connected, a shortest distance to the position of C6 in the capacitor power supply wiring layer 61V to which the power supply side electrode of the pass capacitor C2 is connected, a shortest distance to the position of C5 in the capacitor power supply wiring layer 61V to which the power supply side electrode of the pass capacitor C3 is connected, a shortest distance to the position of C4 in the capacitor power supply wiring layer 61V to which the power supply side electrode of the pass capacitor C4 is connected, a shortest distance to the position of C3 in the capacitor power supply wiring layer 61V to which the power supply side electrode of the pass capacitor C5 is connected, a shortest distance to the position of C2 in the capacitor power supply wiring layer 61V to which the power supply side electrode of the pass capacitor C6 is connected, a shortest distance to the position of F7 in the capacitor power supply wiring layer 62V to which the power supply side electrode of the pass capacitor C7 is connected, a shortest distance to the position of F6 in the capacitor power supply wiring layer 62V to which the power supply side electrode of the pass capacitor C8 is connected, a shortest distance to the position of F5 in the capacitor power supply wiring layer 62V to which the power supply side electrode of the pass capacitor C9 is connected, a shortest distance to the position of F4 in the capacitor power supply wiring layer 62V to which the power supply side electrode of the pass capacitor C10 is connected, a shortest distance to the position of F3 in the capacitor power supply wiring layer 62V to which the power supply side electrode of the pass capacitor C11 is connected, and a shortest distance to the position of F2 in the capacitor power supply wiring layer 62V to which the power supply side electrode of the pass capacitor C12 is connected from the position of C7 in the IC power supply wiring layer 11V to which the power supply terminal 1V located at C7 is connected, is calculated.

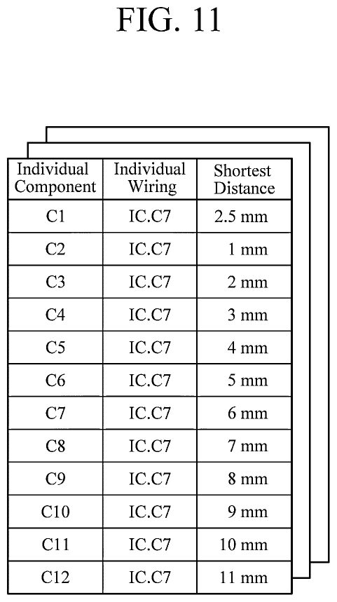

FIG. 11 illustrates an example of the calculation result.

For each of the plurality of power supply terminals 1V of the IC1, 18 power supply terminals 1V in the above example, similarly, a shortest distance from the connection position in the IC power supply wiring layers 11V to 15V to which the power supply terminal 1V is connected to the connection position in the capacitor power supply wiring layers 61V and 62V to which the respective power supply side electrodes of the pass capacitors C1 to C12 are connected is calculated.

In addition, for each of the plurality of ground terminals 1G of the IC1, 16 ground terminals 1G in the above example, similarly, a shortest distance from the connection position in the IC ground wiring layers 11G to 14G to which the ground terminal 1G is connected to the connection position in the capacitor ground wiring layer 61G to which the GND-side electrode of each of the pass capacitors C1 to C12 is connected is calculated.

In short, the connection path calculating unit 103 calculates a shortest distance of the wiring path of the 1.0 V power supply system on the print board in all combinations of each power supply terminal 1V of the IC1 and the power supply side terminals of the pass capacitors C1 to C12 and a shortest distance of the wiring path of the ground system in all combinations of each ground terminal 1G of the IC1 and the ground side terminals of the pass capacitors C1 to C12.

The information obtained by the connection path calculating unit 103 is information in which each of the power supply terminal 1V and the ground terminal 1G of the IC1, each of the pass capacitors C1 to C12, and each of the shortest distances are associated with each other.

The validity evaluating unit 104 relatively compares a shortest distance of the wiring path of the 1.0 V power supply system in the print board in all combinations of the power supply side terminals of the pass capacitors C1 to C12 with respect to each of the power supply terminals 1V of the IC1, determines that the pass capacitor in the wiring path in which the shortest distance indicates a minimum value is valid and the other are invalid, compares a shortest distance of the wiring path of the ground system in the print board in all combinations of the power supply side terminals of the pass capacitors C1 to C12 with respect to each of the ground terminals 1G of the IC1, determines that the pass capacitor in the wiring path in which the shortest distance indicates a minimum value is valid and the other are invalid, and finally determines a pass capacitor that has been determined as valid for at least one pass capacitor of the power supply terminal 1V and the ground terminal 1G of the IC1 as valid.

That is, the validity evaluating unit 104 extracts one pass capacitor having a shortest distance of the wiring path for each of the plurality of power supply terminals 1V and the plurality of ground terminals 1G of the IC1, determines the extracted pass capacitor as valid, and determines the other pass capacitors as invalid.

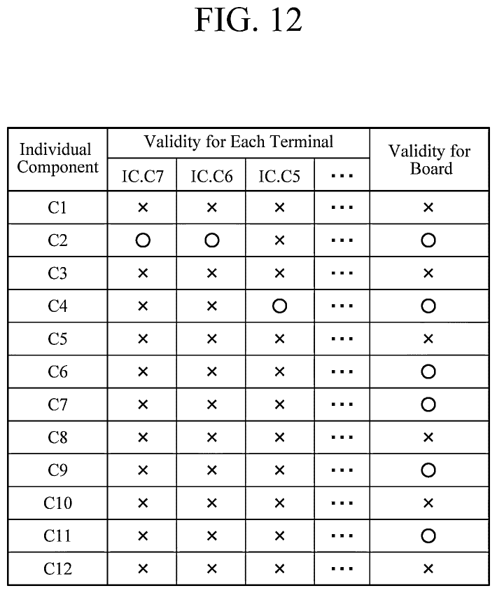

An example of a determination result for each of the plurality of power supply terminals 1V and the plurality of ground terminals 1G is illustrated in a column of validity for each terminal in FIG. 12.

FIG. 12 illustrates a result of determination that the pass capacitor C2 is valid for the power supply terminal 1V located at C7 of the IC1 (mark ∘ in the drawing) and the other pass capacitors are invalid (mark x in the drawing), illustrates a result of determination that the pass capacitor C2 is valid for the ground terminal 1G located at C6 of the IC1 (mark ∘ in the drawing) and the other pass capacitors are invalid (mark x in the drawing), and illustrates a result of determination that the pass capacitor C4 is valid for the power supply terminal 1V located at C5 of the IC1 (mark ∘ in the drawing) and the other pass capacitors are invalid (mark x in the drawing).

In addition, in FIG. 12, as a result of determining the validity of each of the plurality of power supply terminals 1V and the plurality of ground terminals 1G of the IC1 with respect to the pass capacitors C1 to C12, in at least one terminal of the plurality of power supply terminals 1V or the plurality of ground terminals 1G of the IC1, results of determining that the pass capacitors C2, C4, C6, C7, C9, and C11 enabled with respect to the pass capacitors are valid (mark ∘ in the drawing), and the other pass capacitors C1, C3, C5, C8, C10, and C12 are invalid (mark x in the drawing) are illustrated in the column of validity with respect to the board.

The information obtained by the validity evaluating unit 104 is pass capacitor individual information for the pass capacitors C2, C4, C6, C7, C9, and C11 determined to be valid for the board, which is associated with validity, and pass capacitor individual information for the pass capacitors C1, C3, C5, C8, C10, and C12 determined to be invalid, which is associated with invalidity.

In short, the validity evaluating unit 104 determines that among the pass capacitors C1 to C12, the pass capacitors C2, C4, C6, C7, C9, and C11 connected to the wiring path having the shortest distance calculated by the connection path calculating unit 103 are valid, and determines that the other pass capacitors C1, C3, C5, C8, C10, and C12 are invalid.

Note that the validity evaluating unit 104 determines that the final result is valid also when the pass capacitors C1 to C12 are determined to be valid in an overlapping manner with respect to the power supply terminal 1V and the ground terminal 1G of the IC1.

On the basis of the information obtained by the validity evaluating unit 104, the design changing unit 105 determines to mount the pass capacitor determined to be valid in the six-layer pattern of the print board, and not to mount the pass capacitor determined to be invalid in the six-layer pattern of the print board.

For example, in the above example, the design changing unit 105 determines that the pass capacitors C2, C4, C6, C7, C9, and C11 determined to be valid are pass capacitors to be mounted on the six-layer pattern of the print board, and that the pass capacitors C1, C3, C5, C8, C10, and C12 determined to be invalid, that is, not valid are pass capacitors not to be mounted on the six-layer pattern of the print board.

The information obtained by the design changing unit 105 is pass capacitor individual information for the pass capacitors C2, C4, C6, C7, C9, and C11 determined to be valid, associated with implementation.

The change result output unit 106 converts the information obtained by the design changing unit 105 into the format of the board design information 200 and outputs the converted information as a change result 300.

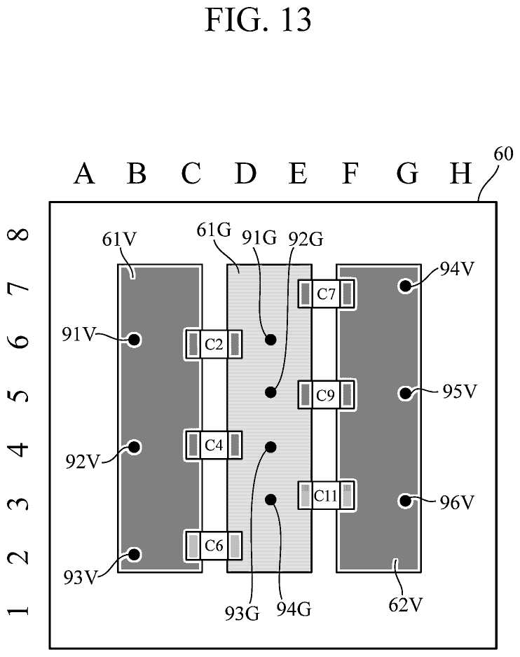

On the basis of the change result 300 obtained by the change result output unit 106, FIG. 13 illustrates an arrangement state of the pass capacitors C2, C4, C6, C7, C9, and C11 after design change arranged in the six-layer pattern displayed on a display device such as a display.

As described above, a shortest distance of the wiring path from the connection position in the plurality of IC power supply wiring layers 11V to 15V corresponding to each of the plurality of power supply terminals 1V of the IC1 to the connection position in the capacitor power supply wiring layers 61V and 62V to which the power supply side electrode of each of the pass capacitors C1 to C12 is connected and a shortest distance of the wiring path from the connection position in the plurality of IC ground wiring layers 11G to 14G corresponding to each of the plurality of ground terminals 1G of the IC1 to the connection position in the capacitor ground wiring layer 61G to which the GND-side electrode of each of the pass capacitors C1 to C12 is connected are calculated, the shortest distances to the pass capacitors C1 to C12 corresponding to each of the plurality of power supply terminals 1V and the plurality of ground terminals 1G of the IC1 are relatively compared, and a pass capacitor having a wiring path longer than a selected shortest distance, having a high impedance in the wiring path, and having a low contribution to reduction of impedance from the plurality of power supply terminals 1V and the plurality of ground terminals 1G of the IC1 to the pass capacitors C1 to C12 are eliminated, so that the number of bypass capacitors to be arranged can be optimized without deteriorating performance by the bypass capacitor.

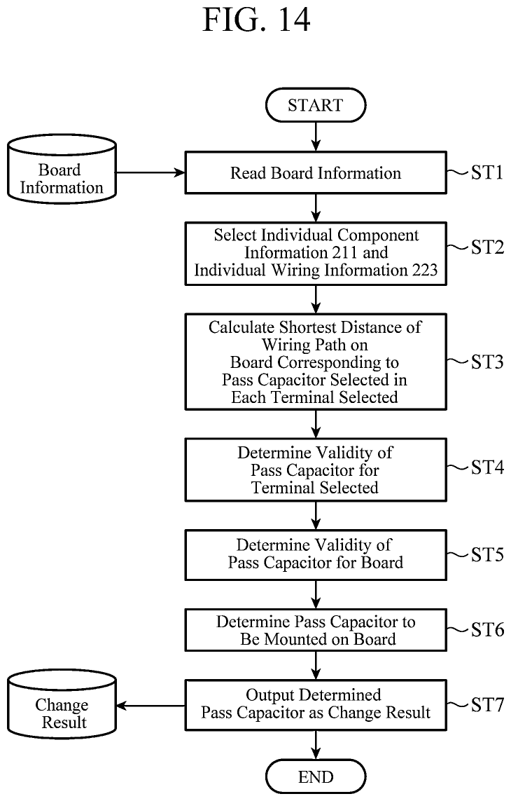

Next, operation of the print board design assistance system according to the first embodiment will be described with reference to FIG. 14.

As illustrated in step ST1, the search target selecting unit 102 reads the board design information 200 input by the board information input unit 101.

The search target selecting unit 102 classifies the read board design information 200 into target and non-target, and selects target individual component information 211 and individual wiring information 223 (step ST2).

As an example, as illustrated in FIG. 3, the pass capacitors C1 to C12 are selected as the individual component information 211 as search targets, and the power supply terminals 1V of the IC1 located at B2, B4, B6, C3, C5, C7, D2, D4, D6, E3, E5, E7, F2, F4, F6, G3, G5, and G7 and the ground terminals 1G located at B3, B5, C2, C4, C6, D3, D5, D7, E2, E4, E6, F3, F5, F7, G4, and G6 are selected as the search target as the individual wiring information 223.

Step ST2 is a selection step of selecting the plurality of power supply terminals 1V and the plurality of ground terminals 1G of the IC, and the pass capacitors C1 to C12 as search targets.

Note that when it is desired to know data illustrated in FIG. 3 in which the pass capacitors C1 to C12 that are the individual component information set as search targets and the power supply terminals 1V and the ground terminals 1G of the IC1 that are the individual wiring information set as search targets are arranged, the data may be output to the display device in the arrangement illustrated in FIG. 3.

The connection path calculating unit 103 calculates a shortest distance of the wiring path on the print board to each of the pass capacitors C1 to C12 for each of the plurality of power supply terminals 1V and the plurality of ground terminals 1G of the IC1 selected as search targets by the selection step (step ST3).

Step ST3 is a shortest distance calculating step of calculating the shortest distance of the wiring path on the print board corresponding to each of the pass capacitors C1 to C12 in each of the plurality of power supply terminals 1V and the plurality of ground terminals 1G of the IC1.

Calculation of the shortest distance of the wiring path will be described with reference to FIGS. 5 to 10, taking the power supply terminal 1V located at C7 illustrated in FIG. 4 as an example.

As illustrated in FIG. 5, with a position of C7 in the IC power supply wiring layer 11V in the one-layer pattern 10 to which the power supply terminal 1V located at C7 is connected as a start point PS, the build-up via 71V located at B6 in the IC power supply wiring layer 11V is reached from the start point PS via a path P1.

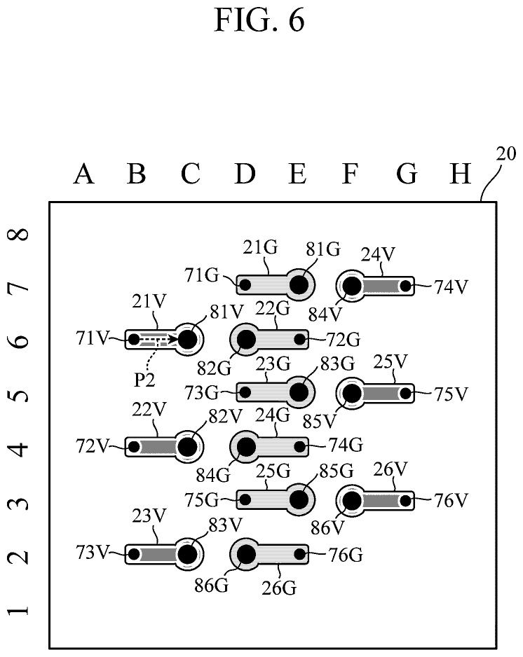

In the power supply switching wiring layer 21V in the two-layer pattern 20 from the build-up via 71V, as illustrated in FIG. 6, a path P2 leads to the IVH 81V located at C6 in the power supply switching wiring layer 21V.

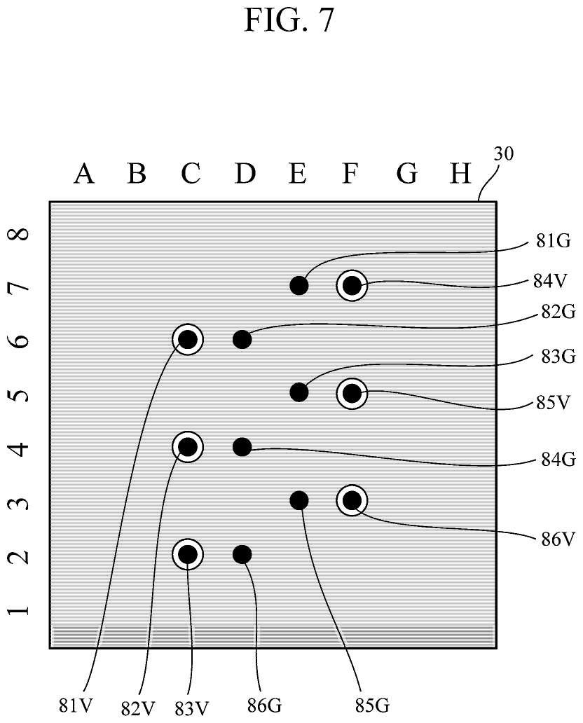

As illustrated in FIG. 7, the IVH 81V penetrates to the four-layer pattern 40 without being electrically connected to the three-layer pattern 30.

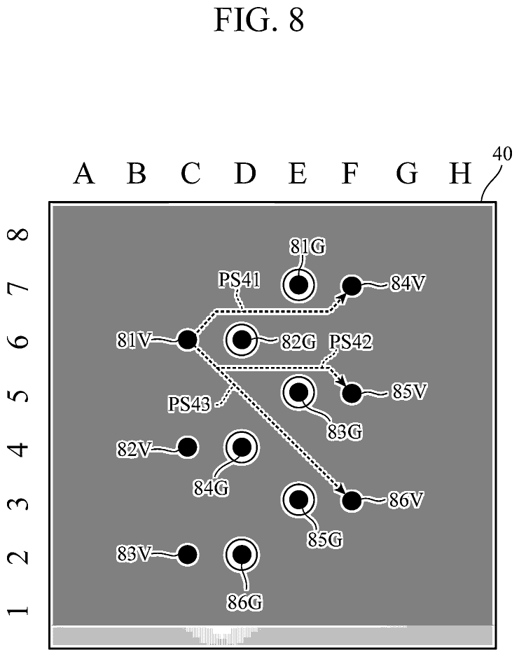

In the four-layer pattern 40, as illustrated in FIG. 8, a path from the IVH 81V to the five-layer pattern 50 is selected as a shortest distance for the pass capacitors C1 to C6, a path to the IVH 84V via a path P41 is selected as a shortest distance for the pass capacitors C7 and C8, a path to the IVH 85V via a path P42 is selected as a shortest distance for the pass capacitors C9 and C10, and a path to the IVH 86V via a path P43 is selected as a shortest distance for the pass capacitors C11 and C12 are selected as shortest distances.

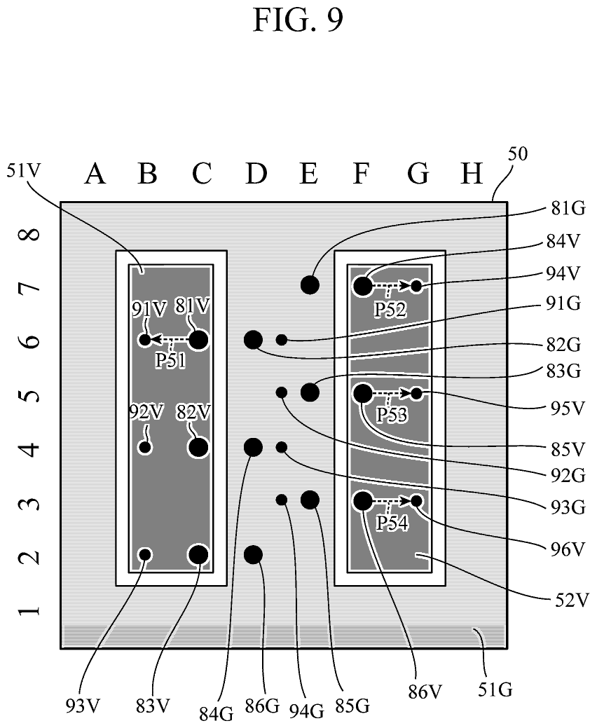

In the five-layer pattern 50, as illustrated in FIG. 9, a path from the IVH 81V to the build-up via 91V via a path P51 in a power supply switching pattern layer 51V, a path from the IVH 84V to the build-up via 94V via a path P52 in a power supply switching pattern layer 52V, a path from the IVH 85V to the build-up via 95V via a path P53 in a power supply switching pattern layer 52V, and a path from the IVH 86V to the build-up via 96V via a path P54 in a power supply switching pattern layer 52V are selected as shortest distances corresponding to the pass capacitors C1 to C12.

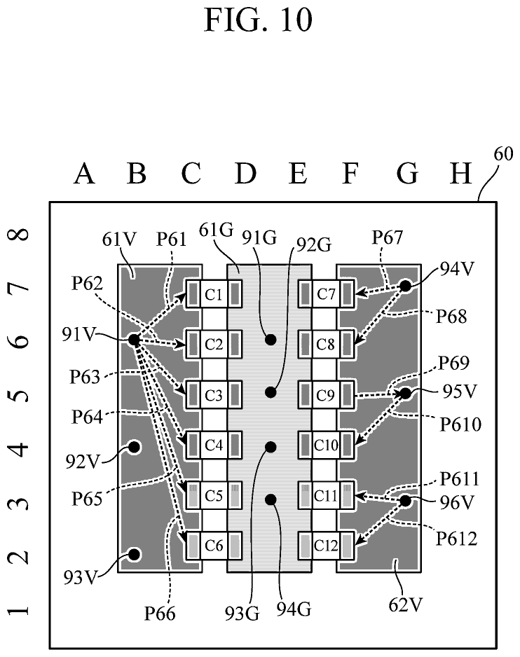

In the six-layer pattern 60, as illustrated in FIG. 10, the following path is selected as a shortest distance.

A path from the build-up via 91V to an end point PE1 which is the position of C7 in the capacitor power supply wiring layer 61V to which the power supply side terminal of the pass capacitor C1 is connected via a path P61.

A path from the build-up via 92V to an end point PE2 which is the position of C6 in the capacitor power supply wiring layer 61V to which the power supply side terminal of the pass capacitor C2 is connected via a path P62.

A path from the build-up via 91V to an end point PE3 which is the position of C5 in the capacitor power supply wiring layer 61V to which the power supply side terminal of the pass capacitor C3 is connected via a path P63.

A path from the build-up via 91V to an end point PE4 which is the position of C4 in the capacitor power supply wiring layer 61V to which the power supply side terminal of the pass capacitor C4 is connected via a path P64.

A path from the build-up via 92V to an end point PE5 which is the position of C3 in the capacitor power supply wiring layer 61V to which the power supply side terminal of the pass capacitor C5 is connected via a path P65.

A path from the build-up via 91V to an end point PE6 which is the position of C2 in the capacitor power supply wiring layer 61V to which the power supply side terminal of the pass capacitor C6 is connected via a path P66.

A path from the build-up via 94V to an end point PE7 which is the position of F7 in the capacitor power supply wiring layer 62V to which the power supply side terminal of the pass capacitor C7 is connected via a path P67.

A path from the build-up via 94V to an end point PE8 which is the position of F6 in the capacitor power supply wiring layer 62V to which the power supply side terminal of the pass capacitor C8 is connected via a path P68.

A path from the build-up via 95V to an end point PE9 which is the position of F5 in the capacitor power supply wiring layer 62V to which the power supply side terminal of the pass capacitor C9 is connected via a path P69.

A path from the build-up via 95V to an end point PE10 which is the position of F4 in the capacitor power supply wiring layer 62V to which the power supply side terminal of the pass capacitor C10 is connected via a path P610.

A path from the build-up via 96V to an end point PE11 which is the position of F3 in the capacitor power supply wiring layer 62V to which the power supply side terminal of the pass capacitor C11 is connected via a path P611.

A path from the build-up via 96V to an end point PE12 which is the position of F2 in the capacitor power supply wiring layer 62V to which the power supply side terminal of the pass capacitor C12 is connected via a path P612.

Therefore, the shortest distance of the wiring path on the print board corresponding to the pass capacitor C1 with respect to the power supply terminal 1V located at C7 is a path leading as the start point PS—the path P1—the build-up via 71V—the path P2—the IVH 81V—the path P51—the build-up via 91V—the path P61—the end point PE1. This path is calculated by the connection path calculating unit 103.

Similarly, a shortest distance of the wiring path on the print board corresponding to the pass capacitors C2 to C12 with respect to the power supply terminal 1V located at C7 is also calculated by the connection path calculating unit 103.

FIG. 11 illustrates an example of the shortest distance of the wiring path on the print board corresponding to the pass capacitors C1 to C12 with respect to the power supply terminal 1V located at C7 obtained by the connection path calculating unit 103 in this manner.

Note that when it is desired to know data illustrated in FIG. 11 in which information indicating the pass capacitors C1 to C12 that are the individual component information, the power supply terminal 1V and the ground terminal 1G of the IC1 that are the individual wiring information, and the shortest distance is arranged as one set, the data may be output to the display device by the arrangement illustrated in FIG. 11.

In step ST3 of calculating a shortest distance of the wiring path on the circuit board, when calculation of a shortest distance of the wiring path on the print board corresponding to the pass capacitors C1 to C12 is completed in all of the plurality of power supply terminals 1V and the plurality of ground terminals 1G of the IC1, the validity evaluating unit 104 relatively compares shortest distances of the wiring paths on the print board corresponding to the pass capacitors C1 to C12 in each of the plurality of power supply terminals 1V and the plurality of ground terminals 1G of the IC1, determines that a pass capacitor in which the shortest distance indicates the minimum value is valid, and determines that the remaining pass capacitors are invalid (step ST4).

Step ST4 is a first validity determining step of determining validity of the pass capacitors C1 to C12 for each of the plurality of power supply terminals 1V and the plurality of ground terminals 1G of the IC1.

When the validity evaluating unit 104 ends the determination of the validity of the pass capacitors C1 to C12 for each of the plurality of power supply terminals 1V and the plurality of ground terminals 1G of the IC1, the validity evaluating unit 104 determines that the pass capacitor determined to be valid in at least one terminal of the plurality of power supply terminals 1V or the plurality of ground terminals 1G is valid for the print board, and determines that other pass capacitors are invalid, that is, not valid for the print board (step ST5).

Step ST5 is a second validity determining step of determining validity of the pass capacitors C1 to C12 on the print board.

An example of a determination result of validity for each terminal obtained by the validity evaluating unit 104 in the first validity determining step and a determination result of validity for a board obtained in the second validity determining step in this manner is illustrated in FIG. 12.

Note that when it is desired to know data in which information indicating a determination result of validity for each of the power supply terminal 1V and the ground terminal 1G of the pass capacitors C1 to C12 and the IC1, which are the individual component information, and a determination result of validity for the board illustrated in FIG. 12 is arranged as one set, the data may be output to the display device by the arrangement illustrated in FIG. 12.

On the basis of information obtained by the validity evaluating unit 104, the design changing unit 105 determines to mount a pass capacitor determined to be valid on the print board and not to mount a pass capacitor determined to be invalid on the print board (step ST6).

Step ST6 is a pass capacitor determining step of determining a pass capacitor to be mounted on the print board.

The change result output unit 106 converts information by the pass capacitor determined in step ST6 into a format of the board design information 200, outputs the information as a change result 300 (step ST7), and ends the process.

On the basis of the change result 300, FIG. 13 illustrates an arrangement state of the pass capacitors C2, C4, C6, C7, C9, and C11 after the design change displayed on the display device such as the display.

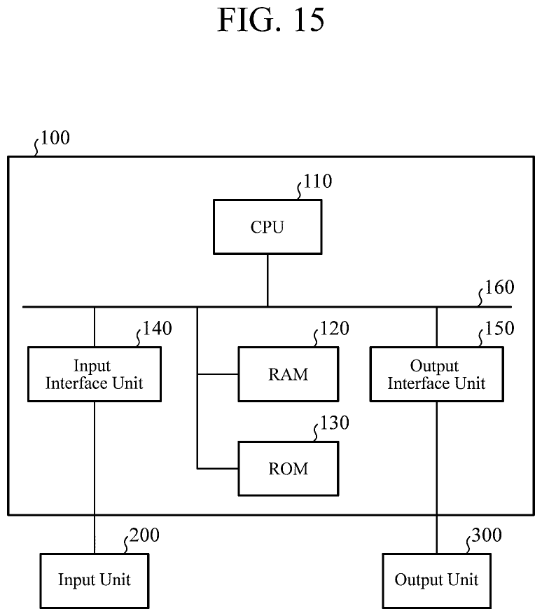

The search target selecting unit 102, the connection path calculating unit 103, the validity evaluating unit 104, and the design changing unit 105 in the design assistance system according to the first embodiment are implemented by a hardware configuration of a computer, and as illustrated in FIG. 15, include a central processing unit (CPU) 110, a large-capacity semiconductor memory (random access memory (RAM)) 120, a storage device (read only memory (ROM)) 130 such as a nonvolatile recording device such as a hard disk device or an SSD device, an input interface unit 140, an output interface unit 150, and a signal path (bus) 160.

The CPU 110 controls and manages the RAM 120, the ROM 130, the input interface unit 140, and the output interface unit 150.

The CPU 110 loads a program stored in the ROM 130 into the RAM 120, and the CPU 110 executes various processes on the basis of the program loaded into the RAM 120.

The print board design assistance method for the print board in steps ST2 to ST6 is performed by the CPU 110 executing processing according to the program stored in the ROM 130.

That is, the program stored in the ROM 130 includes a selecting procedure of selecting a plurality of power supply terminals and a plurality of ground terminals of a semiconductor integrated circuit device to be mounted on the board, and a plurality of bypass capacitors mountable on the board, as search targets, a shortest distance calculating procedure of calculating a shortest distance of a wiring path on the board corresponding to each of the plurality of bypass capacitors for each of the selected plurality of power supply terminals and the selected plurality of ground terminals of the semiconductor integrated circuit device, a first validity determining procedure of relatively comparing the shortest distances of the wiring paths on the board corresponding to each of the plurality of bypass capacitors calculated at each of the plurality of power supply terminals and the plurality of ground terminals of the semiconductor integrated circuit device, determining that a bypass capacitor whose shortest distance indicates a minimum value is valid, and determining that the remaining bypass capacitors are invalid, a second validity determining procedure of determining that a bypass capacitor determined to be valid in at least one of the plurality of power supply terminals or the plurality of ground terminals of the semiconductor integrated circuit device is valid for a board and determining that other bypass capacitors are invalid for the board, and a pass capacitor determining procedure of determining, from among the plurality of bypass capacitors, a bypass capacitor determined to be valid for the board as a bypass capacitor to be mounted on the board.

Note that the print board design assistance system according to the first embodiment calculates a shortest distance of the wiring path of the 1.0 V power supply system in the print board in all combinations of each of the power supply terminals 1V of the IC1 and the power supply side terminals of the pass capacitors C1 to C12 and a shortest distance of the wiring path of the ground system in all combinations of the ground terminal 1G of the IC1 and the ground side terminals of the pass capacitors C1 to C12, extracts one pass capacitor having a shortest distance of the wiring path for each of the plurality of power supply terminals 1V and the plurality of ground terminals 1G of the IC1, determines the extracted pass capacitors as valid, and determines the other cases as invalid, but may be configured to calculate a shortest distance of the wiring path of the 1.0 V power supply system in the print board in all combinations of each of the power supply terminals 1V of the IC1 and the power supply side terminals of the pass capacitors C1 to C12, and extract one pass capacitor having a shortest wiring path for each of the plurality of power supply terminals 1V of the IC1, and may determine that the extracted pass capacitor is valid, and that the other pass capacitors are invalid.

As described above, in the print board design assistance system according to the first embodiment, the connection path calculating unit 103 calculates a shortest distance of a wiring path from the connection position in each of the plurality of IC power supply wiring layers 11V to 15V corresponding to each of the plurality of power supply terminals 1V of the IC1 to the connection position in each of the capacitor power supply wiring layers 61V and 62V to which the power supply side electrodes of the pass capacitors C1 to C12 are connected, the validity evaluating unit 104 relatively compares shortest distances to the pass capacitors C1 to C12 corresponding to each of the plurality of power supply terminals 1V of the IC1 calculated by the connection path calculating unit 103, determines that the bypass capacitor connected to the wiring path having a shortest distance indicating the minimum value as a result of the relative comparison is valid, and determines that the other bypass capacitors are invalid, and the design changing unit 105 determines that, among the plurality of the pass capacitors C1 to C12, the pass capacitors determined to be valid by the validity evaluating unit 104 with respect to the print board is to be mounted on the board, and the pass capacitor determined to be invalid by the validity evaluating unit 104 with respect to the print board is not to be mounted on the board, and deletes the pass capacitor for which wiring path is longer than a shortest distance selected as the minimum value for each pass capacitor and whose impedance in the wiring path is high and contribution to reduction of the impedance from each of the plurality of power supply terminals 1V of the IC1 to the pass capacitors C1 to C12 is low, so that the number of bypass capacitors to be arranged can be optimized without deteriorating the performance by the bypass capacitor.

In the print board design assistance system according to the first embodiment, the connection path calculating unit 103 further calculates a shortest distance of the wiring path from the connection position in the plurality of IC ground wiring layers 11G to 14G corresponding to each of the plurality of ground terminals 1G of the IC1 to the connection position in the capacitor ground wiring layer 61G to which the GND-side electrode of each of the pass capacitors C1 to C12 is connected, and the validity evaluating unit 104 further relatively compares shortest distances to the pass capacitors C1 to C12 corresponding to each of the plurality of ground terminals 1G of the IC1 calculated by the connection path calculating unit 103, determines that the bypass capacitor connected to the wiring path having a shortest distance indicating the minimum value as a result of the relative comparison is valid, and determines that the other bypass capacitors are invalid, it is possible to eliminate a bypass capacitor having a low contribution to reduction of impedance from the plurality of ground terminals 1G of the IC1 to the pass capacitors C1 to C12, and it is possible to further optimize the number of bypass capacitors to be arranged without deteriorating performance by the bypass capacitor.

### Second Embodiment

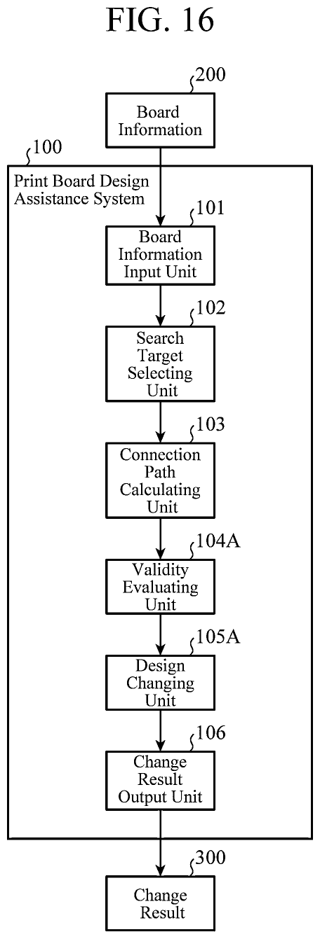

A print board design assistance system according to a second embodiment will be described with reference to FIGS. 16 to 20.

The design assistance system according to the second embodiment is different from the design assistance system according to the first embodiment only in a validity evaluating unit 104A and a design changing unit 105A, and is the same in other points.

Therefore, the validity evaluating unit 104A and the design changing unit 105A will be mainly described.

Note that the pin arrangement of the IC1 and a pattern of a surface in each layer immediately below the mounting region of the IC1 in the print board are the same as those illustrated in FIGS. 4 to 10 in the first embodiment.

Further, in FIGS. 16 to 20, the same reference numerals as those in FIGS. 1 to 15 denote the same or corresponding parts.

The validity evaluating unit 104A is the same as the validity evaluating unit 104 in the design assistance system according to the first embodiment with respect to a function of extracting one pass capacitor having a shortest distance of the wiring path for each of the plurality of power supply terminals 1V and the plurality of ground terminals 1G of the IC1, validating the extracted pass capacitor, and determining that the other pass capacitors are invalid, and a function of determining that the pass capacitors determined to be valid in at least one terminal of the plurality of power supply terminals 1V or the plurality of ground terminals 1G is valid for the print board, and determining that the other pass capacitors are invalid, that is, not valid for the print board.

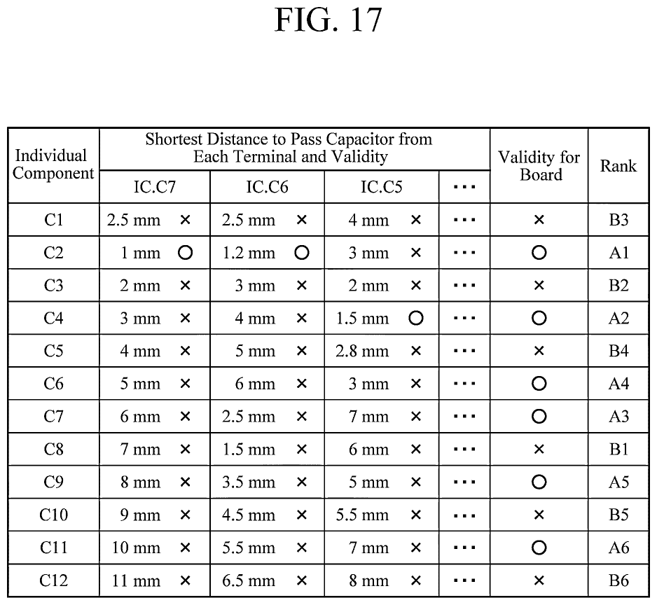

In FIG. 17, an example of a shortest distance calculated by the connection path calculating unit 103 and a determination result for each of the plurality of power supply terminals 1V and the plurality of ground terminals 1G is illustrated in a column of the shortest distance from each terminal to the pass capacitor and validity, and a determination result of validity for the board is illustrated in a column of validity for the board.

In FIG. 17, examples illustrated in the column of the shortest distance from each terminal to the pass capacitor and validity and the column of validity for the board are the same as the examples illustrated in FIGS. 11 and 12 in the first embodiment.

The validity evaluating unit 104A further has a function of grouping into the pass capacitors C2, C4, C6, C7, C9, and C11 determined to be valid for the print board and the pass capacitors C1, C3, C5, C8, C10, and C12 determined to be invalid for the print board on the basis of the determination result of the validity for the print board, and giving priority to each group.

The validity evaluating unit 104A performs ranking on the basis of a value of a shortest distance for each of the pass capacitors of a group A determined to be valid and a group B determined to be invalid for the print board.

In the ranking for each of the groups A and B, shortest distances of wiring paths in the print board calculated in each of the plurality of power supply terminals 1V and the plurality of ground terminals 1G of the IC1 are relatively compared in the pass capacitor belonging to each of the groups A and B, a shortest distance of a minimum value is obtained, validity of a pass capacitor in which a value of the shortest distance of the minimum value is small is evaluated higher, and ranking of validity is performed for each of the groups A and B.

For example, for the group A of the pass capacitors C2, C4, C6, C7, C9, and C11 determined to be valid for the print board, ranking of validity is performed as follows.

For each of the pass capacitors C2, C4, C6, C7, C9, and C11, the minimum value of the shortest distance of the wiring path in the print board calculated in each of the plurality of power supply terminals 1V and the plurality of ground terminals 1G of the IC1 is relatively compared to obtain the shortest distance of the minimum value. For example, a minimum shortest distance to each pass capacitor is obtained as a shortest distance to the power supply terminal 1V located at C7 for the pass capacitor C2 and a shortest distance to the power supply terminal 1V located at C5 for the pass capacitor C4.

Next, obtained minimum shortest distances for respective pass capacitors are relatively compared, and ranking of validity is performed by evaluating validity of a pass capacitor having a small value of a shortest distance of a minimum value higher. For example, as illustrated in a column of rank of FIG. 17, ranking is performed in such a manner that A1 is the pass capacitor C2, A2 is the pass capacitor C4, A3 is the pass capacitor C7, A4 is the pass capacitor C6, A5 is the pass capacitor C9, and A6 is the pass capacitor C11 in descending order of the evaluation.

Similarly to the group A, the group B of the pass capacitor C1, C3, C5, C8, C10, and C12 determined to be invalid is ranked, for example, as illustrated in the column of rank of FIG. 17, in descending order of the evaluation, B1 is the pass capacitor C8, B2 is the pass capacitor C3, B3 is the pass capacitor C1, B4 is the pass capacitor C5, B5 is the pass capacitor C10, and B6 is the pass capacitor C12.

That is, the validity evaluating unit 104A ranks the validity as A1 with the highest validity, then A2 to A6, and further B1 to B6, and B6 with the lowest validity.

On the basis of the validity ranking obtained by the validity evaluating unit 104A, the design changing unit 105A sequentially accumulates pass capacitors in ascending order of the validity rank to set the pass capacitors as deletion candidates, and selects a mounting candidate pass capacitor having a different capacitance value in such a manner that a total capacitance value of mounting candidate pass capacitors becomes equal to or more than a total capacitance value of all mountable pass capacitors when a total capacitance value of pass capacitors (hereinafter, referred to as a mounting candidate pass capacitor) in a case of excluding the pass capacitors set as deletion candidate is less than the total capacitance value of all the non-deleted pass capacitors C1 to C12 (hereinafter, referred to as “all mountable pass capacitors”).

The mountable total pass capacitors are a plurality of temporarily determined pass capacitors C1 to C12 mountable on the mounting surface of the print board, and are pass capacitors C1 to C12 selected as search targets by the individual component selecting unit in the search target selecting unit 102.

The total capacitance value of the pass capacitors C1 to C12 selected as search targets is equal to or more than a capacitance value that satisfies the performance by the bypass capacitor for the IC1.

For the capacitance value of each of the pass capacitors C1 to C12, a pass capacitor with an equal capacitance value is selected from pass capacitors registered in the individual component selecting unit in the search target selecting unit 102 in order to avoid deterioration of characteristics due to antiresonance.

Each of the selected pass capacitors C1 to C12 is a pass capacitor that is the minimum capacitance value among the pass capacitors registered in the individual component selecting unit in which the total capacitance value is equal to or more than a capacitance value satisfying the performance by the bypass capacitor for the IC1.

Similarly, each mounting candidate pass capacitor is also selected from pass capacitors registered in the individual component selecting unit in the search target selecting unit 102.

Each mounting candidate pass capacitor to be selected is a pass capacitor that is a minimum capacitance value among the pass capacitors registered in the individual component selecting unit in which the total capacitance value of the mounting candidate pass capacitor is equal to or more than a capacitance value satisfying the performance by the bypass capacitor for the IC1.

In short, the design changing unit 105A selects the pass capacitors in which the total capacitance value of the mounting candidate pass capacitors satisfies the total capacitance value or more of all the mountable pass capacitors and the mounting candidate pass capacitors have the same capacitance value.

Therefore, the design changing unit 105A selects, as mounting candidate pass capacitors that do not degrade performance by the bypass capacitor for the IC1 and avoid deterioration of characteristics due to antiresonance, pass capacitors having a minimum capacitance value that satisfies the condition from among pass capacitors registered in the individual component selecting unit in the search target selecting unit 102.

On the basis of the ranking of validity obtained by the validity evaluating unit 104A, the design changing unit 105A sequentially accumulates pass capacitors in ascending order of the validity rank to set the pass capacitors as deletion candidates, impedances between the plurality of power supply terminals 1V and the plurality of ground terminals 1G of the IC1 is compared with a set impedance in a case of excluding the pass capacitors set as deletion candidates, and in the comparison result, when the impedance between the plurality of power supply terminals 1V and the plurality of ground terminals 1G of the IC1 is lower than the set impedance and an immediately preceding comparison result is high, it is determined not to mount pass capacitors up to the time when the comparison result is obtained on the print board, and to mount the remaining pass capacitors on the print board.

The design changing unit 105A has functions of pass capacitor change ranking determination, pass capacitor change, impedance calculation, change result comparison, and optimization completion determination.

The functions are as follows.

In the function of the pass capacitor change ranking determination, the deletion rank of pass capacitors having a low validity rank is set higher on the basis of the ranking of validity obtained by the validity evaluating unit 104A.

That is, the deletion rank of the pass capacitors C1 to C12 is opposite to the ranking of validity obtained by the validity evaluating unit 104A.

In the function of the pass capacitor change, pass capacitors whose deletion rank is set higher by the function of the pass capacitor change ranking determination are set as deletion candidates accumulated in order from a pass capacitor having a highest deletion rank, that is, not to be mounted on the print board, and when it is determined that a comparison result is high in the function of the change result comparison, pass capacitors up to the deletion rank that have been determined as deletion candidates immediately before are set as deletion candidates again.

In addition, when the function of the optimization completion determination determines that completion is not possible, the function of the pass capacitor change sets up to a pass capacitor having a next highest deletion rank as a deletion candidate.

For example, in the initial state, when all the pass capacitors C1 to C12 are to be mounted on the board (all the pass capacitors that can be mounted), that is, there are no deletion candidates, and the function of the optimization completion determination determines that completion is not possible, the function of the pass capacitor change sets a pass capacitor having a highest deletion rank as a deletion candidate, and determine 11 pass capacitors to be mounted on the board in this example.

When the function of the optimization completion determination determines that completion is not possible, the function of the pass capacitor change sequentially sets a pass capacitor as a deletion candidate from a pass capacitor having a higher deletion rank and, in this example, sets that 10 pass capacitors and 9 pass capacitors are to be mounted on the board in this order.

Further, when the comparison result is determined to be high by the function of the change result comparison, the function of the pass capacitor change is returned to a deletion candidate that has been set as a deletion candidate immediately before, and sets that a number of pass capacitors to which one pass capacitor is added are to be mounted on the board. For example, when a comparison result is high in a case where the deletion rank is 7, in other words, five pass capacitors are to be mounted on the board, the function of the pass capacitor change sets the deletion rank to 6, in other words, sets that six pass capacitors in which one pass capacitor is added are to be mounted on the board.

Further, the function of the pass capacitor change compares a total capacitance value of pass capacitors (mounting candidate pass capacitors) to be mounted on the board with a total capacitance value of all mountable pass capacitors C1 to C12, and when the total capacitance value of the mounting candidate pass capacitors is less than the total capacitance value of all the mountable pass capacitors C1 to C12, a pass capacitor having a next highest capacitance value registered in the individual component selecting unit in the search target selecting unit 102 with respect to the capacitance value of the mounting candidate pass capacitors is selected as the mounting candidate pass capacitor.

The function of the impedance calculation is to calculate an impedance between the plurality of power supply terminals 1V and the plurality of ground terminals 1G of the IC1 of the mounting candidate pass capacitor.

The impedance is calculated by a generally known calculation method, for example, electromagnetic field analysis using a 3D model extracted from the board design information 200 input by the board information input unit 101, or circuit analysis using equivalent circuit conversion.

In the function of the change result comparison, a calculation result of the impedance is compared with a set impedance (hereinafter, referred to as a set value), and when the calculation result of the impedance is higher than the set value, the function returns to the function of the pass capacitor change.

When the function returns to the function of the pass capacitor change, the function of the pass capacitor change is returned to the deletion candidate that has been set as a deletion candidate immediately before, and sets that a number of pass capacitors to which one pass capacitor is added are to be mounted on the board.

The set value is also a target value when the IC1 is mounted on the print board.

When the function of the pass capacitor change indicates the initial state, or when the comparison result is determined that the calculation result of the impedance is lower than the set value and a comparison result immediately before the comparison result is also low in the function of the change result comparison, the function of the optimization completion determination determines that optimization of the pass capacitor arrangement is not possible, and the function returns to the function of the pass capacitor change.

Returning to the function of the pass capacitor change, the function of the pass capacitor change sets deletion candidates up to a pass capacitor whose deletion rank is higher by one as deletion candidates, that is, sets that a number of pass capacitors from which one pass capacitor is deleted are to be mounted on the board.

Further, when the comparison result indicates that the calculation result of the impedance is lower than the set value and a comparison result immediately before the comparison result is high in the function of the change result comparison, the function of the optimization completion determination determines that optimization of the arrangement of the pass capacitors is completed, deletes pass capacitors up to the deletion rank when the comparison result is obtained, and the remaining pass capacitors are determined to be mounted on the board.

As described above, since the shortest distances to the pass capacitors C1 to C12 corresponding to each of the plurality of power supply terminals 1V and the plurality of ground terminals 1G of the IC1 are relatively compared, and the pass capacitors to be mounted on the print board are determined after the ranking of validity is performed, it is possible to increase accuracy and efficiency of optimization of the number of pass capacitors to be mounted on the print board by setting the impedance between the plurality of power supply terminals and the plurality of ground terminals of the IC1 to be equal to or less than the set value without deteriorating the performance by the bypass capacitor for the IC1.

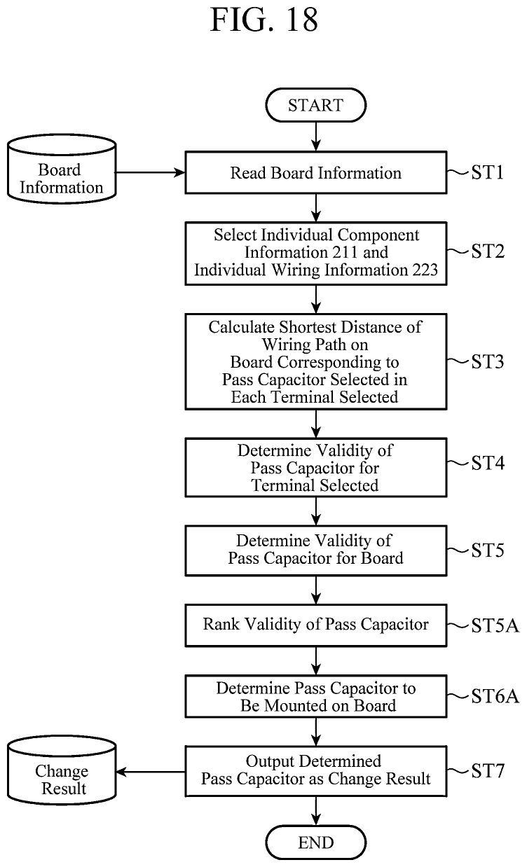

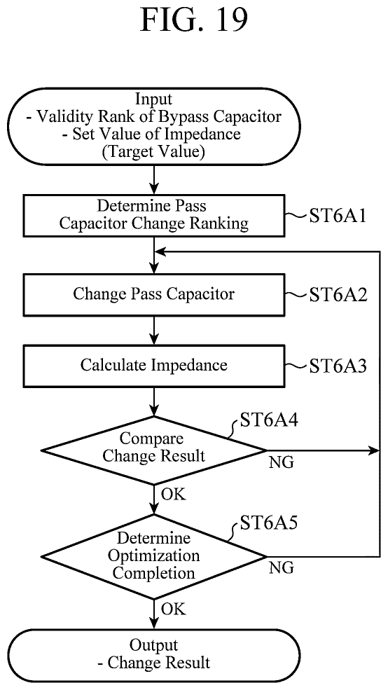

Next, operation of the print board design assistance system according to the second embodiment will be described with reference to FIGS. 18 and 19.

Since steps ST1 to ST5 are the same as those of the design assistance system according to the first embodiment, the description thereof will be omitted.

FIG. 17 illustrates an example of shortest distances from each of the plurality of power supply terminals 1V and the plurality of ground terminals 1G of the IC1 to the pass capacitor C1 to C12 and determination results of validity for each terminal obtained by the validity evaluating unit 104A in the first validity determining step ST4 and determination results of validity for the board obtained in the second validity determining step ST5.

The validity evaluating unit 104A relatively compares minimum values of shortest distances in each of the pass capacitors of the group A of the pass capacitors determined to be valid and the pass capacitors of the group B determined to be invalid with respect to the print board, and ranks the groups A and B as having higher validity from a smaller one of the minimum values (step ST5A).

Step 5A is a validity ranking step.

An example of the rank of validity obtained by the validity evaluating unit 104A in step ST5A is illustrated in the column of validity in FIG. 17.

Note that, when it is desired to know data in which the pass capacitors C1 to C12 that are the individual component information, information indicating the shortest distances from each of the power supply terminals 1V and the ground terminals 1G of the IC1 to the pass capacitors C1 to C12 that are the individual wiring information and information indicating a determination result of validity for each terminal, information indicating a determination result of validity for the board obtained by the second validity determining step, and information indicating a rank of validity in the pass capacitors C1 to C12 are arranged as one set illustrated in FIG. 17, the data may be output to the display device by an arrangement illustrated in FIG. 17.

Step ST6A is a pass capacitor determining step in which the design changing unit 105A determines a pass capacitor to be mounted on the print board on the basis of information obtained by the validity evaluating unit 104A.

The pass capacitor determining step ST6A includes steps ST6A1 to ST6A5.

The total capacitance value of the pass capacitors C1 to C12 for the IC1 is a capacitance value that satisfies the performance by the bypass capacitor for the IC1, for example, 12.0 μF.

Therefore, respective capacitance values of the pass capacitors C1 to C12 with respect to the IC1 mountable on the print board are equal to each other, and a pass capacitor of 1.0 μF, which satisfies that a total capacitance value is 12.0 μF or more, is selected as a pass capacitor in the initial state from among the pass capacitors registered in the individual component selecting unit in the search target selecting unit 102 without deteriorating the performance of the entire pass capacitor.

In the second embodiment, it is assumed that a total capacitance value of a pass capacitor mounted on the board satisfies that a total capacitance value of the pass capacitors C1 to C12 in the initial state is 12.0 μF or more, and optimization of the number of pass capacitors mounted on the board and the arrangement position is obtained by the pass capacitor determining step ST6A in such a manner that the impedance between the plurality of power supply terminals and the plurality of ground terminals of the IC1 is equal to or less than the set value without deteriorating the performance of all pass capacitors connected to the power supply terminal 1V of the IC1.

In step ST6A1, the design changing unit 105A ranks the deletion candidates of the pass capacitor C1 to C12 in ascending order of validity rank from the ranking obtained by the validity evaluating unit 104A.

Ranking of deletion candidates corresponds to a step of determining an arrangement position of a bypass capacitor to be mounted on the print board and a change order of the number of pass capacitors to be connected to the power supply terminal 1V and the ground terminal 1G of the IC1.

Step ST6A1 is a step of determining a change order of the pass capacitor.

In the first state in which the capacitance value of each of the pass capacitors C1 to C12 is set to 1.0 μF, it is determined in step ST6A2 that the deletion candidate is 0, that is, all the pass capacitors C1 to C12 are to be mounted on the print board, and the process proceeds to step ST6A2.

In step ST6A3, the design changing unit 105A calculates the impedance between the plurality of power supply terminals 1V and the plurality of ground terminals 1G of the IC1 when all the pass capacitors C1 to C12 are mounted on the print board by electromagnetic field analysis or circuit analysis by equivalent circuit conversion on the basis of the board design information 200 input by the board information input unit 101.

Step ST6A3 is a step of calculating the impedance.

In step ST6A4, a calculation result of the impedance is compared with the set value of the impedance input by the board information input unit 101.

If the calculation result of the impedance is lower than the set value, that is, OK, the process proceeds to step ST6A5.

Step ST6A4 is a step of comparing impedances when the number (including the arrangement) of pass capacitors to be mounted on the print board is changed.

In step ST6A5, since it is the initial state, it is determined as NG and the process returns to step ST6A2.

In step ST6A2, it is assumed that deletion candidates up to a pass capacitor whose deletion rank is higher by one are set as deletion candidates, that is, a number of pass capacitors from which one pass capacitor is deleted are to be mounted on the board.

In the description presented by way of example, it is assumed that, in step ST6A2, the pass capacitor C12 is set as a deletion candidate (see the column of rank in FIG. 17), and 11 pass capacitors excluding the pass capacitor C12 are mounted on the print board.

The total capacitance value of the 11 pass capacitors is 11.0 μF (=1.0 μF×11), which is less than the capacitance value 12.0 μF that satisfies the performance by the bypass capacitor for the IC1, and thus each of the 11 pass capacitors is selected from the pass capacitors registered in the individual component selecting unit in the search target selecting unit 102 in such a manner that the total capacitance value of the 11 pass capacitors is equal to or more than 12.0 ρF.

The design changing unit 105A selects, from among the pass capacitors registered in the individual component selecting unit in the search target selecting unit 102, a pass capacitor having a minimum capacitance value with which the total capacitance value of the 11 pass capacitors satisfies the capacitance value of 12.0 μF or more, that is, a capacitance value of each pass capacitor satisfies a capacitance value of (12.0 μF/11), for example, a pass capacitor of 2.2 μF.

The process proceeds to step ST6A3 by changing the initial 12.0 μF pass capacitors to 11 2.2 μF pass capacitors.

The process sequentially proceeds from step ST6A3 to step ST6A4 and step ST6A5.

In step ST6A5, since the calculation result of the impedance is lower than the set value, and a comparison result immediately before the comparison result that is lower than the set value is also low, it is determined as NG and the process returns to step ST6A2.

In step ST6A2, deletion candidates are accumulated up to the pass capacitor C10 having a deletion rank higher by one and set as deletion candidates, and 10 pass capacitors excluding the pass capacitors C12 and C10 are to be mounted on the print board.

At this time, since the total capacitance value of 10 pass capacitors is 22.0 μF (=2.2 μF×10) and the total capacitance value of 12.0 μF or more of all the mountable pass capacitors C1 to C12 is satisfied, the process proceeds to step ST6A3, and similarly proceeds to steps ST6A4 and ST6A5, and the process returns to step ST6A2 is repeatedly executed until the calculation result of the impedance is higher than the set value in step ST6A4.

Now, as an example, in a case where seven deletion candidates, that is, C12, C10, C5, C1, C3, C8, and C11 in this example, are accumulated up to the pass capacitor C11, and the remaining five pass capacitors are to be mounted on the print board, in step ST6A4, if the calculation result of the impedance is higher than the set value, that is, NG, the process returns to step ST6A2.

In step ST6A2, it is assumed that it is returned to the deletion candidates accumulated up to the pass capacitor C8 that has been set as a deletion candidate immediately before, and six pass capacitors to which one pass capacitor C11 is added are to be mounted on the print board.

At this time, since the total capacitance value of the 6 pass capacitors is 13.2 μF (=2.2 μF×6) and the total capacitance value of 12.0 μF or more of all the mountable pass capacitors C1 to C12 is satisfied, the process proceeds to step ST6A3.

In this case, since the calculation result of the impedance is lower than the set value, the process sequentially proceeds from step ST6A3 to step ST6A4 and step ST6A5.

In step ST6A5, since the calculation result of the impedance is lower than the set value, and a comparison result immediately before the comparison result that is lower than the set value is high, it is determined as OK, and it is determined to delete the pass capacitors up to the deletion rank at the time of obtaining the comparison result, in this example, six pass capacitors of C12, C10, C5, C1, C3, and C8, and to mount the remaining pass capacitors, in this example, C2, C4, C7, C6, C9, and C11 having the capacitance value of 2.2 μF on the board and a change result is output.

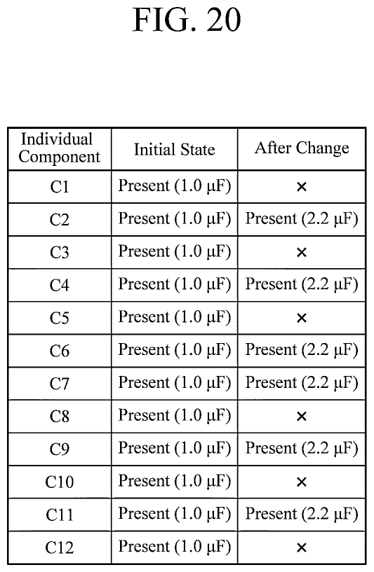

FIG. 20 illustrates the validity of each of the pass capacitors C1 to C12 with respect to the print board when the capacitance value of each of the pass capacitors C1 to C12 is 1.0 μF which is the initial state and when the capacitance value of each of the pass capacitors C1 to C12 is 2.2 μF.

As described above, in step ST6A5, by deleting the pass capacitors according to the deletion rank until the comparison result indicates that the calculation result of the impedance is lower than the set value and an immediately preceding comparison result indicates that the calculation result of the impedance is higher than the set value, it is possible to avoid excessive mounting of the pass capacitors to be mounted on the print board with respect to the set value of the impedance without deteriorating the performance by the bypass capacitor for the IC1, and it is possible to mount pass capacitors at appropriate arrangement positions on the print board with the minimum number of pass capacitors.

Step ST7 is the same as the design assistance system according to the first embodiment, and converts information by the pass capacitor determined in step ST6A into the format of the board design information 200, outputs the converted information as a change result 300, and ends.

The arrangement state of the pass capacitor after the design change displayed on the display device such as a display based on the change result 300 is similar to the arrangement state by the design assistance system according to the first embodiment illustrated in FIG. 13.

The search target selecting unit 102, the connection path calculating unit 103, the validity evaluating unit 104A, and the design changing unit 105A in the design assistance system according to the second embodiment are similar to the hardware configuration by the computer in the design assistance system according to the first embodiment illustrated in FIG. 15.

The print board design assistance method of the print board in steps ST2 to ST6A is performed by the CPU 110 executing processing according to the program stored in the ROM 130.

That is, the program stored in the ROM 130 includes a selecting procedure of selecting a plurality of power supply terminals and a plurality of ground terminals of a semiconductor integrated circuit device to be mounted on the board, and a plurality of bypass capacitors mountable on a board as search targets, a shortest distance calculating procedure of calculating a shortest distance of a wiring path on the board corresponding to each of the plurality of bypass capacitors for each of the plurality of power supply terminals and the plurality of ground terminals of the selected semiconductor integrated circuit device, and a first validity determining procedure of relatively comparing calculated shortest distances of wiring paths on the board corresponding to each of the plurality of bypass capacitors in each of the plurality of power supply terminals and the plurality of ground terminals of the semiconductor integrated circuit device, determining that the bypass capacitor whose shortest distance indicates a minimum value is valid, and determining that the remaining bypass capacitors are invalid, a second validity determining procedure of determining that a bypass capacitor determined to be valid in at least one of a plurality of power supply terminals or a plurality of ground terminals of the semiconductor integrated circuit device is valid for the board and determining that the other bypass capacitors are invalid for the board, a validity ranking procedure of determining that a group A of bypass capacitors determined to be valid for the board is highly valid with respect to a group B of bypass capacitors determined to be invalid for the board and relatively comparing shortest distances of wiring paths on the board calculated in each of the plurality of power supply terminals and the plurality of ground terminals of the semiconductor integrated circuit device in the bypass capacitors belonging to each of the group A and the group B, obtaining a shortest distance of a minimum value, evaluating validity of a bypass capacitor having a smaller value of a shortest distance of the minimum value more highly, and ranking validity, and a pass capacitor selecting procedure of sequentially accumulating bypass capacitors in ascending order of a validity rank to set the bypass capacitors as deletion candidates on the basis of obtained ranking of validity, selecting a bypass capacitor that satisfies that a total capacitance value of bypass capacitors in a case of excluding the bypass capacitors determined as the deletion candidates is equal to or more than a total capacitance value of a plurality of bypass capacitors mountable on the board that has been determined first with the bypass capacitors in the case of excluding the bypass capacitors determined as the deletion candidates having equal capacitance values, and a pass capacitor determining procedure of sequentially accumulating the bypass capacitors in ascending order of validity rank to set the bypass capacitors as deletion candidates on the basis of the obtained ranking of validity, comparing impedances between the plurality of power supply terminals and the plurality of ground terminals of the semiconductor integrated circuit device in a case of excluding the bypass capacitors set as the deletion candidates with a set impedance, and determining bypass capacitors up to when the comparison result is obtained as bypass capacitors not to be mounted on the board and remaining bypass capacitors as bypass capacitors to be mounted on the board when the comparison result indicates that the impedances between the plurality of power supply terminals and the plurality of ground terminals of the semiconductor integrated circuit device are lower than the set impedance and an immediately preceding comparison result is high.

As described above, in addition to that the print board design assistance system according to the second embodiment has effects similar to those of the design assistance system according to the first embodiment, the calculation result of the impedance between the plurality of power supply terminals 1V and the plurality of ground terminals 1G of the IC1 is compared with the set impedance, and by deleting the pass capacitors according to the deletion rank until the comparison result indicates that the calculation result of the impedance is lower than the set value and an immediately preceding comparison result indicates that the calculation result of the impedance is higher than the set value, it is possible to avoid excessive mounting of the pass capacitors to be mounted on the print board with respect to the set value of the impedance without deteriorating the performance by the bypass capacitor for the IC1, and it is possible to mount pass capacitors at appropriate arrangement positions on the print board with the minimum number of pass capacitors.

### Third Embodiment

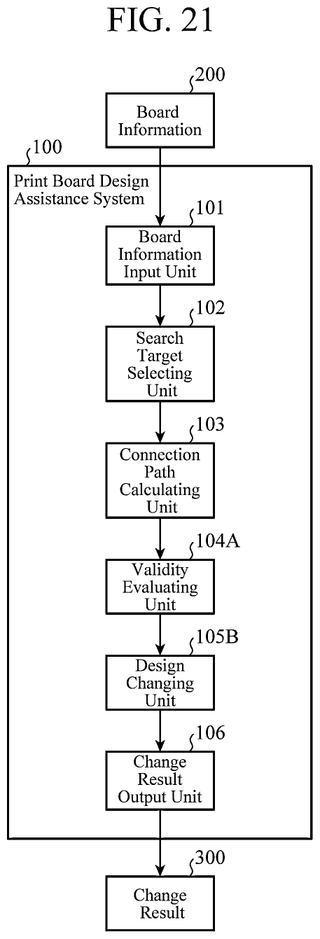

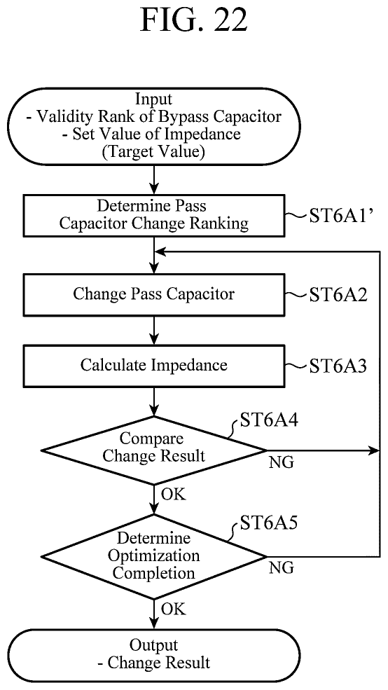

A print board design assistance system according to a third embodiment will be described with reference to FIGS. 21 and 22.

The design assistance system according to the third embodiment is different from the design assistance system according to the second embodiment only in a design changing unit 105B, and the other points are the same.

Therefore, the design changing unit 105B will be mainly described.

Note that, in FIGS. 21 and 22, the same reference numerals as those in FIGS. 1 to 20 denote the same or corresponding parts.

All pass capacitors belonging to the group B are set as deletion candidates by the validity evaluating unit 104A, and then, on the basis of the ranking of validity in the group A obtained by the validity evaluating unit 104A, and the design changing unit 105B sequentially accumulates pass capacitors in ascending order of the validity rank to set the pass capacitors as deletion candidates, compares impedances between the plurality of power supply terminals 1V and the plurality of ground terminals 1G of the IC1 with a set impedance in a case of excluding the pass capacitors set as deletion candidates, and in the comparison result, when the impedance between the plurality of power supply terminals 1V and the plurality of ground terminals 1G of the IC1 is lower than the set impedance and an immediately preceding comparison result is high, it is determined not to mount pass capacitors up to the time when the comparison result is obtained on the print board, and to mount the remaining pass capacitors on the print board.

The design changing unit 105B has functions of pass capacitor change ranking determination, pass capacitor change, impedance calculation, change result comparison, and optimization completion determination.

Only the function of the pass capacitor change ranking determination is different from the function of the pass capacitor change ranking determination according to the second embodiment, and the other points are the same.

In the function of the pass capacitor change ranking determination, first, all pass capacitors belonging to the group B are set as deletion candidates by the validity evaluating unit 104A, and then, a deletion rank of pass capacitors having a low validity rank is set high on the basis of the ranking of validity in the group A obtained by the validity evaluating unit 104A.

That is, the deletion rank of the pass capacitors C1 to C12 is opposite to the ranking of validity obtained by the validity evaluating unit 104A.

As described above, since all pass capacitors belonging to the group B are set as deletion candidates, the shortest distances to the pass capacitors C1 to C12 corresponding to each of the plurality of power supply terminals 1V and the plurality of ground terminals 1G of the IC1 are relatively compared, and the pass capacitors to be mounted on the print board are determined after the ranking of validity is performed, the processing time can be shortened, and it is possible to increase accuracy and efficiency of optimization of the number of pass capacitors to be mounted on the print board by setting the impedance between the plurality of power supply terminals and the plurality of ground terminals of the IC1 to be equal to or less than the set value.

Next, operation of the print board design assistance system according to the third embodiment will be described with reference to FIG. 22.

The operation of the design assistance system according to the third embodiment is different from the operation of the design assistance system according to the second embodiment only in step ST6A1′ of determining the change order of the pass capacitor and the other points are the same, and thus, step ST6A1′ will be mainly described.

In step ST6A1′, it is assumed that all pass capacitors belonging to the group B as deletion candidates are initially set to six pass capacitors, that is, C12, C10, C5, C1, C3, and C8 in this example, and the remaining six pass capacitors are to be mounted on the print board, the process proceeds to step ST6A2, step ST6A3, and step ST6A4, and when a calculation result of the impedance is lower than a set value in step ST6A4, the process proceeds to step ST6A5, and the process returns to step ST6A2.

In step ST6A2, it is assumed that deletion candidates up to a pass capacitor whose deletion rank is higher by one as deletion candidates, that is, a number of pass capacitors from which one pass capacitor is deleted are to be mounted on the board.

As an example, it is assumed that the pass capacitor C11 is the next deletion candidate, the number of deletion candidates up to C11 is set to 7, and five pass capacitors are to be mounted on the print board, the process proceeds to steps ST6A3 and ST6A4, and the process returns to step ST6A2 assuming that a calculation result of the impedance is higher than the set value in step ST6A4.

In step ST6A2, the deletion candidate is returned to the candidate pass capacitor C8 that is a lowest deletion candidate belonging to the group B, and the process proceeds to step ST6A3 assuming that six pass capacitors to which one pass capacitor C11 is added are to be mounted on the print board.

In this case, since the calculation result of the impedance is lower than the set value, the process sequentially proceeds from step ST6A3 to step ST6A4 and step ST6A5.

In step 6A5, since the calculation result of the impedance is lower than the set value, and a comparison result immediately before the comparison result that is lower than the set value is high, it is determined as OK, and it is determined to delete the pass capacitors up to the deletion rank at the time of obtaining the comparison result, in this example, six pass capacitors of C12, C10, C5, C1, C3, and C8, and to mount the remaining pass capacitors, in this example, C2, C4, C7, C6, C9, and C11 on the board and a change result is output.

Note that, in step ST6A4, if the calculation result of the impedance is lower than the set value, the process proceeds to step ST6A5, returns to step ST6A2, and in step ST6A2, deletion candidates are accumulated up to a pass capacitor having a deletion rank higher by one, and the process is repeated as the deletion candidates.

On the other hand, in step ST6A2, the process proceeds to steps ST6A3 and ST6A4 with all pass capacitors belonging to the group B as deletion candidates, and in step ST6A4, when the calculation result of the impedance is determined to be higher than the set value, the process returns to step ST6A2.

In step ST6A2, the deletion candidate is returned to the candidate pass capacitor C8 that is a lowest deletion candidate belonging to the group B, the process proceeds to step ST6A3 assuming that six pass capacitors to which one pass capacitor C11 is added are to be mounted on the print board, and similar processing is performed.

The search target selecting unit 102, the connection path calculating unit 103, the validity evaluating unit 104A, and the design changing unit 105B in the design assistance system according to the third embodiment are similar to the hardware configuration by the computer in the design assistance system according to the first embodiment illustrated in FIG. 15.

The print board design assistance method of the print board in steps ST2 to ST6A is performed by the CPU 110 executing processing according to the program stored in the ROM 130.

That is, the program stored in the ROM 130 includes a selecting procedure of selecting a plurality of power supply terminals and a plurality of ground terminals of a semiconductor integrated circuit device to be mounted on the board, and a plurality of bypass capacitors mountable on a board, as search targets, a shortest distance calculating procedure of calculating a shortest distance of a wiring path on the board corresponding to each of the selected plurality of bypass capacitors for each of the selected plurality of power supply terminals and the selected plurality of ground terminals of the semiconductor integrated circuit device, and a first validity determining procedure of relatively comparing calculated shortest distances of wiring paths on the board corresponding to each of the plurality of bypass capacitors in each of the plurality of power supply terminals and the plurality of ground terminals of the semiconductor integrated circuit device, determining that the bypass capacitor whose shortest distance indicates a minimum value is valid, and determining that the remaining bypass capacitors are invalid, a second validity determining procedure of determining that a bypass capacitor determined to be valid in at least one of a plurality of power supply terminals or a plurality of ground terminals of the semiconductor integrated circuit device is valid for the board and determining that the other bypass capacitors are invalid for the board, a validity ranking procedure of determining that a group A of bypass capacitors determined to be valid for the board is highly valid with respect to a group B of bypass capacitors determined to be invalid for the board and relatively comparing shortest distances of wiring paths on the board calculated in each of the plurality of power supply terminals and the plurality of ground terminals of the semiconductor integrated circuit device in the bypass capacitors belonging to the group A, obtaining a shortest distance of a minimum value, evaluating validity of a bypass capacitor having a smaller value of a shortest distance of the minimum value more highly, and ranking validity, and a pass capacitor selecting procedure of setting all bypass capacitors determined as the group B as deletion candidates, sequentially accumulating bypass capacitors in ascending order of a validity rank to set the bypass capacitors as deletion candidates on the basis of obtained ranking of validity in the group A, selecting a bypass capacitor that satisfies that a total capacitance value of bypass capacitors in a case of excluding the bypass capacitors determined as the deletion candidates is equal to or more than a total capacitance value of a plurality of bypass capacitors mountable on the board that has been determined first with the bypass capacitors in the case of excluding the bypass capacitors determined as the deletion candidates having equal capacitance values, and a pass capacitor determining procedure of setting all bypass capacitors determined as the group B as deletion candidates, then sequentially accumulating bypass capacitors in ascending order of the validity rank in the group A to set the bypass capacitors as deletion candidates on the basis of the obtained ranking of validity in the group B, comparing impedances between the plurality of power supply terminals and the plurality of ground terminals of the semiconductor integrated circuit device in a case of excluding the bypass capacitors set as the deletion candidates with a set impedance, and determining bypass capacitors up to when the comparison result is obtained as bypass capacitors not to be mounted on the board and remaining bypass capacitors as bypass capacitors to be mounted on the board when the comparison result indicates that the impedances between the plurality of power supply terminals and the plurality of ground terminals of the semiconductor integrated circuit device are lower than the set impedance and an immediately previous comparison result is high.

As described above, in addition to that the print board design assistance system according to the third embodiment has effects similar to those of the design assistance system according to the second embodiment, since all the pass capacitors belonging to the group B are initially set as deletion candidates, it is possible to start from a state in which the number and the arrangement position of the pass capacitors with respect to the print board are close to optimum, it is possible to increase accuracy and efficiency of optimization of the number of pass capacitors to be mounted on the print board by setting the impedance between the plurality of power supply terminals and the plurality of ground terminals of the IC1 to be equal to or less than the set value without shortening the processing time, and deteriorating the performance by the bypass capacitor with respect to the IC1.

### Fourth Embodiment

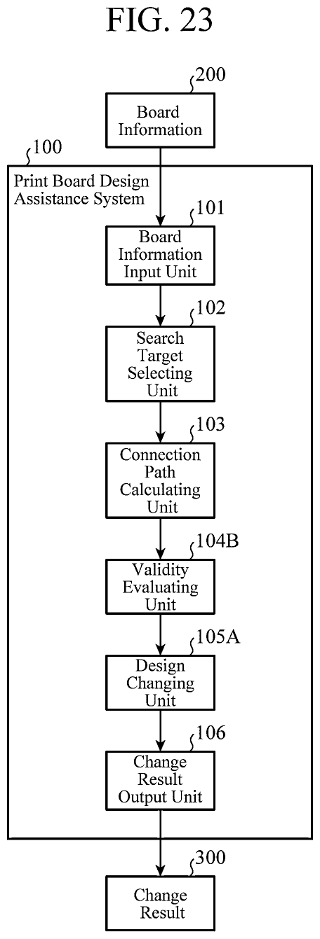

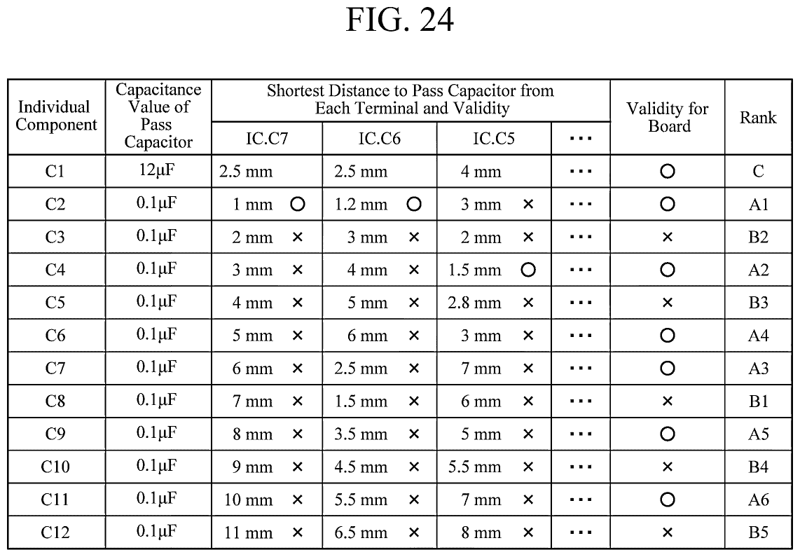

A print board design assistance system according to a fourth embodiment will be described with reference to FIGS. 23 and 24.

The design assistance system according to the fourth embodiment is different from the design assistance system according to the second embodiment only in a validity evaluating unit 104B, and the other points are the same.

Therefore, the validity evaluating unit 104B will be mainly described.

Note that, in FIGS. 23 and 24, the same reference numerals as those in FIGS. 1 to 22 denote the same or corresponding parts.

The validity evaluating unit 104B confirms whether or not a smoothing capacitor is included in the plurality of pass capacitors C1 to C12, extracts the smoothing capacitor when the smoothing capacitor is included, and the extracted smoothing capacitor is always mounted on the print board.

The extraction of the smoothing capacitor in the validity evaluating unit 104B refers to capacitance values of the pass capacitors C1 to C12, which are component information associated with specifications of the pass capacitors C1 to C12, which are individual component information obtained by the connection path calculating unit 103 on the basis of the board design information input from the board information input unit 101, and identifies the smoothing capacitor as a smoothing capacitor when the capacitance value is equal to or more than a predetermined capacitance threshold of the smoothing capacitor.

The capacitance threshold of the smoothing capacitor is generally 10 μF.

Processing performed by the validity evaluating unit 104B on the plurality of pass capacitors excluding the extracted smoothing capacitor is the same as that performed by the validity evaluating unit 104A in the second embodiment.

The design changing unit 105A also performs substantially the same processing as the design changing unit 105A in the second embodiment on the plurality of pass capacitors except for the smoothing capacitor extracted by the validity evaluating unit 104B.

That is, the design changing unit 105A constantly performs processing by excluding the smoothing capacitor extracted by the validity evaluating unit 104B from the deletion candidate, and when the comparison result indicates that a calculation result of impedance is lower than the set value and a comparison result immediately before the comparison result is high in the change result comparison function, pass capacitors up to a deletion rank when the comparison result is obtained are deleted, and the remaining pass capacitors including the smoothing capacitor extracted by the validity evaluating unit 104B are to be mounted on the board.

Note that the board information input unit 101, the search target selecting unit 102, the connection path calculating unit 103, and the change result output unit 106 are the same as the board information input unit 101, the search target selecting unit 102, the connection path calculating unit 103, and the change result output unit 106 in the second embodiment.

As described above, when the smoothing capacitor is extracted by the validity evaluating unit 104B, since processing is performed by excluding the smoothing capacitor, it is possible to prevent deletion of the capacitor for power supply smoothing mounted on the print board and to improve accuracy and efficiency of optimization of the number of pass capacitors mounted on the print board by setting the impedance between the plurality of power supply terminals and the plurality of ground terminals of the IC1 to the set value or less.

Operation of the print board design assistance system according to the fourth embodiment is substantially the same as operation of the design assistance system according to the second embodiment except that processing is executed after the smoothing capacitor is extracted in first validity determining step ST4.

That is, in the flowchart illustrated in FIG. 18 illustrated in the second embodiment, the operation of the design assistance system according to the fourth embodiment is as follows.

In the first validity determining step ST4, the validity evaluating unit 104B extracts a smoothing capacitor from the plurality of pass capacitors C1 to C12, and determines whether the plurality of pass capacitors C1 to C12 excluding the smoothing capacitor is valid or invalid, and in second validity determining step ST5, determination of whether the plurality of pass capacitors C1 to C12 excluding the smoothing capacitor is valid or invalid with respect to a print board is performed.

FIG. 23 illustrates an example of the smoothing capacitor extracted by the first validity determining step ST4 by the validity evaluating unit 104B, shortest distances from each of the plurality of power supply terminals 1V and the plurality of ground terminals 1G of the IC1 to the pass capacitors C1 to C12 obtained in the first validity determining step ST4 and determination results of validity for respective terminals, and determination results of validity for the board obtained in a second validity determining step and a rank of validity.

As an example, the smoothing capacitor extracted by the validity evaluating unit 104B is assumed as a pass capacitor C1, a capacitance value of the pass capacitor C1 is 12 μF, and each of pass capacitors C2 to C12 is assumed as a pass capacitor of 0.1 μF indicating a minimum capacitance value from among pass capacitors registered in the individual component selecting unit in the search target selecting unit 102 in which a total capacitance value of the pass capacitors C1 to C12 satisfies a capacitance value equal to or more than 12.0 μF that satisfies performance by the bypass capacitor with respect to IC1.

In order to indicate that pass capacitor C1 is a smoothing capacitor, C is added to the column of rank.

Note that when it is desired to know data in which the pass capacitors C1 to C12 that are the individual component information, capacitance values of the pass capacitors C1 to C12, information indicating the shortest distances from each of the power supply terminals 1V and the ground terminals 1G of the IC1 to the pass capacitors C1 to C12 that are the individual wiring information and information indicating a determination result of validity for each terminal, information indicating a determination result of validity for the board obtained by the second validity determining step, and information indicating a rank of validity in the pass capacitors C1 to C12 are arranged as one set illustrated in FIG. 23, the data may be output to the display device by an arrangement illustrated in FIG. 23.

Further, in the flowchart illustrated in FIG. 19 illustrated in the second embodiment, pass capacitor determining step ST6A according to the fourth embodiment is as follows.

In step ST6A1, the design changing unit 105A, for example, ranks deletion candidates of the pass capacitor C2 to C12 in ascending order of a validity rank from ranking of validity obtained by the validity evaluating unit 104A excluding the pass capacitor C1 which is a smoothing capacitor extracted by the validity evaluating unit 104A.

From step ST6A2 to step ST6A5, processing is executed on the assumption that the pass capacitor C1, which is the smoothing capacitor extracted by the validity evaluating unit 104A, is mounted on the print board.

As described above, under the assumption that the pass capacitor C1, which is the smoothing capacitor extracted by the validity evaluating unit 104A, is to be mounted on the print board, deletion of the pass capacitor is performed by the deletion rank until a comparison result indicates that a calculation result of impedance is lower than a set value and an immediately preceding comparison result indicates that a calculation result of impedance is higher than the set value, and thus, with the smoothing capacitor constantly mounted on the print board, excessive mounting of the pass capacitor to be mounted on the print board with respect to the set value of impedance is avoided, and the pass capacitor can be mounted at an appropriate arrangement position on the print board with a minimum number of pass capacitors.

The search target selecting unit 102, the connection path calculating unit 103, the validity evaluating unit 104B, and the design changing unit 105A in the design assistance system according to the fourth embodiment are similar to the hardware configuration by the computer in the design assistance system according to the first embodiment illustrated in FIG. 15.

The print board design assistance method of the print board in steps ST2 to ST6A is performed by the CPU 110 executing processing according to the program stored in the ROM 130.

That is, the program stored in the ROM 130 includes a selecting procedure of selecting a plurality of power supply terminals and a plurality of ground terminals of a semiconductor integrated circuit device to be mounted on the board, and a plurality of bypass capacitors mountable on a board, as search targets, a shortest distance calculating procedure of calculating a shortest distance of a wiring path on the board corresponding to each of the selected plurality of bypass capacitors for each of the selected plurality of power supply terminals and the selected plurality of ground terminals of the semiconductor integrated circuit device, and a first validity determining procedure of extracting a smoothing capacitor from the plurality of bypass capacitors, relatively comparing calculated shortest distances of wiring paths on the board corresponding to each of the plurality of bypass capacitors excluding the extracted smoothing capacitor, in each of the plurality of power supply terminals and the plurality of ground terminals of the semiconductor integrated circuit device, determining that the bypass capacitor whose shortest distance indicates a minimum value is valid, and determining that the remaining bypass capacitors are invalid, a second validity determining procedure of determining that a bypass capacitor determined to be valid in at least one of a plurality of power supply terminals or a plurality of ground terminals of the semiconductor integrated circuit device is valid for the board and determining that the other bypass capacitors are invalid for the board, a validity ranking procedure of determining that a group A of bypass capacitors determined to be valid for the board is highly valid with respect to a group B of bypass capacitors determined to be invalid for the board and relatively comparing shortest distances of wiring paths on the board calculated in each of the plurality of power supply terminals and the plurality of ground terminals of the semiconductor integrated circuit device in the bypass capacitors belonging to each of the group A and the group B, obtaining a shortest distance of a minimum value, evaluating validity of a bypass capacitor having a smaller value of a shortest distance of the minimum value more highly, and ranking validity, and a pass capacitor determining procedure of sequentially accumulating bypass capacitors in ascending order of a validity rank to set the bypass capacitors as deletion candidates on the basis of obtained ranking of validity, comparing impedances between the plurality of power supply terminals and the plurality of ground terminals of the semiconductor integrated circuit device in a case of excluding the bypass capacitors set as the deletion candidates with a set impedance, and determining bypass capacitors up to when the comparison result is obtained as bypass capacitors not to be mounted on the board and remaining bypass capacitors including the extracted smoothing capacitor as bypass capacitors to be mounted on the board when the comparison result indicates that the impedances between the plurality of power supply terminals and the plurality of ground terminals of the semiconductor integrated circuit device are lower than the set impedance and an immediately preceding comparison result is high.

As described above, in addition to that the print board design assistance system according to the fourth embodiment has effects similar to those of the design assistance system according to the second embodiment, the smoothing capacitor is constantly mounted on the print board, and it is possible to increase accuracy and efficiency of optimization of the number of pass capacitors mounted on the print board, in which the impedance between the plurality of power supply terminals and the plurality of ground terminals of the IC1 is set to be equal to or less than the set value.

Note that, in the design assistance system according to the fourth embodiment, similarly to the design assistance system according to the third embodiment, the validity evaluating unit 104B may set all the pass capacitors belonging to the group B as deletion candidates, and the design changing unit 105B may execute the processing.

The program stored in the ROM 130 in this case includes a selecting procedure of selecting a plurality of power supply terminals and a plurality of ground terminals of a semiconductor integrated circuit device to be mounted on the board, and a plurality of bypass capacitors mountable on a board, as search targets, a shortest distance calculating procedure of calculating a shortest distance of a wiring path on the board corresponding to each of the plurality of bypass capacitors for each of the selected plurality of power supply terminals and the selected plurality of ground terminals of the semiconductor integrated circuit device, and a first validity determining procedure of extracting a smoothing capacitor from a plurality of bypass capacitors, relatively comparing calculated shortest distances of wiring paths on the board corresponding to each of the plurality of bypass capacitors in each of the plurality of power supply terminals and the plurality of ground terminals of the semiconductor integrated circuit device, determining that the bypass capacitor whose shortest distance indicates a minimum value is valid, and determining that the remaining bypass capacitors are invalid, a second validity determining procedure of determining that a bypass capacitor determined to be valid in at least one of a plurality of power supply terminals or a plurality of ground terminals of the semiconductor integrated circuit device is valid for the board and determining that the other bypass capacitors are invalid for the board, a validity ranking procedure of determining that a group A of bypass capacitors determined to be valid for the board is highly valid with respect to a group B of bypass capacitors determined to be invalid for the board and relatively comparing shortest distances of wiring paths on the board calculated in each of the plurality of power supply terminals and the plurality of ground terminals of the semiconductor integrated circuit device in the bypass capacitors belonging to the group A, obtaining a shortest distance of a minimum value, evaluating validity of a bypass capacitor having a smaller value of a shortest distance of the minimum value more highly, and ranking validity, and a pass capacitor determining procedure of setting all bypass capacitors determined as the group B as deletion candidates, then sequentially accumulating bypass capacitors in ascending order of a validity rank in the group A to set the bypass capacitors as deletion candidates on the basis of obtained ranking of validity, comparing impedances between the plurality of power supply terminals and the plurality of ground terminals of the semiconductor integrated circuit device in a case of excluding the bypass capacitors set as the deletion candidates with a set impedance, and determining bypass capacitors up to when the comparison result is obtained as bypass capacitors not to be mounted on the board and remaining bypass capacitors including the extracted smoothing capacitor as bypass capacitors to be mounted on the board when the comparison result indicates that the impedances between the plurality of power supply terminals and the plurality of ground terminals of the semiconductor integrated circuit device are lower than the set impedance and an immediately preceding comparison result is high.

In the design assistance system according to the fourth embodiment, after the validity evaluating unit 104 extracts the smoothing capacitor from the plurality of pass capacitors C1 to C12 and determines whether the plurality of pass capacitors C1 to C12 excluding the smoothing capacitor is valid or invalid with respect to the print board, the design changing unit 105 may determine that the pass capacitor extracted as the smoothing capacitor and the pass capacitor determined to be valid are mounted on the print board and the pass capacitor determined to be invalid is not mounted on the print board on the basis of the information obtained by the validity evaluating unit 104, similarly to the design assistance system according to the first embodiment.

The program stored in the ROM 130 in this case includes a selecting procedure of selecting a plurality of power supply terminals and a plurality of ground terminals of a semiconductor integrated circuit device to be mounted on the board, and a plurality of bypass capacitors mountable on the board, as search targets, a shortest distance calculating procedure of calculating a shortest distance of a wiring path on the board corresponding to each of the plurality of bypass capacitors for each of the selected plurality of power supply terminals and the selected plurality of ground terminals of the semiconductor integrated circuit device, a first validity determining procedure of extracting a smoothing capacitor from the plurality of bypass capacitors, relatively comparing the shortest distances of the wiring paths on the board corresponding to each of the plurality of bypass capacitors, excluding the smoothing capacitor, calculated at each of the plurality of power supply terminals and the plurality of ground terminals of the semiconductor integrated circuit device, determining that a bypass capacitor whose shortest distance indicates a minimum value is valid, and determining that the remaining bypass capacitors are invalid, a second validity determining procedure of determining that a bypass capacitor determined to be valid in at least one of the plurality of power supply terminals or the plurality of ground terminals of the semiconductor integrated circuit device is valid for a board and determining that other bypass capacitors are invalid for the board, and a pass capacitor determining procedure of determining, from among the plurality of bypass capacitors, a bypass capacitor extracted as a smoothing capacitor and a bypass capacitor determined to be valid for the board as a bypass capacitor to be mounted on the board.

### Fifth Embodiment

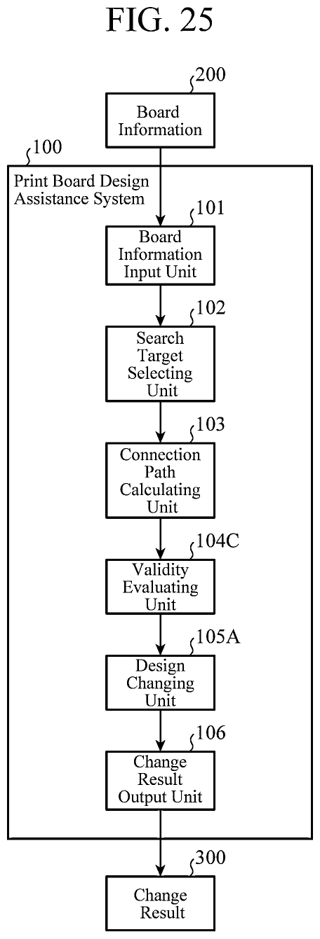

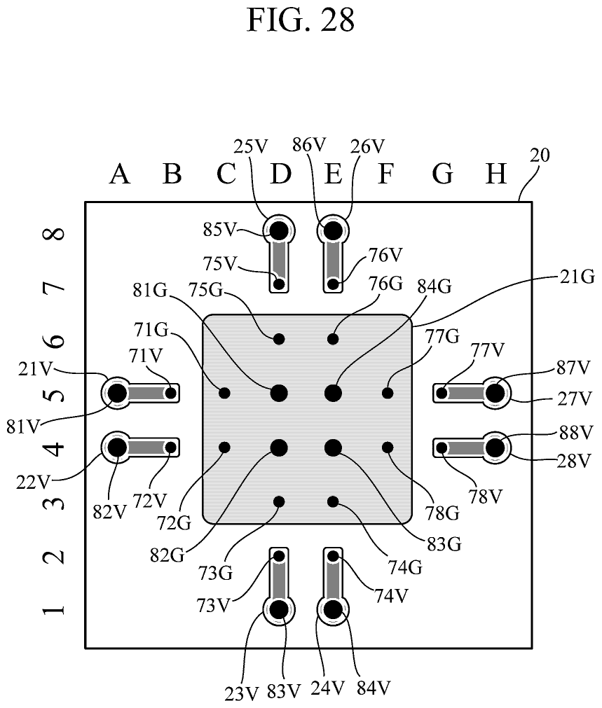

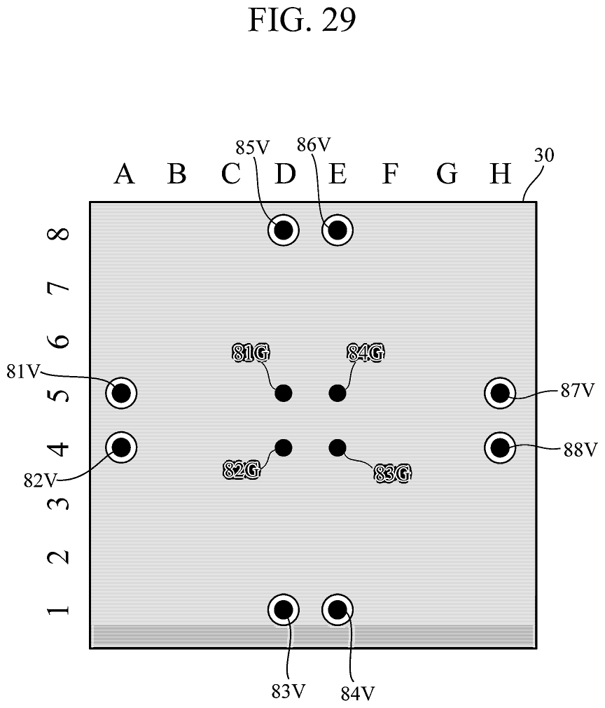

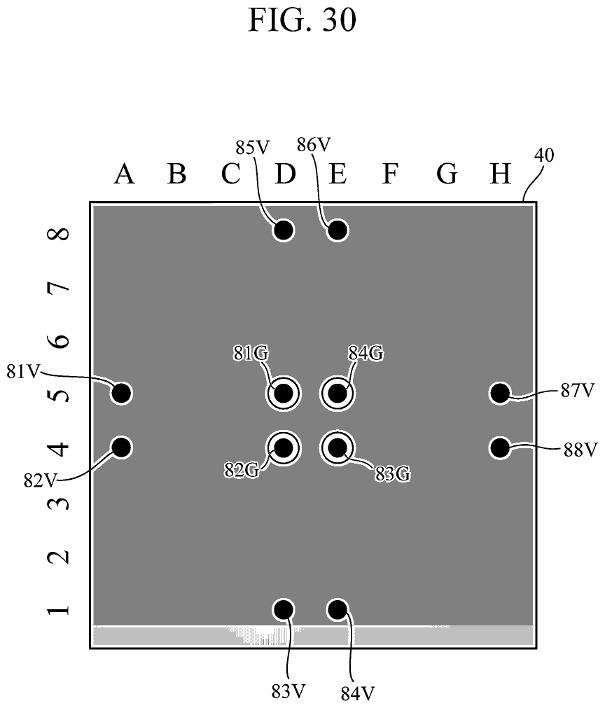

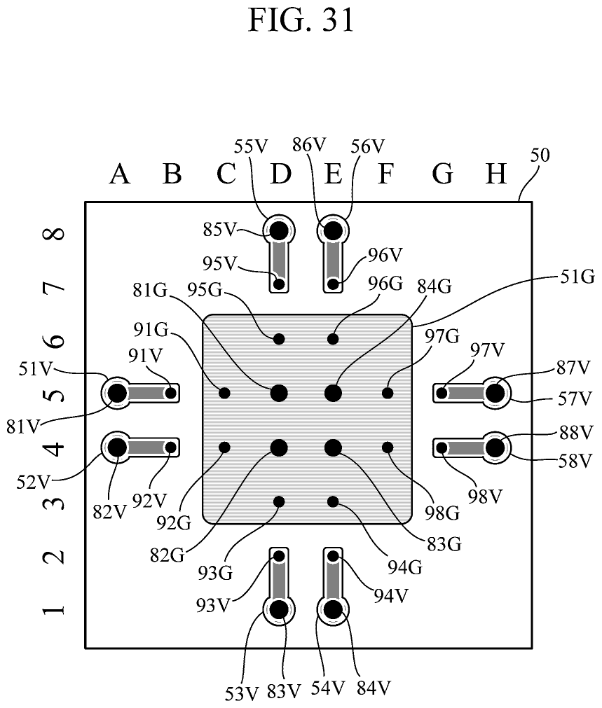

A print board design assistance system according to a fifth embodiment will be described with reference to FIGS. 25 to 35.

The design assistance system according to the fifth embodiment is different from the design assistance system according to the second embodiment only in the validity evaluating unit 104C, and the other points are the same.

Therefore, the validity evaluating unit 104C will be mainly described.

Note that, in FIGS. 25 to 34, the same reference numerals as those in FIGS. 1 to 22 denote the same or corresponding parts.

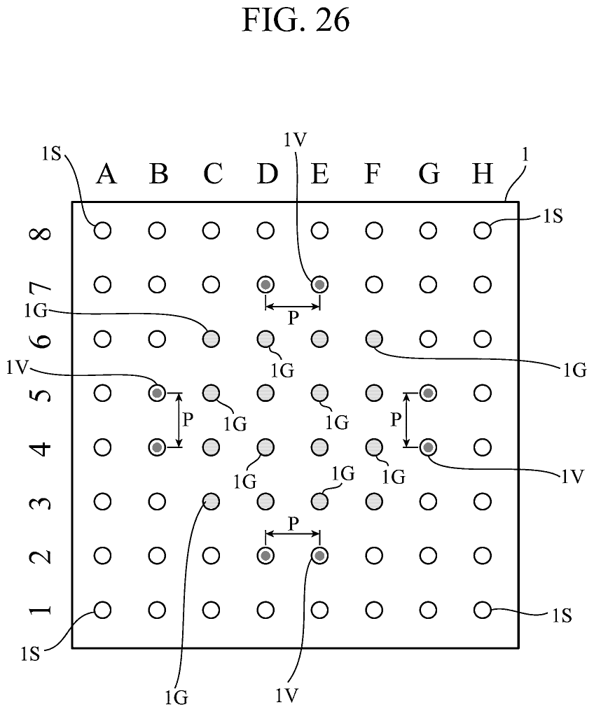

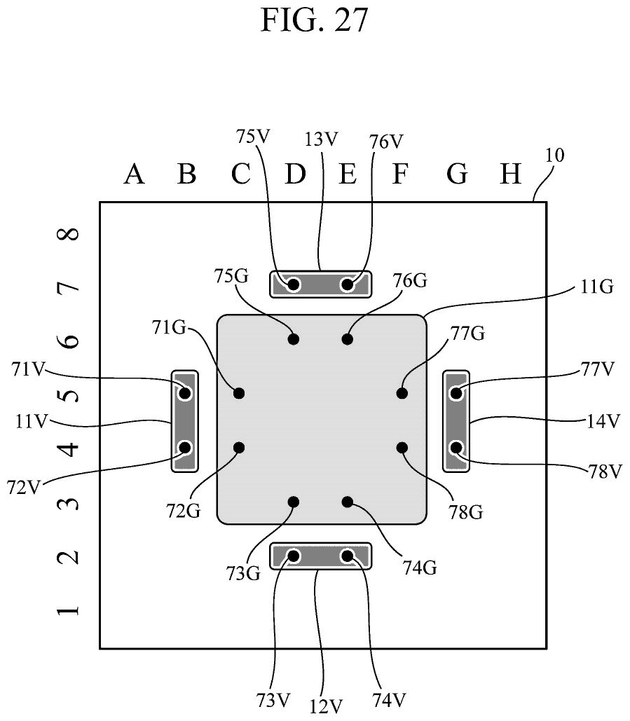

A design assistance system according to the fifth embodiment will be described for determining an arrangement position of a pass capacitor for an IC1 with a pin arrangement illustrated in FIG. 26 and a print board having a pattern in each layer immediately below a mounting region of the IC1 illustrated in FIGS. 27 to 32.

That is, in the design assistance system according to the second embodiment, as illustrated in FIG. 4, an IC in which the power supply terminal 1V and the ground terminal 1G are alternately arranged vertically and horizontally and a print board corresponding to the IC are targeted as the IC1.

On the other hand, in the design assistance system according to the fifth embodiment, as illustrated in FIG. 26, two adjacent power supply terminals 1V are arranged as a pair, and in this example, four power supply terminal 1V pairs are arranged.

The pitch P between the two power supply terminals 1V arranged adjacent to each other is 1 mm. That is, the pitch between the lattices where the pins are arranged is 1 mm.

Therefore, first, the pin arrangement of the IC1 and the pattern in each layer immediately below the mounting region of the IC in the print board will be described with reference to FIGS. 26 to 32.

In the pin arrangement (in this example, an arrangement of solder balls, which will be collectively referred to as pin arrangement) of the IC1, as illustrated in FIG. 26, pins are arranged in a lattice pattern of 8×8 with 8 rows in width and 8 rows in height, similarly to the pin arrangement of the IC1 targeted in the second embodiment.

A horizontal direction is defined as A column to H column, a vertical direction is defined as 1 row to 8 row, and intersections of the columns and the rows are defined as A1 to A8 to H1 to H8.

The power supply terminal 1V of the IC1 is disposed at B4, B5, D2, E2, D7, E7, G4, and G5.

The power supply terminal 1V arranged in B4 and B5 constitutes a power supply terminal 1V pair, the power supply terminal 1V arranged in D2 and E2 constitutes a power supply terminal 1V pair, the power supply terminal 1V arranged in D7 and E7 constitutes a power supply terminal 1V pair, and the power supply terminal 1V arranged in G4 and G5 constitutes a power supply terminal 1V pair. In this example, four power supply terminal 1V pairs are arranged.

The ground terminal 1G of the IC1 is arranged in 16 pin arrangements located in a region surrounding positions of C3 to C6 to F3 to F6.

Remaining pins are signal terminals 1S.

The power supply terminal 1V is connected to a 1.0 V power supply system, and 1.0 V is supplied to the power supply terminal 1V. The ground terminal 1G is connected to a ground system and has a ground potential.

Next, the pattern of the surface in each layer immediately below the mounting region of the IC1 in the print board will be described with reference to FIGS. 27 to 32.

In order to eliminate complexity of description, a pattern of the first layer of the print board is simply abbreviated as one-layer pattern. The sixth layer from the second layer will also be abbreviated for description.

Note that, in one to six layers, a pattern such as a signal wiring layer is formed in a region other than a region immediately below the mounting region of the IC1.

A one-layer pattern 10 is a pattern on the surface of the print board, and is a mounting surface of the IC1.

The one-layer pattern 10 is a pattern of a plurality of IC power supply wiring layers 11V to 14V and an IC ground pattern 11G.

The IC power supply wiring layers 11V to 14V are connected to a 1.0 V power supply system, and the IC ground pattern 11G is connected to a ground system.

Also in the two-layer pattern 20 to the six-layer pattern 60, the power supply wiring layer is connected to the 1.0 V power supply system, and the ground pattern is connected to the ground system.

Each of the IC power supply wiring layers 11V to 14V is arranged corresponding to four power supply terminal 1V pairs.

That is, the IC power supply wiring layer 11V is formed by a line segment connecting B5 and B4, and is connected to a pair of power supply terminals 1V located at B5 and B4.

The IC power supply wiring layer 12V is formed by a line segment connecting D2 and E2, and is connected to a pair of power supply terminals 1V located at D2 and E2.

The IC power supply wiring layer 13V is formed by a line segment connecting D7 and E7, and is connected to a pair of power supply terminals 1V located at D7 and E7.

The IC power supply wiring layer 14V is formed by a line segment connecting G5 and G4, and is connected to a pair of power supply terminals 1V located at G5 and G4.

The IC ground pattern 11G is a solid pattern formed in such a manner as to surround the positions of C3 to C6 to F3 to F6, and is connected to 16 ground terminals 1G located in regions surrounding C3 to C6 to F3 to F6.

In the two-layer pattern 20 to the six-layer pattern 60, vias connecting a power supply wiring layer and a power supply wiring layer in each layer and vias connecting ground patterns in each layer are appropriately arranged in such a manner that the plurality of pass capacitors C1 to C8 that can be mounted on the six-layer pattern 60 are temporarily determined, and then the plurality of pass capacitors C1 to C8 that can be mounted on the plurality of IC power supply wiring layers 11V to 14V and the ground pattern 11G in the one-layer pattern 10 are connected.

That is, the vias connecting the power supply wiring layer and the power supply wiring layer in each layer and the vias connecting the ground patterns in each layer in the two-layer pattern 20 to the six-layer pattern 60 are not uniquely determined to the arrangement of the pins of the IC1.

However, in the following description, in order to describe features of the print board design assistance system according to the fifth embodiment in an easily understandable manner, positions of the vias connecting the power supply wiring layer and the power supply wiring layers in each layer and the vias connecting the ground patterns in each layer will be described using reference numerals schematically indicating intersections of columns and rows for convenience of description while avoiding complication of description.

Therefore, the positions of the vias connecting the power supply wiring layer and the power supply wiring layer in each layer and the vias connecting the ground patterns in each layer are not limited to the positions described below.

The two-layer pattern 20 is a first switching pattern of a build-up layer.

The two-layer pattern 20 is a pattern of a plurality of power supply switching wiring layers 21V to 28V and a ground switching pattern 21G.

The power supply switching wiring layer 21V is formed by a line segment connecting B5 and A5.

The power supply switching wiring layer 22V is formed by a line segment connecting B4 and A4.

The power supply switching wiring layer 23V is formed by a line segment connecting D2 and D1.

The power supply switching wiring layer 24V is formed by a line segment connecting E2 and E1.

The power supply switching wiring layer 25V is formed by a line segment connecting D7 and D8.

The power supply switching wiring layer 26V is formed by a line segment connecting E7 and E8.

The power supply switching wiring layer 27V is formed by a line segment connecting G5 and H5.

The power supply switching wiring layer 28V is formed by a line segment connecting G4 and H4.

The ground switching pattern 21G is a solid pattern formed in such a manner as to surround the positions of C3 to C6 to F3 to F6.

A build-up via 71V electrically connects a position of B5 in the IC power supply wiring layer 11V and a position of B5 in the power supply switching wiring layer 21V.

A build-up via 72V electrically connects a position of B4 in the IC power supply wiring layer 11V and a position of B4 in the power supply switching wiring layer 22V.

A build-up via 73V electrically connects a position of D2 in the IC power supply wiring layer 12V and a position of D2 in the power supply switching wiring layer 23V.

A build-up via 74V electrically connects a position of E2 in the IC power supply wiring layer 12V and a position of E2 in the power supply switching wiring layer 24V.

A build-up via 75V electrically connects a position of D7 in the IC power supply wiring layer 13V and a position of D7 in the power supply switching wiring layer 25V.

A build-up via 76V electrically connects a position of E7 in the IC power supply wiring layer 13V and a position of E7 in the power supply switching wiring layer 26V.

A build-up via 77V electrically connects a position of G5 in the IC power supply wiring layer 14V and a position of G5 in the power supply switching wiring layer 27V.

A build-up via 78V electrically connects a position of G4 in the IC power supply wiring layer 14V and a position of G4 in the power supply switching wiring layer 28V.

The build-up vias 71G to 78G electrically connect respective positions of C5, C4, D3, E3, D6, E6, F5, and F4 in the IC ground pattern 11G and respective positions of C5, C4, D3, E3, D6, E6, F5, and F4 in the ground switching pattern 21G.

The three-layer pattern 30 is a ground pattern layer, and is a solid pattern except for positions of A5, A4, D1, E1, D8, E8, H5, and H4.

In the GND pattern layer 30, a conductive layer is removed in a circular shape at the positions of A5, A4, D1, E1, D8, E8, H5, and H4, and IVHs of 81V to 88V are penetrated without being electrically connected to the GND pattern layer 30 at center positions of A5, A4, D1, E1, D8, E8, H5, and H4.

The four-layer pattern 40 is a power supply pattern layer, and is a solid pattern except for positions of D5, D4, E5, and E4.

In the power supply pattern layer 40, a conductive layer is removed in a circular shape at the positions of D5, D4, E5, and E4, and the IVH 81G to 84G are penetrated through without being electrically connected to the power supply pattern layer 40 at center positions of D5, D4, E5, and E4.

The five-layer pattern 50 is a second switching pattern of the build-up layer.

The five-layer pattern 50 is a pattern of a plurality of power supply switching wiring layers 51V to 58V and a ground switching pattern 51G.

The power supply switching wiring layer 51V is formed by a line segment connecting A5 and B5.

The power supply switching wiring layer 52V is formed by a line segment connecting A4 and B4.

The power supply switching wiring layer 53V is formed by a line segment connecting D1 and D2.

The power supply switching wiring layer 54V is formed by a line segment connecting E1 and E2.

The power supply switching wiring layer 55V is formed by a line segment connecting D8 and D7.

The power supply switching wiring layer 56V is formed by a line segment connecting E8 and E7.

The power supply switching wiring layer 57V is formed by a line segment connecting H5 and G5.

The power supply switching wiring layer 58V is formed by a line segment connecting H4 and G4.

The ground switching pattern 51G is a solid pattern formed in such a manner as to surround the positions of C3 to C6 to F3 to F6.

A build-up via 81V electrically connects the position of A5 in the power supply pattern layer 40 and the position of A5 in the power supply switching wiring layer 51V.

A build-up via 82V electrically connects the position of A4 in the power supply pattern layer 40 and the position of A4 in the power supply switching wiring layer 52V.

A build-up via 83V electrically connects the position of D1 in the power supply pattern layer 40 and the position of D1 in the power supply switching wiring layer 53V.

A build-up via 84V electrically connects the position of E1 in the power supply pattern layer 40 and the position of E1 in the power supply switching wiring layer 54V.

A build-up via 85V electrically connects the position of D8 in the power supply pattern layer 40 and the position of D8 in the power supply switching wiring layer 55V.

A build-up via 86V electrically connects the position of E8 in the power supply pattern layer 40 and the position of E8 in the power supply switching wiring layer 56V.

A build-up via 87V electrically connects the position of H5 in the power supply pattern layer 40 and the position of H5 in the power supply switching wiring layer 57V.

A build-up via 88V electrically connects the position of H4 in the power supply pattern layer 40 and the position of H4 in the power supply switching wiring layer 58V.

The build-up vias 81G to 84G electrically connect the respective positions of D5, D4, E5, and E4 in the GND pattern layer 30 and the respective positions of D5, D4, E5, and E4 in the ground switching pattern 51G.

The IVHs 81V to 88V and IVHs 81G to 84G penetrate through from the two-layer to the three-layer and the four-layer, and electrically connect the corresponding two-layer pattern 20 and five-layer pattern.

The IVH 81V electrically connects the power supply switching wiring layer 21V, the power supply pattern layer 40, and the power supply switching wiring layer 51V at the position A5.

The IVH 82V electrically connects the power supply switching wiring layer 22V, the power supply pattern layer 40, and the power supply switching wiring layer 52V at the position A4.

The IVH 83V electrically connects the power supply switching wiring layer 23V, the power supply pattern layer 40, and the power supply switching wiring layer 53V at the position D1.

The IVH 84V electrically connects the power supply switching wiring layer 24V, the power supply pattern layer 40, and the power supply switching wiring layer 54V at the position E1.

The IVH 85V electrically connects the power supply switching wiring layer 25V, the power supply pattern layer 40, and the power supply switching wiring layer 55V at the position D8.

The IVH 86V electrically connects the power supply switching wiring layer 26V, the power supply pattern layer 40, and the power supply switching wiring layer 56V at the position E8.

The IVH 87V electrically connects the power supply switching wiring layer 27V, the power supply pattern layer 40, and the power supply switching wiring layer 57V at the position H5.

The IVH 88V electrically connects the power supply switching wiring layer 28V, the power supply pattern layer 40, and the power supply switching wiring layer 58V at the position H4.

The IVH 81G electrically connects the ground switching pattern 21G, the GND pattern layer 30, and the ground switching pattern 51G at the position D5.

The IVH 82G electrically connects the ground switching pattern 21G, the GND pattern layer 30, and the ground switching pattern 51G at the position D4.

The IVH 83G electrically connects the ground switching pattern 21G, the GND pattern layer 30, and the ground switching pattern 51G at the position E4.

The IVH 84G electrically connects the ground switching pattern 21G, the GND pattern layer 30, and the ground switching pattern 51G at the position E5.

The six-layer pattern 60 is a pattern on a back surface of the print board, and is a mounting surface on which a plurality of pass capacitors C1 to C8 can be mounted.

The six-layer pattern 60 is a pattern of a plurality of capacitor power supply wiring layers 61V to 64V and a capacitor ground pattern 61G.

The capacitor power supply wiring layer 61V is formed by a line segment connecting B4 and B5, and is arranged to face the IC power supply wiring layer 11V formed by the line segment connecting B4 and B5.

The capacitor power supply wiring layer 62V is formed by a line segment connecting D2 and E2, and is disposed to face the IC power supply wiring layer 12V formed by the line segment connecting D2 and E2.

The capacitor power supply wiring layer 63V is formed by a line segment connecting D7 and E7, and is arranged to face the IC power supply wiring layer 13V formed by the line segment connecting D7 and E7.

The capacitor power supply wiring layer 64V is formed by a line segment connecting G4 and G5, and is arranged to face the IC power supply wiring layer 14V formed by the line segment connecting G4 and G5.

The capacitor ground pattern 61G is a solid pattern formed in such a manner as to surround the positions of C3 to C6 to F3 to F6.

A build-up via 91V electrically connects the position of B5 in the power supply switching wiring layer 51V and the position of B5 in the capacitor power supply wiring layer 61V.

A build-up via 92V electrically connects the position of B4 in the power supply switching wiring layer 52V and the position of B4 in the capacitor power supply wiring layer 61V.

A build-up via 93V electrically connects the position of D2 in the power supply switching wiring layer 53V and the position of D2 in the capacitor power supply wiring layer 62V.

A build-up via 94V electrically connects the position of E2 in the power supply switching wiring layer 54V and the position of E2 in the capacitor power supply wiring layer 62V.

A build-up via 95V electrically connects the position of D7 in the power supply switching wiring layer 55V and the position of D7 in the capacitor power supply wiring layer 63V.

A build-up via 96V electrically connects the position of E7 in the power supply switching wiring layer 56V and the position of E7 in the capacitor power supply wiring layer 63V.

A build-up via 97V electrically connects the position of G5 in the power supply switching wiring layer 57V and the position of G5 in the capacitor power supply wiring layer 64V.

A build-up via 98V electrically connects the position of G4 in the power supply switching wiring layer 58V and the position of G4 in the capacitor power supply wiring layer 64V.

The build-up vias 91G to 98G electrically connect respective positions of C5, C4, D3, E3, D6, E6, F5, and F4 in the ground switching pattern 51G and respective positions of C5, C4, D3, E3, D6, E6, F5, and F4 in the capacitor ground pattern 61G.

One end portion (corresponding to the position of B5) of the capacitor power supply wiring layer 61V is a position to which a power supply side electrode of the pass capacitor C1 can be connected, and a side portion (corresponding to the position of C5) of the capacitor ground pattern 61G at a position facing the one end portion of the capacitor power supply wiring layer 61V is a position to which the GND-side electrode of the pass capacitor C1 can be connected.

The other end portion (corresponding to the position of B4) of the capacitor power supply wiring layer 61V is a position to which a power supply side electrode of the pass capacitor C2 can be connected, and a side portion (corresponding to the position of C4) of the capacitor ground pattern 61G at a position facing the other end portion of the capacitor power supply wiring layer 61V is a position to which the GND-side electrode of the pass capacitor C2 can be connected.

One end portion (corresponding to the position of D2) of the capacitor power supply wiring layer 62V is a position to which a power supply side electrode of the pass capacitor C3 can be connected, and a side portion (corresponding to the position of D3) of the capacitor ground pattern 61G at a position facing the one end portion of the capacitor power supply wiring layer 62 is a position to which the GND-side electrode of the pass capacitor C3 can be connected.

The other end portion (corresponding to the position E2) of the capacitor power supply wiring layer 62V is a position to which a power supply side electrode of the pass capacitor C4 can be connected, and the side portion (corresponding to the position E3) of the capacitor ground pattern 61G at a position facing the other end portion of the capacitor power supply wiring layer 62V is a position to which the GND-side electrode of the pass capacitor C4 can be connected.

One end portion (corresponding to the position of D7) of the capacitor power supply wiring layer 63V is a position to which a power supply side electrode of the pass capacitor C5 can be connected, and a side portion (corresponding to the position of D6) of the capacitor ground pattern 61G at a position facing the one end portion of the capacitor power supply wiring layer 63V is a position to which the GND-side electrode of the pass capacitor C5 can be connected.

The other end portion (corresponding to the position of E7) of the capacitor power supply wiring layer 63V is a position to which a power supply side electrode of the pass capacitor C6 can be connected, and the side portion (corresponding to the position of E6) of the capacitor ground pattern 61G at a position facing the other end portion of the capacitor power supply wiring layer 63V is a position to which the GND-side electrode of the pass capacitor C6 can be connected.

One end portion (corresponding to the position of G5) of the capacitor power supply wiring layer 64V is a position to which a power supply side electrode of the pass capacitor C7 can be connected, and a side portion (corresponding to the position of F5) of the capacitor ground pattern 61G at a position facing the one end portion of the capacitor power supply wiring layer 64V is a position to which the GND-side electrode of the pass capacitor C7 can be connected.

The other end portion (corresponding to the position of G4) of the capacitor power supply wiring layer 64V is a position to which a power supply side electrode of the pass capacitor C8 can be connected, and the side portion (corresponding to the position of F4) of the capacitor ground pattern 61G at a position facing the other end portion of the capacitor power supply wiring layer 64V is a position to which the GND-side electrode of the pass capacitor C8 can be connected.

That is, the eight pass capacitors C1 to C8 can be mounted on the mounting surface of the print board.

Next, a print board design assistance system according to the fifth embodiment will be described with reference to FIG. 25.

Taking the print board described above as an example, the design assistance system according to the fifth embodiment determines validity of the eight pass capacitors C1 to C8 mountable on the mounting surface of the print board, and efficiently selects the optimum number of pass capacitors by deleting unnecessary pass capacitors for design assistance.

As illustrated in FIG. 25, the design assistance system 100 according to the fifth embodiment includes a board information input unit 101, a search target selecting unit 102, a connection path calculating unit 103, a validity evaluating unit 104C, a design changing unit 105A, and a change result output unit 106.

The board information input unit 101, the search target selecting unit 102, the connection path calculating unit 103, and the design changing unit 105A are the same as the board information input unit 101, the search target selecting unit 102, the connection path calculating unit 103, and the design changing unit 105A in the design assistance system 100 according to the second embodiment, and thus, detailed description thereof is omitted.

Board design information 200 is input by the board information input unit 101, and the board information input unit 101 converts the input board design information 200 into a format that can be processed in the design assistance system 100 and outputs the information.

The search target selecting unit 102 includes an individual wiring selecting unit and an individual component selecting unit.

The individual component selecting unit in the search target selecting unit 102 refers to the individual component information 211 in the board design information 200 output from the board information input unit 101, and selects the IC1 and the pass capacitors C1 to C8 to be mounted on the print board.

The individual component selecting unit in the search target selecting unit 102 selects, for example, the pass capacitors C1 to C8 as the search targets for the print board described above, and classifies the other pass capacitors output from the board information input unit 101 as non-search targets.

The individual wiring selecting unit in the search target selecting unit 102 refers to individual wiring information 223 in the board design information 200 output from the board information input unit 101, and selects the power supply terminal 1V and the ground terminal 1G of the selected IC1.

The connection path calculating unit 103 calculates the shortest distance of the wiring path from the connection position in the plurality of IC power supply wiring layers 11V to 14V corresponding to each of the plurality of power supply terminals 1V of the IC1 selected by the individual wiring selecting unit in the search target selecting unit 102 to the connection position in the capacitor power supply wiring layers 61V to 64V to which the respective power supply side electrodes of the pass capacitors C1 to C8 are connected.

Further, the connection path calculating unit 103 calculates a shortest distance of the wiring path from the connection position in each of the plurality of IC ground patterns 11G corresponding to each of the plurality of ground terminals 1G of the IC1 selected by the individual wiring selecting unit in the search target selecting unit 102 to the connection position in the capacitor ground wiring layer 61G to which the GND-side electrode of each of the pass capacitors C1 to C8 is connected.

In short, the connection path calculating unit 103 calculates the shortest distance of the wiring path of the 1.0 V power supply system in the print board in all combinations of each power supply terminal 1V of the IC1 and the power supply side terminals of the pass capacitors C1 to C8 and the shortest distance of the wiring path of the ground system in all combinations of each ground terminal 1G of the IC1 and the ground side terminals of the pass capacitors C1 to C8.

The information obtained by the connection path calculating unit 103 is information in which each of the power supply terminal 1V and the ground terminal 1G of the IC1, each of the pass capacitors C1 to C8, and each of the shortest distances are associated with each other.

In addition, the information obtained by the connection path calculating unit 103 is information in which the power supply terminal 1V, the ground terminal 1G, and the signal terminal 1S of the IC1 are also associated.

The validity evaluating unit 104C relatively compares a shortest distance of the wiring path of the 1.0 V power supply system in the print board in all combinations of the power supply side terminals of the pass capacitors C1 to C8 with respect to each of the power supply terminals 1V of the IC1, determines that the pass capacitor in the wiring path in which the shortest distance indicates a minimum value is valid and the other are invalid, compares a shortest distance of the wiring path of the ground system in the print board in all combinations of the power supply side terminals of the pass capacitors C1 to C8 with respect to each of the ground terminals 1G of the IC1, determines that the pass capacitor in the wiring path in which the shortest distance indicates a minimum value is valid and the other are invalid, and finally determines a pass capacitor that has been determined as valid for at least one pass capacitor of the power supply terminal 1V and the ground terminal 1G of the IC1 as valid.

That is, the validity evaluating unit 104C extracts one pass capacitor having a shortest distance of the wiring path for each of the plurality of power supply terminals 1V and the plurality of ground terminals 1G of the IC1, determines the extracted pass capacitor as valid, and determines the other pass capacitors as invalid.

The validity evaluating unit 104C sets the pass capacitor determined to be valid as a group A, and sets the pass capacitor determined to be invalid as a group B.

The validity evaluating unit 104C has a validity determination function of determining the validity of the pass capacitor C1 to C8 and grouping the validity/invalidity.

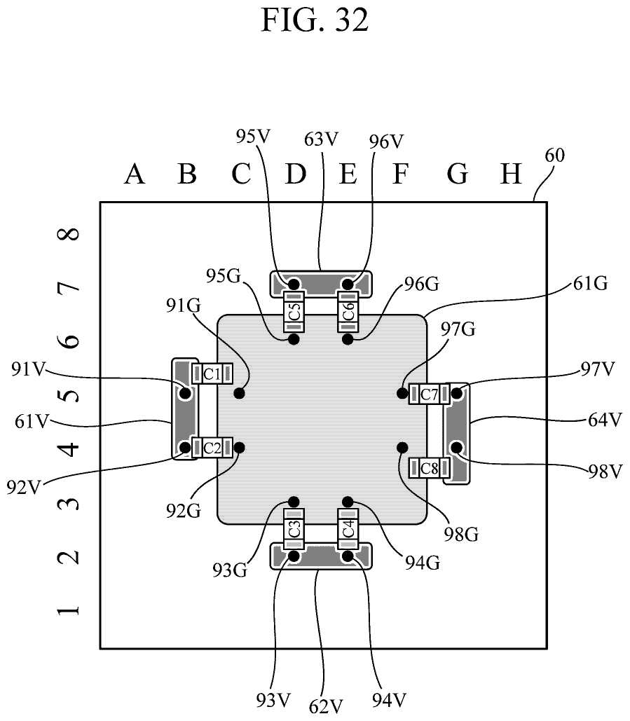

As understood from FIGS. 27 and 32, the IC power supply wiring layers 11V to 14V and the capacitor power supply wiring layers 61V to 64V are arranged to face each other in the front and back direction of the print board. Therefore, the shortest distance from the position of the IC power supply wiring layers 11V to 14V to which each of the plurality of power supply terminals 1V of the IC1 is connected to the connectable position of each of the pass capacitors C1 to C8 in the capacitor power supply wiring layers 61V to 64V is a distance from each of the plurality of power supply terminals 1V to the connectable position of each of the pass capacitors C1 to C8 in the capacitor power supply wiring layers 61V to 64V.

That is, all the pass capacitors C1 to C8 to which the plurality of power supply terminals 1V are connected at the shortest distance are different from each other.

The pass capacitor C1 is extracted with respect to the power supply terminal 1V located at B5 of the IC1.

The pass capacitor C2 is extracted with respect to the power supply terminal 1V located at B4 of the IC1.

The pass capacitor C3 is extracted for power supply terminal 1V located at D2 of IC1.

The pass capacitor C4 is extracted for power supply terminal 1V located at E2 of IC1.

The pass capacitor C5 is extracted for power supply terminal 1V located at D7 of IC1.

The pass capacitor C6 is extracted for the power supply terminal 1V located at E7 of the IC1.

The pass capacitor C7 is extracted for the power supply terminal 1V located at G5 of the IC1.

The pass capacitor C8 is extracted for the power supply terminal 1V located at G4 of the IC1.

Therefore, in the determination of the validity in the validity evaluating unit 104C, all the pass capacitor C1 to C8 are determined to be valid for the print board, and the validity evaluating unit 104C classifies the pass capacitor C1 to C8 into the group A.

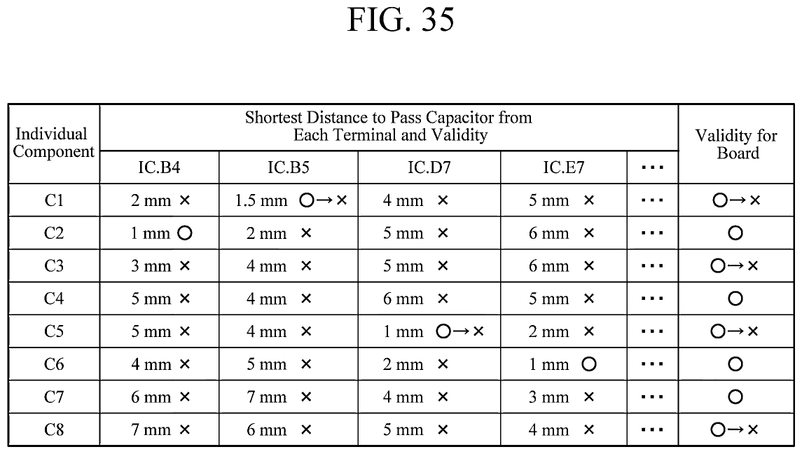

An example of the determination result for each of the plurality of power supply terminals 1V is illustrated together with the shortest distance obtained by the connection path calculating unit 103 in the column of shortest distance from each terminal to the pass capacitor and validity in FIG. 35.

Similarly, for each of the plurality of ground terminals 1G of the IC1, as understood from FIGS. 27 and 32, the IC ground pattern 11G and the capacitor ground wiring layer 61G are arranged to face each other in the front and back direction of the print board, and thus, all the pass capacitors C1 to C8 to which each of the plurality of ground terminals 1G is connected at the shortest distance are different pass capacitors. The pass capacitor C1 is extracted for the ground terminal 1G located at C5 of the IC1.

The pass capacitor C2 is extracted with respect to the ground terminal 1G located at C4 of the IC1.

The pass capacitor C3 is extracted with respect to the ground terminal 1G located at D3 of the IC1.

The pass capacitor C4 is extracted for the ground terminal 1G located at E3 of the IC1.

The pass capacitor C5 is extracted with respect to the ground terminal 1G located at D6 of the IC1.

The pass capacitor C6 is extracted with respect to the ground terminal 1G located at E6 of the IC1.

The pass capacitor C7 is extracted for the ground terminal 1G located at F5 of the IC1.

The pass capacitor C8 is extracted for the ground terminal 1G located at F4 of the IC1.

The validity evaluating unit 104C further determines that the group A of the pass capacitors determined to be valid for the print board is highly valid with respect to the group B determined to be invalid for the print board.

In each of the group A and the group B, the validity evaluating unit 104C relatively compares shortest distances of wiring paths in the print board calculated in each of the plurality of power supply terminals IV and the plurality of ground terminals 1G of the IC1, obtains the shortest distance of the minimum value, evaluates the validity of the pass capacitor in which the value of the shortest distance of the minimum value is small higher, and ranks the validity.

The validity evaluating unit 104C has a ranking function of evaluating the validity of the pass capacitors in the group for each of the group A and the group B and ranking the validity of the pass capacitors.

In the present example, since all the pass capacitors C1 to C8 are classified into the group A, the pass capacitors C1 to C8 of the group A are ranked.

The validity evaluating unit 104C extracts adjacent power supply terminals 1V for the power supply terminals 1V for the pass capacitors C1 to C8 belonging to the group A, in this example, the power supply terminals 1V located at the pin numbers B5, B4, D2, E2, D7, E7, G5, and G4 of the IC1.

The validity evaluating unit 104C has a function of determining whether the power supply terminals 1V are adjacent to each other, that is, an adjacency function of extracting the power supply terminal 1V in which the ground terminal 1G and the signal terminal 1S do not exist between the two power supply terminals 1V.

The adjacency determination by the validity evaluating unit 104C is performed as follows.

As a first method, the adjacency determination of the power supply terminal 1V is performed by the information related to the power supply terminal 1V of the IC1 and the information indicating the pin number of the power supply terminal 1V in the individual component information 211 of the board design information 200 input by the board information input unit 101.

That is, when the pin numbers of the power supply terminals 1V are serial numbers, it is determined that the plurality of power supply terminals 1V whose pin numbers are serial numbers are adjacent.

In general, in the BGA package, the terminal of the IC1 is designated by a pin number by a combination of a number and an alphabet. In the pin arrangement of the IC1 illustrated in FIG. 26, pin numbers such as A1, A2, . . . , A8, B1, B2, . . . , G8, H1, H2, . . . , and H8 are assigned to the terminals.

At this time, the power supply terminal 1V in the case where the alphabets of the pin numbers are the same and the numbers are serial numbers and the power supply terminal 1V in the case where the numbers are the same and the alphabets are continuous are determined to be the adjacent power supply terminal 1V.

In the present example, a pair of pin numbers B5 and B4 and pin numbers G5 and G4 having the same alphabet and serial numbers is determined as a group of adjacent power supply terminals 1V, in the present example, as a pair.

In addition, a pair of pin numbers D2 and E2 and pin numbers D7 and E7 having the same number and consecutive alphabets is determined to be a group of adjacent power supply terminals 1V, in this example, a pair.

Although the BGA package having a pin arrangement of a lattice pattern of 8×8 has been described as an example, in the case of a large-scale BGA package, the terminal of the IC1 may be designated by pin numbers of two alphabets and numbers, for example, AA1, AB2, and the like. At this time, it may be determined whether the terminals of the BGA package are continuous according to an alphabet notation rule.

Furthermore, in the present example, the group of two power supply terminals 1V adjacent as a group has been described as an example, but three or more power supply terminals 1V having serial pin numbers may be one group.

As a second method, the adjacency determination of the power supply terminal 1V is performed on the basis of the information on the terminal of the IC1, the information indicating the pin number of the power supply terminal 1V, and the information on the pitch between the terminals of the IC1 in the individual component information 211 of the board design information 200 input by the board information input unit 101.

The information regarding the pitch is information regarding the distance between the center coordinates of the terminals of the IC1.

The distance between the two power supply terminals 1V is calculated, the calculated distance is compared with a threshold, and when the distance is equal to or less than the threshold, it is determined that the power supply terminals 1V are adjacent to each other.

The threshold is a pin pitch of the BGA package.

Note that the threshold may be a value in a range from the pin pitch of the BGA package or more to less than the diagonal pin pitch, that is, less than v 2 times the pin pitch.

In this example, the distance between the pin numbers B4 and B5, the distance between the pin numbers G4 and G5, the distance between the pin numbers D7 and E7, and the distance between the pin numbers D2 and E2 are equal to or less than the threshold, and the pin numbers B4 and B5, the pin numbers G4 and G5, the pin numbers D7 and E7, and the pin numbers D2 and E2 are determined as groups of adjacent power supply terminals 1V.

The validity evaluating unit 104C relatively compares the shortest distances between the plurality of power supply terminals 1V in the group determined to be adjacent and the pass capacitors C1 to C8 determined to be the shortest distances with respect to the plurality of power supply terminals 1V, determines that one pass capacitor among the plurality of pass capacitors corresponding to the plurality of power supply terminals 1V in the group determined to be adjacent is valid, keeps the pass capacitor determined to be valid in the group A, determines that the remaining pass capacitors are invalid, and classifies the pass capacitors determined to be invalid into the group B.

The validity evaluating unit 104C selects one of the pass capacitors from among the extracted pass capacitors for the adjacent power supply terminal 1V by selecting a pass capacitor connected to a wiring path in which the shortest distance of the wiring path on the print board corresponding to each of the extracted pass capacitors for the adjacent power supply terminal 1V indicates a minimum value, and if there are a plurality of pass capacitors connected to the wiring path indicating the minimum value, selecting any one of the pass capacitors connected to the wiring path indicating the minimum value.

In the present example, since the shortest distance to the pass capacitor C2 is shorter than the shortest distance to the pass capacitor C1 in the pass capacitor C1 (shortest distance: 1.5 mm) and the pass capacitor C2 (shortest distance: 1 mm) with respect to the power supply terminal 1V (IC, B5, IC, B4) of the adjacent pin numbers B5 and B4 in the IC1, the pass capacitor C2 connected to the wiring path in which the shortest distance of the wiring path indicates the minimum value is selected from the pass capacitor C1 and the pass capacitor C2.

That is, as illustrated in the column of the validity for the board in FIG. 35, the determination of the validity of the pass capacitor C2 is maintained and the pass capacitor C2 is kept in the group A, and the determination of the pass capacitor C1 is changed from valid to invalid and classified into the group B.

Since the shortest distances of the wiring paths to the pass capacitor C5 (shortest distance: 1 mm) and the pass capacitor C6 (shortest distance: 1 mm) with respect to the power supply terminals 1V (IC, D7, IC, E7) of the adjacent pin numbers D7 and E7 in the IC1 are the same, one of the pass capacitor C5 and the pass capacitor C6, in this example, the pass capacitor C6 is selected.

That is, as illustrated in the column of the validity for the board in FIG. 35, the determination of the validity of the pass capacitor C6 is maintained and the pass capacitor C6 is kept in the group A, and the determination of the pass capacitor C5 is changed from valid to invalid and classified into the group B.

Note that since the shortest distance to the pass capacitor C5 and the shortest distance to the pass capacitor C6 are the same, the pass capacitor C5 may be selected, the determination of the validity of the pass capacitor C5 may be maintained and the pass capacitor C5 may be kept in the group A, and the determination of the validity of the pass capacitor C6 may be changed from the validity to the invalidity to classify the pass capacitor C6 into the group B.

In any case, when the shortest distances to a plurality of pass capacitors are the same, any one pass capacitor may be selected from a plurality of pass capacitors having the same shortest distance, one pass capacitor may be redetermined to be valid and remain in the group A, and the remaining pass capacitors may be redetermined to be invalid from valid and classified into the group B.

Similarly, for the pass capacitor C3 and the pass capacitor C4 for the power supply terminals 1V (IC, D2, IC, E2) of the adjacent pin numbers D2 and E2 in the IC1, as illustrated in the column of validity for the board of FIG. 35, the determination of the validity of the pass capacitor C4 is maintained and kept in the group A, and the determination of the validity of the pass capacitor C3 is changed from valid to invalid and classified into the group B.

For the pass capacitor C7 and the pass capacitor C8 for the power supply terminals 1V (IC, G5, IC, G4) of adjacent pin numbers G5 and G4 in the IC1, as illustrated in the column of validity for the board of FIG. 35, the pass capacitor C7 maintains the determination of validity and remains in the group A, and the pass capacitor C8 changes the determination from valid to invalid and is classified into the group B.

As a result, the validity evaluating unit 104C redetermines that the pass capacitor C2, C4, C6, and C7 are valid and remains in the group A, and redetermines that the pass capacitor C1, C3, C5, and C8 are invalid and changes the group A to the group B.

The ranking in each of the group A and the group B follows the ranking performed by the ranking function.

Similarly to the design changing unit 105A in the second embodiment, the design changing unit 105A sequentially accumulates the pass capacitors in ascending order of the validity ranking obtained by the validity evaluating unit 104C to make them deletion candidates, and when the total capacitance value of the mounting candidate pass capacitors excluding the deletion candidate pass capacitors is less than the total capacitance value of all the mountable pass capacitors C1 to C8 that have not been deleted, selects the mounting candidate pass capacitors having different capacitance values in such a manner that the total capacitance value of the mounting candidate pass capacitors becomes equal to or more than the total capacitance value of all the mountable pass capacitors.

In addition, similarly to the design changing unit 105A in the second embodiment, the design changing unit 105A sequentially accumulates the pass capacitors in ascending order of the validity rank on the basis of the ranking of the validity obtained by the validity evaluating unit 104C to set the pass capacitors as the deletion candidates, compares the impedance between the plurality of power supply terminals 1V and the plurality of ground terminals 1G of the IC1 in a case where the pass capacitors set as the deletion candidates are excluded with the set impedance, and when the comparison result is that the impedance between the plurality of power supply terminals 1V and the plurality of ground terminals 1G of the IC1 is lower than the set impedance and the previous comparison result is high, determines that the pass capacitors up to the time when the comparison result is obtained are not to be mounted on the print board and to mount the remaining pass capacitors on the print board.

In short, similarly to the design changing unit 105A in the second embodiment, the design changing unit 105A has functions of pass capacitor change ranking determination, the pass capacitor change, impedance calculation, change result comparison, and optimization completion determination for the pass capacitors C1 to C8.

Therefore, since the design changing unit 105A is similar to the design changing unit 105A in the second embodiment, further detailed description will be omitted.

Note that, similarly to the design changing unit 105 in the first embodiment, the design changing unit 105A may determine that the information obtained by the validity evaluating unit 104C, that is, the pass capacitors C2, C4, C6, and C7 determined to be valid as a result of the re-determination of the pass capacitors C1 to C8 by the validity evaluation unit 104C are mounted on the print board, and the pass capacitors C1, C3, C5, and C8 determined to be invalid are not mounted on the print board.

Similarly to the change result output unit 106 in the second embodiment, the change result output unit 106 converts the information obtained by the design changing unit 105A into the format of the board design information 200 and outputs the information as a change result 300 to a display device such as a display.

Note that, in a case where the design changing unit 105A is similar to the design changing unit 105 in the first embodiment, the information obtained by the design changing unit 105 is converted into the format of the board design information 200 and is output to a display device such as a display as a change result 300.

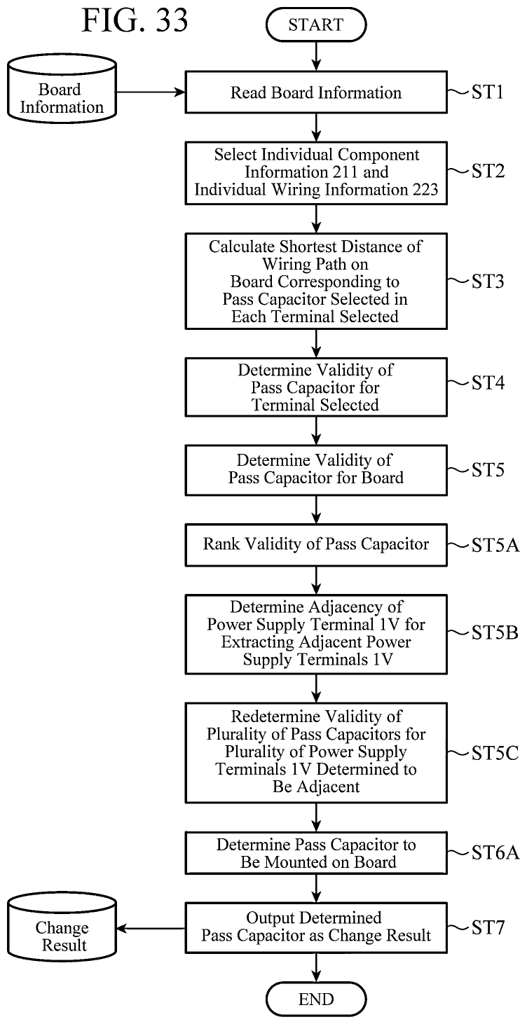

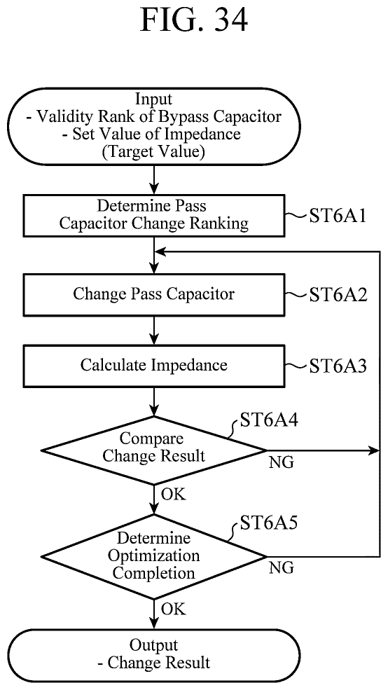

Next, operation of the print board design assistance system according to the second embodiment will be described with reference to FIGS. 33 and 34.

Since steps ST1 to ST5A are the same as those of the design assistance system according to the second embodiment, the description thereof will be omitted.

An example of the shortest distance from each of the plurality of power supply terminals 1V and the plurality of ground terminals 1G of the IC1 to the pass capacitors C1 to C8 and the determination result of the validity for each terminal obtained by the validity evaluating unit 104C in the first validity determining step ST4 and the determination result of the validity for the board obtained in the second validity determining step ST5 is illustrated in the column of the shortest distance from each terminal to the pass capacitor and the validity in FIG. 35.

In the column of the shortest distance from each terminal to the pass capacitor and the validity in FIG. 35, the power supply terminals 1V (IC, B4, IC, B5, IC, D7, IC, E7) of pin numbers B4, B5, D7, and E7 are representatively illustrated.

The validity evaluating unit 104C extracts adjacent power supply terminals 1V for the power supply terminals 1V for the pass capacitors 1C to C8 belonging to the group A of pass capacitors determined to be valid for the print board, in this example, power supply terminals 1V located at pin numbers B5, B4, D2, E2, D7, E7, G5, and G4 of the IC1 (step ST5B).

In this example, the validity evaluating unit 104C determines that the pin numbers B4 and B5, the pin numbers D2 and E2, the pin numbers D7 and E7, and the pin numbers G4 and G5 are groups of the power supply terminals 1V adjacent to each other.

Step ST5B is a step of determining adjacency.

The validity evaluating unit 104C relatively compares the shortest distances between the plurality of power supply terminals 1V (IC, B5 and IC, B4, IC, D7 and IC, E7, IC, D2 and IC, E2, IC, G5 and IC, G4) in the group determined to be adjacent and the pass capacitors C1, C2, C3, C4, C5, C6, C7, and C8 determined to be the shortest distances with respect to the plurality of power supply terminals 1V (IC, B5 and IC, B4, IC, D7 and IC, E7, IC, D2 and IC, E2, IC, G5 and IC, G4), determines that one pass capacitor C2, C4, C6, and C7 among the plurality of pass capacitors corresponding to the plurality of power supply terminals 1V in the group determined to be adjacent is valid, keeps the pass capacitors C2, C4, C6, and C7 determined to be valid in the group A, determines the remaining pass capacitors C1, C3, C5, and C8 as invalid, and classifies the pass capacitors C1, C3, C5, and C8 determined to be invalid into the group B (step ST5C).

Step ST5C is a step of redetermining the validity of the pass capacitor.

An example of the result of re-determination of the validity obtained by the validity evaluating unit 104C in step ST5C is illustrated in the column of validity for a board in FIG. 35.

In the column of validity for the board in FIG. 35, the mark “∘” indicates that it remains valid, and the mark “∘→x” indicates that it has been changed from valid to invalid.

In this example, the number of pass capacitors belonging to the group A can be reduced from eight to four.

For the pass capacitor C1 to C8 whose validity has been redetermined by the validity evaluating unit 104C in this manner, the design changing unit 105A determines the pass capacitor to be mounted on the print board in step ST6A on the basis of the information obtained by the validity evaluating unit 104C.

As illustrated in FIG. 34, the pass capacitor determining step ST6A includes steps ST6A1 to ST6A5, and steps ST6A1 to ST6A5 are the same as steps ST6A1 to ST6A5 in the design assistance system according to the second embodiment, and thus detailed description thereof is omitted.

That is, the design changing unit 105A performs, for the pass capacitors C1 to C8, the pass capacitor change ranking determination (step ST6A1), the pass capacitor change (step ST6A2), the impedance calculation (step ST6A3), the change result comparison (step ST6A4), and the optimization completion determination (step ST6A5).

When the design changing unit 105 determines the pass capacitor to be mounted on the print board in step ST6A in this manner, the design changing unit 105A converts the information by the pass capacitor determined in step ST6A into the format of the board design information 200 in step ST7, outputs the information as the change result 300 to the display device, and ends the process.

Note that, in a case where the design changing unit 105A is similar to the design changing unit 105 in the first embodiment, the design changing unit 105 operates as step ST6 instead of step ST6A, and the design changing unit 105 determines, on the basis of the information obtained by the validity evaluating unit 104C, to mount, on the print board, the pass capacitor determined to be valid for the print board, and not to mount, on the print board, the pass capacitor determined to be invalid, and in step ST7, the design changing unit 105 converts the information on the basis of the pass capacitor determined in step ST6 into the format of the board design information 200, outputs the information to the display device as the change result 300, and ends the process.

The search target selecting unit 102, the connection path calculating unit 103, the validity evaluating unit 104C, and the design changing unit 105A in the design assistance system according to the fifth embodiment are similar to the hardware configuration by the computer in the design assistance system according to the first embodiment illustrated in FIG. 15.

The print board design assistance method of the print board in steps ST2 to ST6A is performed by the CPU 110 executing processing according to the program stored in the ROM 130.

That is, the program stored in the ROM 130 includes a selecting procedure of selecting, for steps ST2 to ST5C, a plurality of power supply terminals and a plurality of ground terminals of a semiconductor integrated circuit device to be mounted on a board, and a plurality of bypass capacitors mountable on a board, as search targets, a shortest distance calculating procedure of calculating a shortest distance of a wiring path on the board corresponding to each of the plurality of bypass capacitors for each of the plurality of power supply terminals and the plurality of ground terminals of the selected semiconductor integrated circuit device; a first validity determining procedure of relatively comparing calculated shortest distances of wiring paths on the board corresponding to each of the plurality of bypass capacitors in each of the plurality of power supply terminals and the plurality of ground terminals of the semiconductor integrated circuit device, determining that the bypass capacitor whose shortest distance indicates a minimum value is valid, and determining that the remaining bypass capacitors are invalid, a second validity determining procedure of determining that a bypass capacitor determined to be valid in at least one of a plurality of power supply terminals or a plurality of ground terminals of the semiconductor integrated circuit device is valid for the board and determining that the other bypass capacitors are invalid for the board, a validity ranking procedure of determining that a group A of bypass capacitors determined to be valid for the board is highly valid with respect to a group B of bypass capacitors determined to be invalid for the board and relatively comparing shortest distances of wiring paths on the board calculated in each of the plurality of power supply terminals and the plurality of ground terminals of the semiconductor integrated circuit device in the bypass capacitors belonging to each of the group A and the group B, obtaining a shortest distance of a minimum value, evaluating validity of a bypass capacitor having a smaller value of a shortest distance of the minimum value more highly, and ranking validity, and a power supply terminal adjacency determination procedure of extracting an adjacent power supply terminal with respect to a power supply terminal for a bypass capacitor belonging to the group A, and a validity redetermination procedure of selecting one bypass capacitor among the extracted bypass capacitors with respect to the adjacent power supply terminal and leaving the bypass capacitor in the group A by performing a relative comparison of shortest distances of wiring paths on the board corresponding to the bypass capacitors with respect to the extracted adjacent power supply terminal, and changing a bypass capacitor that has not been selected from the group A to the group B.

In addition, the program stored in the ROM 130 performs, for step ST6A, a pass capacitor selecting procedure of sequentially accumulating bypass capacitors in ascending order of a validity rank to be deletion candidates on the basis of the obtained ranking of validity, determining that a total capacitance value of the bypass capacitors in a case of excluding the bypass capacitor as the deletion candidate is equal to or more than a total capacitance value of a plurality of bypass capacitors mountable on the initially set board, and selecting bypass capacitors having the same capacitance value in a case of excluding the bypass capacitor as the deletion candidate, and a pass capacitor determining procedure of sequentially accumulating bypass capacitors in ascending order of the validity rank to set the bypass capacitors as deletion candidates on the basis of the obtained ranking of validity, comparing impedances between the plurality of power supply terminals and the plurality of ground terminals of the semiconductor integrated circuit device in a case of excluding the bypass capacitors set as the deletion candidates with a set impedance, and determining bypass capacitors up to when the comparison result is obtained as bypass capacitors not to be mounted on the board and remaining bypass capacitors as bypass capacitors to be mounted on the board when the comparison result indicates that the impedances between the plurality of power supply terminals and the plurality of ground terminals of the semiconductor integrated circuit device are lower than the set impedance and an immediately previous comparison result is high.

Note that, in the print board design assistance method in step ST6 instead of step ST6A, the program stored in the ROM 130 includes, in step ST6, a pass capacitor determining procedure of determining a bypass capacitor determined to be valid for the board from among the plurality of bypass capacitors by the validity redetermination procedure as a bypass capacitor to be mounted on the board.

As described above, the print board design assistance system according to the fifth embodiment has effects similar to those of the design assistance system according to the second embodiment or the design assistance system according to the second embodiment.

Furthermore, in the print board design assistance system according to the fifth embodiment, the validity evaluating unit 104C extracts the power supply terminals 1V adjacent to the power supply terminals 1V for the pass capacitors belonging to the group A, selects one bypass capacitor among the pass capacitors for the extracted adjacent power supply terminals 1V by performing a relative comparison between the shortest distances of the wiring paths in the board corresponding to each of the pass capacitors for the extracted adjacent power supply terminals 1V, and leaves the bypass capacitor in the group A, and changes the bypass capacitor that has not been selected from the group A to the group B, and thus, since it is possible to set one pass capacitor for the adjacent power supply terminals 1V, it is possible to reduce the number of power supply terminals 1V without deteriorating performance due to the bypass capacitor, and to optimize the number of bypass capacitors to be arranged.

Note that free combinations of the respective embodiments, modifications of any components of the respective embodiments, or omissions of any components in the respective embodiments are possible.

### INDUSTRIAL APPLICABILITY

A print board design assistance system according to the present disclosure is preferable for a large-scale semiconductor integrated circuit device for multi-functionalization and high-functionalization, particularly a design assistance system that assists in design for selecting a plurality of bypass capacitors and determining arrangement positions of the plurality of bypass capacitors on a print board on which a semiconductor integrated circuit device in a ball grid array package is mounted.

### REFERENCE SIGNS LIST

1: IC, 1V: power supply terminal, 1G2: ground terminal, 10: one-layer pattern, 11V to 15V: IC power supply wiring layer, 11G to 14G: IC ground wiring layer, 20: two-layer pattern, 21V to 26V: power supply switching wiring layer, 21G to 26G: ground switching wiring layer, 30: three-layer pattern (GND pattern layer), 40: four-layer pattern (power supply pattern layer), 50: five-layer pattern, 51V, 52V: power supply switching pattern layer, 51G: ground switching pattern layer, 60: six-layer pattern, 61V, 62V: capacitor power supply wiring layer, 61G: capacitor ground wiring layer, 71V to 76V, 71G to 76G: build-up via, 81V to 86V, 81G to 86G: VIVH, 91V to 96V, 91G to 94G: build-up via, 100: design assistance system, 101: board information input unit, 102: search target selecting unit, 103: connection path calculating unit, 104: validity evaluating unit, 105: design changing unit, 106: change result output unit, C1 to C12: pass capacitor

1. A design assistance system for selecting and determining a bypass capacitor to be mounted from among a plurality of bypass capacitors, the bypass capacitor being mounted on a board on which a semiconductor integrated circuit device including a plurality of power supply terminals and a plurality of ground terminals is mounted, and the plurality of bypass capacitors each having a pair of electrodes is mountable, the board including a power supply wiring layer to which the plurality of power supply terminals is connected, a ground wiring layer to which the plurality of ground terminals is connected, a power supply side wiring layer to which one electrode of the plurality of bypass capacitors is connected, and a ground side wiring layer to which the other electrode of the plurality of bypass capacitors is connected, the design assistance system comprising:
a processor; and
a memory storing a program, upon executed by the processor, performing a process:
to calculate, for all combinations of the plurality of power supply terminals of the semiconductor integrated circuit device and one electrode of the plurality of bypass capacitors, a shortest distance in a wiring path from a connection position of the power supply wiring layer to which each of the plurality of power supply terminals of the semiconductor integrated circuit device is connected to each of connection positions of the power supply side wiring layer to which the one electrode of the plurality of bypass capacitors is connected, and calculate, for all combinations of the plurality of ground terminals of the semiconductor integrated circuit device and other electrode of the plurality of bypass capacitors, a shortest distance in a wiring path from a connection position of the ground wiring layer to which each of the plurality of ground terminals of the semiconductor integrated circuit device is connected to each of connection positions of the ground side wiring layer to which the other electrode of the plurality of bypass capacitors is connected; and
to relatively compare shortest distances of wiring paths on the board corresponding to each of the plurality of bypass capacitors calculated in each of the plurality of power supply terminals and the plurality of ground terminals of the semiconductor integrated circuit device, determine that a bypass capacitor connected to a wiring path whose shortest distance indicates a minimum value is valid, determine that remaining bypass capacitors are invalid, determine that the bypass capacitor determined to be valid among the plurality of bypass capacitors is valid for the board, and determine that other bypass capacitors are invalid for the board.

2. The design assistance system according to claim 1, wherein
the semiconductor integrated circuit device is a semiconductor integrated circuit device of a grid array package in which terminals including the plurality of power supply terminals and the plurality of ground terminals are arranged in a lattice pattern on a bottom surface, and
the board includes the power supply wiring layer and the ground wiring layer in a mounting region of the semiconductor integrated circuit device on a front surface, and includes the power supply side wiring layer and the ground side wiring layer in a region where the mounting region of the semiconductor integrated circuit device is projected on a back surface.

3. The design assistance system according to claim 1, the process further comprising to determine that a bypass capacitor that has been determined to be valid for the board is to be mounted on the board, and a bypass capacitor that has been determined to be invalid for the board is not to be mounted on the board, among the plurality of bypass capacitors.

4. The design assistance system according to claim 1, wherein
the process further determines that, regarding the bypass capacitor determined to be valid for the board, a group A of bypass capacitors determined to be valid for the board is highly valid with respect to a group B determined to be invalid for the board and, in each of the group A and the group B, relatively compares the shortest distances of the wiring paths in the board calculated in the plurality of power supply terminals and the plurality of ground terminals of the semiconductor integrated circuit device, obtains a shortest distance of a minimum value, evaluates validity of a bypass capacitor having a small value of the shortest distance of the minimum value more highly, and ranks the validity, and
the design assistance system performing the process that further comprises to sequentially accumulate a bypass capacitor in ascending order of validity rank on a basis of ranking of validity obtained to set the bypass capacitor as a deletion candidate, and select a bypass capacitor in which a total capacitance value of the bypass capacitors in a case of excluding the bypass capacitor as the deletion candidate satisfies a total capacitance value or more of the plurality of bypass capacitors and the bypass capacitors in a case of excluding the bypass capacitor as the deletion candidate have equal capacitance values.

5. The design assistance system according to claim 1, wherein
the process further determines that, regarding the bypass capacitor determined to be valid for the board, a group A of bypass capacitors determined to be valid for the board is highly valid with respect to a group B determined to be invalid for the board and, in each of the group A and the group B, relatively compares the shortest distances of the wiring paths on the board calculated in the plurality of power supply terminals and the plurality of ground terminals of the semiconductor integrated circuit device, obtains a shortest distance of a minimum value, evaluates validity of a bypass capacitor having a small value of the shortest distance of the minimum value more highly, and ranks the validity, and
the design assistance system performing the process that further comprises to sequentially accumulate a bypass capacitor in ascending order of validity rank on a basis of ranking of validity obtained to set the bypass capacitor as a deletion candidate, compare impedances between the plurality of power supply terminals and the plurality of ground terminals of the semiconductor integrated circuit device in a case of excluding the bypass capacitor as the deletion candidate with a set impedance and, when a result of the comparison indicates that the impedances between the plurality of power supply terminals and the plurality of ground terminals of the semiconductor integrated circuit device are lower than the set impedance and a previous comparison result is high, determine that bypass capacitors up to the bypass capacitors when the comparison result is obtained are not to be mounted on the board, and remaining bypass capacitors are to be mounted on the board.

6. The design assistance system according to claim 1, wherein
the process further determines that, regarding the bypass capacitor determined to be valid for the board, a group A of bypass capacitors determined to be valid for the board is highly valid with respect to a group B determined to be invalid for the board and, in the group A, relatively compares the shortest distances of the wiring paths in the board calculated in the plurality of power supply terminals and the plurality of ground terminals of the semiconductor integrated circuit device, obtains a shortest distance of a minimum value, evaluates validity of a bypass capacitor having a small value of the shortest distance of the minimum value more highly, and ranks the validity, and
the design assistance system performing the process that further comprises to set all bypass capacitors determined as the group B as deletion candidates, and then sequentially accumulate a bypass capacitor in ascending order of a validity rank on a basis of ranking of validity in the group A obtained, to set the bypass capacitor as a deletion candidate, compare impedances between the plurality of power supply terminals and the plurality of ground terminals of the semiconductor integrated circuit device in a case of excluding the bypass capacitor as the deletion candidate with a set impedance and, when a result of the comparison indicates that the impedances between the plurality of power supply terminals and the plurality of ground terminals of the semiconductor integrated circuit device are lower than the set impedance and a previous comparison result is high, determine that bypass capacitors up to the bypass capacitors when the comparison result is obtained are not to be mounted on the board, and remaining bypass capacitors are to be mounted on the board.

7. The design assistance system according to claim 1, wherein
the process further extracts a smoothing capacitor from the plurality of bypass capacitors, determines whether the plurality of bypass capacitors excluding the smoothing capacitor is valid or invalid, determines that, regarding the bypass capacitor determined to be valid for the board, a group A of bypass capacitors determined to be valid for the board is highly valid with respect to a group B determined to be invalid for the board and, in each of the group A and the group B, relatively compares the shortest distances of the wiring paths on the board calculated in the plurality of power supply terminals and the plurality of ground terminals of the semiconductor integrated circuit device, obtains a shortest distance of a minimum value, evaluates validity of a bypass capacitor having a small value of the shortest distance of the minimum value more highly, and ranks the validity, and
the design assistance system performing the process that further comprises to sequentially accumulate a bypass capacitor in ascending order of validity rank on a basis of ranking of validity obtained to set the bypass capacitor as a deletion candidate, compare impedances between the plurality of power supply terminals and the plurality of ground terminals of the semiconductor integrated circuit device in a case of excluding the bypass capacitor as the deletion candidate with a set impedance and, when a result of the comparison indicates that the impedances between the plurality of power supply terminals and the plurality of ground terminals of the semiconductor integrated circuit device are lower than the set impedance and a previous comparison result is high, determine that bypass capacitors up to the bypass capacitors when the comparison result is obtained are not to be mounted on the board, and remaining bypass capacitors including the extracted smoothing capacitor are to be mounted on the board.

8. The design assistance system according to claim 1, wherein
the process further extracts a smoothing capacitor from the plurality of bypass capacitors, determines whether the plurality of bypass capacitors excluding the smoothing capacitor is valid or invalid, determines that, regarding the bypass capacitor determined to be valid for the board, a group A of bypass capacitors determined to be valid for the board is highly valid with respect to a group B determined to be invalid for the board and, in the group A, relatively compares the shortest distances of the wiring paths in the board calculated in the plurality of power supply terminals and the plurality of ground terminals of the semiconductor integrated circuit device, obtains a shortest distance of a minimum value, evaluates validity of a bypass capacitor having a small value of the shortest distance of the minimum value more highly, and ranks the validity, and
the design assistance system performing the process that further comprises to set all bypass capacitors determined as the group B as deletion candidates, and then sequentially accumulate a bypass capacitor in ascending order of a validity rank on a basis of ranking of validity in the group A obtained, to set the bypass capacitor as a deletion candidate, compare impedances between the plurality of power supply terminals and the plurality of ground terminals of the semiconductor integrated circuit device in a case of excluding the bypass capacitor as the deletion candidate with a set impedance and, when a result of the comparison indicates that the impedances between the plurality of power supply terminals and the plurality of ground terminals of the semiconductor integrated circuit device are lower than the set impedance and a previous comparison result is high, determine that bypass capacitors up to the bypass capacitors when the comparison result is obtained are not to be mounted on the board, and remaining bypass capacitors including the extracted smoothing capacitor are to be mounted on the board.

9. The design assistance system according to claim 1, wherein
the process further extracts a smoothing capacitor from the plurality of bypass capacitors and determines whether the plurality of bypass capacitors excluding the smoothing capacitor is valid or invalid for the board, and
the design assistance system performing the process that further comprises to determine that, from the bypass capacitor extracted as a smoothing capacitor and the plurality of bypass capacitors among the plurality of bypass capacitors, a bypass capacitor that is determined to be valid for the board is to be mounted on the board, and a bypass capacitor that is determined to be invalid for the board is not to be mounted on the board.

10. A design assistance method for selecting and determining a bypass capacitor to be mounted from among a plurality of bypass capacitors on a board on which a semiconductor integrated circuit device including a plurality of power supply terminals and a plurality of ground terminals is mounted, and on which the plurality of bypass capacitors each having a pair of electrodes is mountable, the design assistance method comprising:
selecting a plurality of power supply terminals and a plurality of ground terminals of the semiconductor integrated circuit device to be mounted on the board and a plurality of bypass capacitors mountable on the board as a search target;
calculating a shortest distance of a wiring path on the board corresponding to each of the plurality of bypass capacitors for each of the plurality of power supply terminals and the plurality of ground terminals of the semiconductor integrated circuit device selected;
relatively comparing shortest distances of wiring paths on the board corresponding to each of the plurality of bypass capacitors calculated in each of the plurality of power supply terminals and the plurality of ground terminals of the semiconductor integrated circuit device, determining that a bypass capacitor whose shortest distance indicates a minimum value is valid, and determining that remaining bypass capacitors are invalid; and
determining that a bypass capacitor determined to be valid in at least one of the plurality of power supply terminals and the plurality of ground terminals of the semiconductor integrated circuit device is valid for the board, and determining that other bypass capacitors are invalid for the board.

11. The design assistance method according to claim 10, wherein
the semiconductor integrated circuit device is a semiconductor integrated circuit device of a grid array package in which terminals including the plurality of power supply terminals and the plurality of ground terminals are arranged in a lattice pattern on a bottom surface, and
the board includes the power supply wiring layer and the ground wiring layer in a mounting region of the semiconductor integrated circuit device on a front surface, and includes a power supply side wiring layer and a ground side wiring layer in a region where the mounting region of the semiconductor integrated circuit device is projected on a back surface.

12. The design assistance method according to claim 10, further comprising determining, from among the plurality of bypass capacitors, a bypass capacitor that is determined to be valid for the board as a bypass capacitor to be mounted on the board.

13. The design assistance method according to claim 10, further comprising:
determining that a group A of bypass capacitors determined to be valid for the board is highly valid with respect to a group B of bypass capacitors determined to be invalid for the board, and in the bypass capacitors belonging to each of the group A and the group B, relatively comparing shortest distances of wiring paths on the board calculated in each of the plurality of power supply terminals and the plurality of ground terminals of the semiconductor integrated circuit device to obtain a shortest distance of a minimum value, evaluating validity of a bypass capacitor having a smaller value of the shortest distance of the minimum value higher, and ranking the validity; and
on a basis of ranking of validity obtained, sequentially accumulating a bypass capacitor in ascending order of a validity rank to set the bypass capacitor as a deletion candidate, comparing impedances between the plurality of power supply terminals and the plurality of ground terminals of the semiconductor integrated circuit device in a case of excluding the bypass capacitor as the deletion candidate with a set impedance and, when a result of the comparison indicates that the impedances between the plurality of power supply terminals and the plurality of ground terminals of the semiconductor integrated circuit device are lower than the set impedance and a previous comparison result is high, determining that bypass capacitors up to the bypass capacitors when the comparison result is obtained are not to be mounted on the board, and remaining bypass capacitors are to be mounted on the board.

14. The design assistance method according to claim 10, further comprising:
determining that a group A of bypass capacitors determined to be valid for the board is highly valid with respect to a group B of bypass capacitors determined to be invalid for the board, and in the bypass capacitors belonging to the group A, relatively comparing shortest distances of wiring paths on the board calculated in each of the plurality of power supply terminals and the plurality of ground terminals of the semiconductor integrated circuit device to obtain a shortest distance of a minimum value, evaluating validity of a bypass capacitor having a smaller value of the shortest distance of the minimum value higher, and ranking the validity; and
setting all bypass capacitors determined as the group B as deletion candidates, and on a basis of ranking of validity in the group A obtained, sequentially accumulating a bypass capacitor in ascending order of a validity rank to set the bypass capacitor as a deletion candidate, comparing impedances between the plurality of power supply terminals and the plurality of ground terminals of the semiconductor integrated circuit device in a case of excluding the bypass capacitor as the deletion candidate with a set impedance and, when a result of the comparison indicates that the impedances between the plurality of power supply terminals and the plurality of ground terminals of the semiconductor integrated circuit device are lower than the set impedance and a previous comparison result is high, determining that bypass capacitors up to the bypass capacitors when the comparison result is obtained are not to be mounted on the board, and remaining bypass capacitors are to be mounted on the board.

15. The design assistance method according to claim 10, wherein
the method further extracts a smoothing capacitor from the plurality of bypass capacitors and determines whether the plurality of bypass capacitors excluding the smoothing capacitor is valid or invalid, and
the method further includes determining whether the plurality of bypass capacitors excluding the smoothing capacitor is valid or invalid for the board, and
the design assistance method further comprises:
determining that a group A of bypass capacitors determined to be valid for the board is highly valid with respect to a group B of bypass capacitors determined to be invalid for the board, and in the bypass capacitors belonging to each of the group A and the group B, relatively comparing shortest distances of wiring paths on the board calculated in each of the plurality of power supply terminals and the plurality of ground terminals of the semiconductor integrated circuit device to obtain a shortest distance of a minimum value, evaluating validity of a bypass capacitor having a smaller value of the shortest distance of the minimum value higher, and ranking the validity; and
sequentially accumulating a bypass capacitor in ascending order of validity rank on a basis of ranking of validity obtained to set the bypass capacitor as a deletion candidate, comparing impedances between the plurality of power supply terminals and the plurality of ground terminals of the semiconductor integrated circuit device in a case of excluding the bypass capacitor as the deletion candidate with a set impedance and, when a result of the comparison indicates that the impedances between the plurality of power supply terminals and the plurality of ground terminals of the semiconductor integrated circuit device are lower than the set impedance and a previous comparison result is high, determining that bypass capacitors up to the bypass capacitors when the comparison result is obtained are not to be mounted on the board, and remaining bypass capacitors including the extracted smoothing capacitor are to be mounted on the board.

16. The design assistance method according to claim 10, wherein
the method further extracts a smoothing capacitor from the plurality of bypass capacitors and determines whether the plurality of bypass capacitors excluding the smoothing capacitor is valid or invalid, and
the method includes determining whether the plurality of bypass capacitors excluding the smoothing capacitor is valid or invalid for the board, and
the design assistance method further comprises:
determining that a group A of bypass capacitors determined to be valid for the board is highly valid with respect to a group B of bypass capacitors determined to be invalid for the board, and in the bypass capacitors belonging to the group A, relatively comparing shortest distances of wiring paths on the board calculated in each of the plurality of power supply terminals and the plurality of ground terminals of the semiconductor integrated circuit device to obtain a shortest distance of a minimum value, evaluating validity of a bypass capacitor having a smaller value of the shortest distance of the minimum value higher, and ranking the validity; and
setting all bypass capacitors determined as the group B as deletion candidates, and on a basis of ranking of validity in the group A obtained, sequentially accumulating a bypass capacitor in ascending order of a validity rank to set the bypass capacitor as a deletion candidate, comparing impedances between the plurality of power supply terminals and the plurality of ground terminals of the semiconductor integrated circuit device in a case of excluding the bypass capacitor as the deletion candidate with a set impedance and, when a result of the comparison indicates that the impedances between the plurality of power supply terminals and the plurality of ground terminals of the semiconductor integrated circuit device are lower than the set impedance and a previous comparison result is high, determining that bypass capacitors up to the bypass capacitors when the comparison result is obtained are not to be mounted on the board, and remaining bypass capacitors including the extracted smoothing capacitor are to be mounted on the board.

17. The design assistance method according to claim 10, wherein
the method further extracts a smoothing capacitor from the plurality of bypass capacitors and determines whether the plurality of bypass capacitors excluding the smoothing capacitor is valid or invalid, and
the method includes determining whether the plurality of bypass capacitors excluding the smoothing capacitor is valid or invalid for the board, and
the design assistance method further comprises determining that a bypass capacitor extracted as a smoothing capacitor from among the plurality of bypass capacitors and a bypass capacitor determined to be valid for the board as bypass capacitors to be mounted on the board.

18. A non-transitory, tangible, computer readable recording medium storing a program for causing a computer to execute:
selecting a plurality of power supply terminals and a plurality of ground terminals of a semiconductor integrated circuit device to be mounted on a board and a plurality of bypass capacitors mountable on the board as search targets;
calculating a shortest distance of a wiring path on the board corresponding to each of the plurality of bypass capacitors for each of the plurality of power supply terminals and the plurality of ground terminals of the semiconductor integrated circuit device selected;
relatively comparing the shortest distances of wiring paths on the board corresponding to each of the plurality of bypass capacitors calculated at each of the plurality of power supply terminals and the plurality of ground terminals of the semiconductor integrated circuit device, determining that a bypass capacitor whose shortest distance indicates a minimum value is valid, and determining that the remaining bypass capacitors are invalid; and
determining that a bypass capacitor determined to be valid in at least one of the plurality of power supply terminals and the plurality of ground terminals of the semiconductor integrated circuit device is valid for the board and determining that other bypass capacitors are invalid for the board.

19. A design assistance system for selecting and determining a bypass capacitor to be mounted from among a plurality of bypass capacitors, the bypass capacitor being mounted on a board on which a semiconductor integrated circuit device of a grid array package in which terminals including the plurality of power supply terminals and the plurality of ground terminals are arranged in a lattice pattern on a bottom surface, including a plurality of power supply terminals and a plurality of ground terminals is mounted, and the plurality of bypass capacitors each having a pair of electrodes is mountable, the board including a power supply wiring layer to which the plurality of power supply terminals is connected, a ground wiring layer to which the plurality of ground terminals is connected, in a mounting region of the semiconductor integrated circuit device on a front surface, a power supply side wiring layer to which one electrode of the plurality of bypass capacitors is connected, and a ground side wiring layer to which the other electrode of the plurality of bypass capacitors is connected, in a region where the mounting region of the semiconductor integrated circuit device is projected on a back surface, the design assistance system comprising:
a processor; and
a memory storing a program, upon executed by the processor, performing a process:
to calculate, for all combinations of the plurality of power supply terminals of the semiconductor integrated circuit device and one electrode of the plurality of bypass capacitors, a shortest distance in a wiring path from a connection position of the power supply wiring layer to which each of the plurality of power supply terminals of the semiconductor integrated circuit device is connected to each of connection positions of the power supply side wiring layer to which the one electrode of the plurality of bypass capacitors is connected; and
to relatively compare shortest distances of wiring paths on the board corresponding to each of the plurality of bypass capacitors calculated in each of the plurality of power supply terminals of the semiconductor integrated circuit device, determine that a bypass capacitor connected to a wiring path whose shortest distance indicates a minimum value is valid, determine that remaining bypass capacitors are invalid, determine that the bypass capacitor determined to be valid among the plurality of bypass capacitors is valid for the board, determine that other bypass capacitors are invalid for the board, determines that, regarding the bypass capacitor determined to be valid for the board, a group A of bypass capacitors determined to be valid for the board is highly valid with respect to a group B determined to be invalid for the board, extracts adjacent power supply terminals with respect to the power supply terminals for the bypass capacitors belonging to the group A, selects one bypass capacitor from among the bypass capacitors for the extracted adjacent power supply terminals and leaves the selected bypass capacitor in the group A by relatively comparing shortest distances of wiring paths on the board corresponding to respective bypass capacitors for the extracted adjacent power supply terminals, and changes unselected bypass capacitor from the group A to the group B.

20. The design assistance system according to claim 19, wherein in extracting the adjacent power supply terminals with respect to the power supply terminals for the bypass capacitors belonging to the group A, when pin numbers of power supply terminals in the semiconductor integrated circuit device are serial numbers, the power supply terminals are determined as adjacent power supply terminals and extracted.

21. The design assistance system according to claim 19, wherein in extracting the adjacent power supply terminals with respect to the power supply terminals for the bypass capacitors belonging to the group A, when a distance between power supply terminals in the semiconductor integrated circuit device is equal to or less than a threshold, the power supply terminals are determined as adjacent power supply terminals and extracted.

22. The design assistance system according to claim 19, wherein in the selecting one bypass capacitor from among the bypass capacitors for the extracted adjacent power supply terminals, a bypass capacitor connected to a wiring path in which a shortest distance of a wiring path on the board corresponding to each of the bypass capacitors for the extracted adjacent power supply terminals indicates a minimum value is selected, and any one of the bypass capacitors connected to a wiring path indicating the minimum value is selected when there is a plurality of bypass capacitors connected to the wiring path indicating the minimum value.

23. The design assistance method according to claim 11, further comprising:
determining that a group A of bypass capacitors determined to be valid for the board is highly valid with respect to a group B of bypass capacitors determined to be invalid for the board, and extracting an adjacent power supply terminal for a power supply terminal for a bypass capacitor belonging to the group A; and
selecting one bypass capacitor among the bypass capacitors for the extracted adjacent power supply terminals to remain in the group A, and changing the bypass capacitor that has not been selected from the group A to the group B by relatively comparing shortest distances of wiring paths on the board corresponding to respective bypass capacitors for the adjacent power supply terminals extracted.

24. The design assistance method according to claim 23, wherein, in extracting the adjacent power supply terminals of the power supply terminals for the bypass capacitors belonging to the group A, when pin numbers of the power supply terminals in the semiconductor integrated circuit device are serial numbers, the power supply terminals are determined as the adjacent power supply terminals and extracted.

25. The design assistance method according to claim 23, wherein, in extracting the adjacent power supply terminals of the power supply terminals for the bypass capacitors belonging to the group A, when a distance between the power supply terminals in the semiconductor integrated circuit device is equal to or less than a threshold, the power supply terminals are determined as the adjacent power supply terminals and extracted.

26. The design assistance method according to claim 23, wherein in the selecting one bypass capacitor from among the bypass capacitors for the extracted adjacent power supply terminals, a bypass capacitor connected to a wiring path in which a shortest distance of a wiring path on the board corresponding to each of the bypass capacitors for the extracted adjacent power supply terminals indicates a minimum value is selected, and any one of the bypass capacitors connected to a wiring path indicating the minimum value is selected when there is a plurality of bypass capacitors connected to the wiring path indicating the minimum value.
